(19) United States
(12) Patent Application Publication
(10) Pub. No.: US 2005/0128212 A1
(43) Pub. Date: Jun. 16, 2005

(54) System and method for minimizing the amount of data necessary to create a virtual three-dimensional environment

(76) Inventors: Ada Mae Edecker, Earlville, IL (US); Alex Siyanko, Klev (UA); Anatoly Syomik, Kiev (UA)

Correspondence Address: Bell, Boyd & Lloyd LLC, P.O. Box 1135, Chicago, IL, 60690-1135, US

(21) Appl. No.: 10/943,041

(22) Filed: Sep. 15, 2004

Related U.S. Application Data
(63) Continuation-in-part of application No. 10/793,614, filed on Mar. 4, 2004.
(60) Provisional application No. 60/452,735, filed on Mar. 6, 2003.

(51) Int. Cl. G09G 5/00; G06T 15/00; G06T 17/00; G06F 9/44

(52) U.S. Cl. 345/582; 345/581; 345/419; 345/420; 717/104

(57) ABSTRACT

A system and method for minimizing the amount of photographic data to be collected to reconstruct a model of a three-dimensional object such as a building. In one embodiment a systematic process is used to collect survey and detailed photographic data from designated facades and architectural components of the facades to be processed into graphical tiles. The graphical tiles are textured or coated onto a three-dimensional wireframe model of the building. In one embodiment, the amount of photographic data to be collected is based on the footprint of the building, the height of the building and the number of unique facades and architectural details on the facades. In one embodiment, photographic data of the objects surrounding the building is also collected for modeling with the building. The virtual three-dimensional building models can be incorporated into the virtual three-dimensional city model which is a realistically accurate depiction of a city environment including all the details of an actual city.

### PRIORITY CLAIM

This application is a continuation-in-part of, and claims priority to and benefit of U.S. application Ser. No. 10/793,614, filed Mar. 4, 2004, which is incorporated herein in its entirety, and which claims priority to and benefit of U.S. Provisional Application Ser. No. 60/452,735, filed Mar. 6, 2003.

### BACKGROUND OF THE INVENTION

The present invention relates in general to an apparatus and method for creating a virtual three-dimensional environment, and a method for generating revenue therefrom, and more particularly to an apparatus and method for creating a virtual three-dimensional model of a city based on actual physical data of the city, to an apparatus and method for using the virtual three-dimensional model of the actual city, and to a method of generating revenue based on the virtual three-dimensional model of the city. The present invention also relates to a system and method for minimizing the amount of data necessary to create a virtual three dimensional environment.

The concept of virtual reality and the creation of virtual three-dimensional models are known. Generally, virtual three-dimensional models are created based on actual physical data of the modeled object, when available. However, many virtual models may not have a corresponding physical model or actual physical data may not be available. In the latter case, physical data is generally approximated and/or interpolated from available data, if any, in order to create the virtual three-dimensional model.

The concept of virtual reality extends to the creation of large virtual models such as virtual three-dimensional environments. Generally, a virtual three-dimensional environment will include a number of other virtual objects within the environment. As with the virtual models described above, these virtual environments may be based on actual physical data, when available. However, it is more likely in the case or virtual environments that a majority of the actual physical data may be approximated in creating the virtual environment. Moreover, many virtual three-dimensional environments are fictional environments which do not correspond to real-world environments, and therefore do not have corresponding physical data available for the modeling process.

A need exists to create a virtual three-dimensional model of an environment such as a city based on a majority of actual physical data of the corresponding environment. Moreover, a need exists to generate revenue from the virtual model of such environment. Specifically, it is desirable to provide businesses with new methods for generating revenue which include generating revenue based on business promotion and increased awareness of a business by illustrating the business in a virtual model in relation to other businesses and points of interest within the virtual environment.

There is also a need for a system which provides additional uses of three-dimensional environments which directly and accurately correspond to real-world environments such as cities which is not accomplished by current media forms or formats.

For example, information currently distributed within the tourism/retail market is exemplified by the numerous printed directories, area maps, telephone directories, and other print magazines and newspapers touting attractions and service offerings to various areas. These kinds of publications are readily known within the market so the concept is well known. However, there is growing user dissatisfaction with these publications. Much of the print information is not readily searchable and is static in nature such that it is old and obsolete shortly after publishing. Internet information is a growing source of searchable information but requires effort to sort through the volumes of information to find the particular information needed and such information is generally not geographically organized as it appears in the real world. Once found, getting information on surrounding attractions and transportation requires additional effort.

Thus, it should be appreciated that there is a on-going need in many fields and industries for computerized actual three-dimensional environments and systems which enable users to employ such actual three-dimensional environments.

### SUMMARY OF THE INVENTION

The present invention overcomes the above shortcomings by providing an apparatus and method for creating and using a virtual three-dimensional environment, and a method for generating revenue therefrom.

In one embodiment of the present invention, the virtual three-dimensional environment is a virtual three-dimensional model of a city. To create the virtual three-dimensional model of the city, information relating to city elements is collected and analyzed. In addition, geographical data relating to the city is also collected and analyzed. The collected and analyzed information is used to outline a general city boundary. The general city boundary defines the physical boundary for implementing the virtual three-dimensional model of the city.

Once the boundary of the virtual city model, that is, the city target area has been defined, the virtual city model is created. Creating the virtual city model includes acquiring further information pertaining to city elements as well as further geographical data corresponding to the city target area. This information and data is used in creating three-dimensional models of the city element interiors and exteriors as well as terrain within the city target area.

The completed virtual city model in one embodiment includes a plurality of the city elements that are present in the corresponding real-world city target area. The present invention enables end users of the virtual city model to navigate the virtual city model to experience what it would be like to actually visit the real-world city target area. Users are able to explore the virtual city model and to build a sense of familiarity with their surroundings in the virtual city model. In addition to merely exploring the virtual city model, the users are able to interact with a plurality of city elements. This interaction enables the user to further explore and become familiar with the city target area.

Enabling users to build familiarity with an area of a real-world city without actually or before being in the real-world city is advantageous. For example, if a user is planning a pleasure or business trip to a city, the user can become familiar with layout of the city before actually traveling to the city. In this example, the user can virtually explore the area around their intended hotel and virtually travel to restaurants and tourist attractions within walking distance of the hotel. In this manner, the user becomes more comfortable when actually going on the pleasure or business trip, without the cost of actually visiting the city beforehand. The user, who has never been to the city, thus feels as if they have already been to the city before their trip.

The sense of familiarity gained through virtually exploring the city model has broad application beyond merely planning a pleasure or business trip. Specifically, the virtual city model of this embodiment has broad applicability to industries and functions such as tourism, economic development, zoning, other city services, relocation, promotion and advertising. This wide applicability creates a large marketplace for the virtual city model of this embodiment.

The large marketplace for the virtual city model of this embodiment, in turn, drives methods of generating revenue from the virtual city model. In one embodiment, a method for generating revenue from the virtual city model includes developing a software product which includes the virtual city model. Money or other payment is solicited and collected from third-parties for their interests to be represented in the virtual city model software product.

Development of the software product continues in this fashion while money or other suitable payment is continually being solicited and collected from third-parties. The money collected from the third-parties funds the software development and helps to generate revenue. When the software development is completed or a state thereof is completed, the software product is distributed to end users. It should be appreciated that distributing the software product in one embodiment includes selling or licensing the software product.

In one embodiment, the software product of the above-described embodiment is continually updated and distributed. Money continues to be solicited and collected from interested third parties, thereby generating further revenue. Copies of the software product are updated and intermittently distributed to end users, and the development of the software product continues, thereby creating a dynamic virtual city model. The virtual city model thus adapts to changes in the real-world city and is able to grow over time.

In one embodiment, a method for generating revenue from the virtual city model includes defining a plurality of city elements in the virtual city model and leasing the defined city elements to real-world parties. Leasing the defined city elements thereby generates revenue. After the city elements have been defined and leased, the virtual city model is distributed to end users. It should be appreciated that distributing the virtual city model in one embodiment includes selling or licensing the virtual city model to end users.

In one alternative embodiment, city elements are continually defined and leased, thereby creating a dynamic or ever-changing version of the virtual city model which continues to generate revenue. Periodically, the virtual city model will be distributed or re-distributed to end users. It should be appreciated that later distributed versions of the city model will include additional or changed city elements and will be more updated than earlier distributed versions of the virtual city model. Eventually, the virtual city may include all or substantially all of the city elements of the real-world city and may thereafter change as the city changes. Accordingly, the present invention provides a virtual city which replicates an actual city in geographic appearance and in the inclusion of a great number if not all of the city elements or significant city elements. It should be appreciated that the term “city” as used in the present invention is meant to includes any suitable geographic region as discussed below.

An actual city may be large and complex consisting of millions of city elements and literally thousands of structures such as buildings. Collecting, processing, organizing and applying the data representing such objects and structures in a three-dimensional virtual city can be an extremely time-consuming, tedious and expensive endeavor. The present invention solves this problem by providing a system, process and method for minimizing the amount of data, such as photographic data, needed to be collected, processed, organized and employed to create the three-dimensional virtual city. This method is sometimes referred to herein as the minimized data collection method.

In one embodiment of the present invention, the minimized data collection method includes taking survey photographs of a building to create a wireframe model of the building and to determine what elements need to be photographed in more detail. Detailed photographs of repeatable elements of the building are then taken and processed to create graphical texture to be applied to the model. The present invention provides a method of determining the position and subject matter of the photographs in order to minimize the number of photographs necessary to complete a three-dimensional virtual model of the building.

In one embodiment of the present invention, a method of collecting photographic data for three-dimensional modeling of an object, such as a building, is provided. In one embodiment of the present invention, the minimized data collection method includes planning the photographic data to be collected. In one embodiment, an analysis of the target object or structure is conducted to identify potential shooting targets. These distinctive details of the object are documented in a suitable log or logbook. The log or logbook is preferably computerized although it may be maintained in other suitable forms.

In one embodiment, the method includes determining geometrical shape and spatial location information including a footprint of a building that is used to plan shooting tasks of the building. In one embodiment, planning includes identifying shooting targets and determining shooting positions in relation to the shooting targets from which to collect the photographic data. In one embodiment, the plan is documented in layouts of the target in a shooting task and in lists of objects for survey, detailed, and surrounding object photography.

Photographic data includes survey photos and detailed photos each taken from a shooting position at a distance and angle relative to a surface or facade of a building. Photographic data of the general features of a building are collected in the form of survey photographs, and photographic data of each of the distinct features of the building are collected in the form of detailed photographs.

A detailed photograph is taken of each of the features within at least a portion of a building facade or surface fragment that is different from features in adjacent surface fragments or portions of facades. In one embodiment, the photographer documents the completion of the collection of the survey and detailed photographic data together with the description of the task in a log or logbook.

The survey photos and detailed photographs undergo quality control for adequacy of the photographic data for three-dimensional reconstruction of the building. Documentation of the description of each of the photographs enables the reviewer to efficiently determine the adequacy of the collected photographic data. Upon a determination that adequate photographic data has been collected, in one embodiment, photographic data of each of the different surface fragments is processed or transformed to improve the quality of the photographic data and to customize it for use as a graphical tile texture. The enhanced graphical tile texture is applied to a three-dimensional wireframe model of the building surface fragments and is duplicated in different surface fragments if necessary.

In one embodiment, to complete the model of the building, detailed photos are taken of objects around the building using the same techniques to model the building.

Additional features and advantages of the present invention are described in, and will be apparent from, the following Detailed Description of the Invention and the Figures.

### BRIEF DESCRIPTION OF THE FIGURES

FIG. 1 is a flowchart illustrating one embodiment of a method for creating a three-dimensional virtual model of a city.

FIGS. 2A and 2B are diagrams illustrating an inner area and an outer area of a virtual city model in one embodiment.

FIGS. 3A 3B, 3C, 3D, 3E, 3F, 3G, 3H, 3I, 3J, 3K, 3L and 3M are example screen shots of an interface for a three-dimensional virtual model of a city according to one embodiment of the present invention.

FIG. 4 is a flowchart illustrating one embodiment of a method for generating revenue of the present invention.

FIG. 5 is a flowchart illustrating another embodiment of a method for generating revenue of the present invention.

FIG. 6 is a flowchart illustrating one other embodiment of a method of the present invention for generating revenue by marketing a three-dimensional city model in a cyclical revenue stream.

FIG. 7 is a diagram illustrating one embodiment of a customers technology database.

FIG. 8 is a flowchart illustrating an interaction between photographer and modeler in an architectural photography process framework and a model reconstruction process framework of one embodiment of the present invention.

FIG. 9A is a flowchart illustrating an architectural photography process framework of one embodiment of the present invention.

FIG. 9B is a flowchart illustrating a model reconstruction process framework of one embodiment of the present invention.

FIG. 10 is a flowchart illustrating documentation of photography of one embodiment of the present invention.

FIG. 11 is an example of a shooting task document of one embodiment of the present invention.

FIGS. 12A and 12B are examples of city block layouts of one embodiment of the present invention.

FIG. 13 is an example of a building peculiarities list document of one embodiment of the present invention.

FIGS. 14A and 14B are diagrams illustrating types of homogeneity areas on building facades of one embodiment of the present invention.

FIG. 15 is a table illustrating a sufficient number of survey pictures to be taken of buildings having different architectural features.

FIGS. 16A and 16B are diagrams illustrating a plan view and side view of shooting positions and angles for an average height building with a simple square footprint.

FIGS. 17A and 17B are diagrams illustrating a plan view and side view of shooting positions and angles for an average height building with a simple square footprint having concave and convex facade joints.

FIGS. 18A and 18B are diagrams illustrating a plan view and side view of shooting positions and angles for an average height building with a round footprint.

FIG. 19 is a diagram illustrating a plan view of shooting positions and angles for a building with a wide facade.

FIG. 20A is a photograph illustrating a high-rise building with a simple square footprint having concave and convex facade joints.

FIG. 20B is a diagram of illustrating a plan view of city segment including a high-rise building with a simple square footprint having concave and convex facade joints.

FIG. 21A is an example of a survey shooting objects list document of one embodiment of the present invention.

FIG. 21B is an example of a detailed shooting objects list document of one embodiment of the present invention.

FIG. 21C is an example of a city clutter objects list document of one embodiment of the present invention.

FIG. 22 is an angle-view survey photograph illustrating a facade of a building with outlined areas of detailed photography in one embodiment of the present invention.

FIG. 23 is a detailed photograph illustrating stone facing of a facade of a building.

FIG. 24 is an angle-view survey photograph illustrating a facade of a building with outlined targets of city clutter photography.

FIG. 25 is an angle-view survey photograph illustrating a facade of a building.

FIG. 26 is a detailed photograph illustrating a facade of a building.

FIG. 27 is a detailed photograph illustrating stone facing of a facade of a building indicating a segment to be used for texturing in one embodiment of the present invention.

FIG. 28 is a diagram illustrating a simplified view of a wireframe model of a building of one embodiment of the present invention.

FIG. 29 is an angle-view survey photograph of a building illustrating the outlining of a building fragment of a facade in one embodiment of the present invention.

FIG. 30 is a diagram illustrating the location of a textured fragment of a building on a wireframe model of one embodiment of the present invention.

FIGS. 31A is a detailed photograph of a facade illustrating a building used as a source image in one embodiment of the present invention.

FIGS. 31B is a partial view of a detailed photograph illustrating a facade of a building after perspective correction in one embodiment of the present invention.

FIGS. 31C is a partial view of a detailed photograph illustrating a facade of a building after clipping of the image in one embodiment of the present invention.

FIGS. 31D illustrates a graphical tile ready for texturing in one embodiment of the present invention.

FIG. 32 is a diagram illustrating graphical tile textures superimposed on a building wireframe in one embodiment of the present invention.

FIG. 33 illustrates a graphical tile ready for coating in one embodiment of the present invention.

FIG. 34A, 34B, 34C and 34D are diagrams illustrating the process of texturing a surface of one embodiment of the present invention.

FIG. 35 illustrates duplication of a graphical tile texture for coating in one embodiment of the present invention.

FIG. 36 is a diagram illustrating a completed three-dimensional model of a building in one embodiment of the present invention.

### DETAILED DESCRIPTION OF THE INVENTION

### Creating the Virtual Reality Three-Dimensional Environment

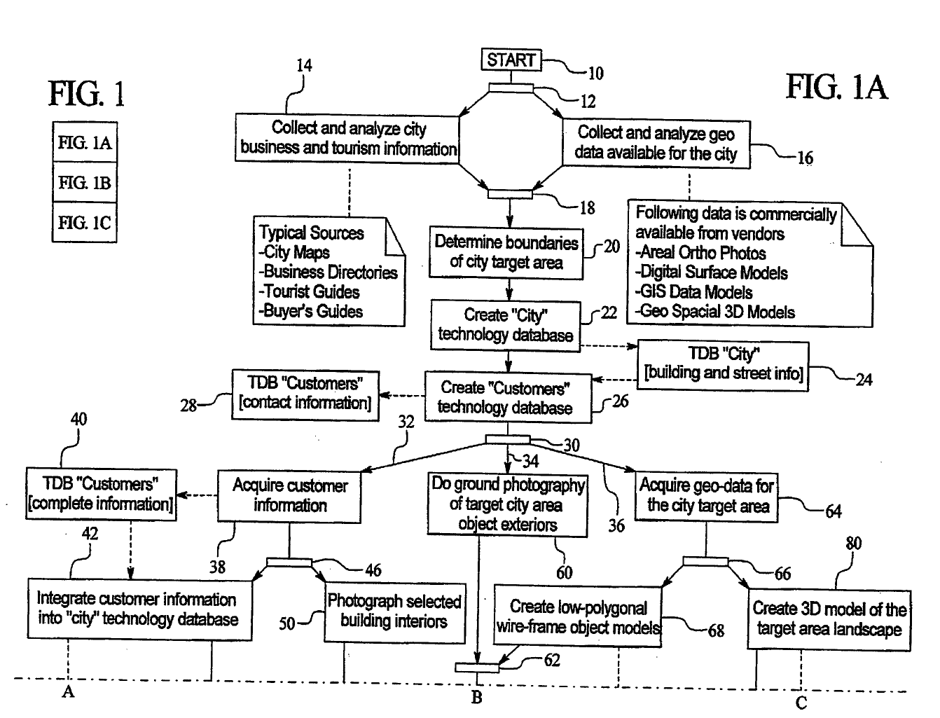

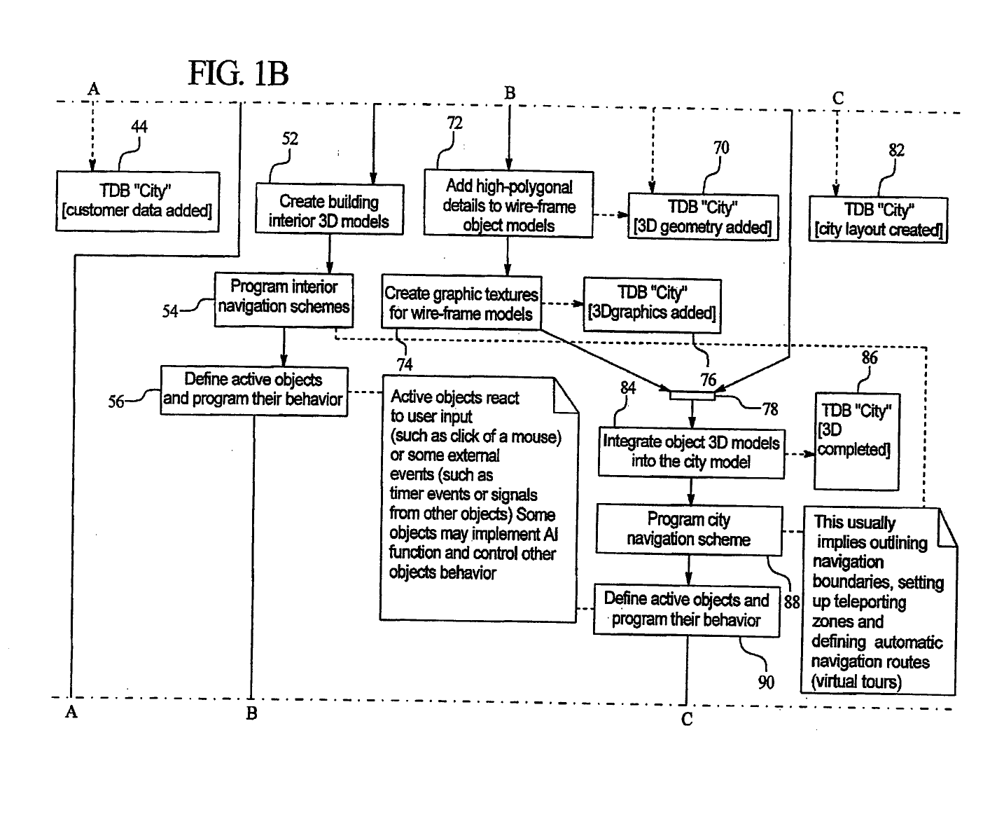

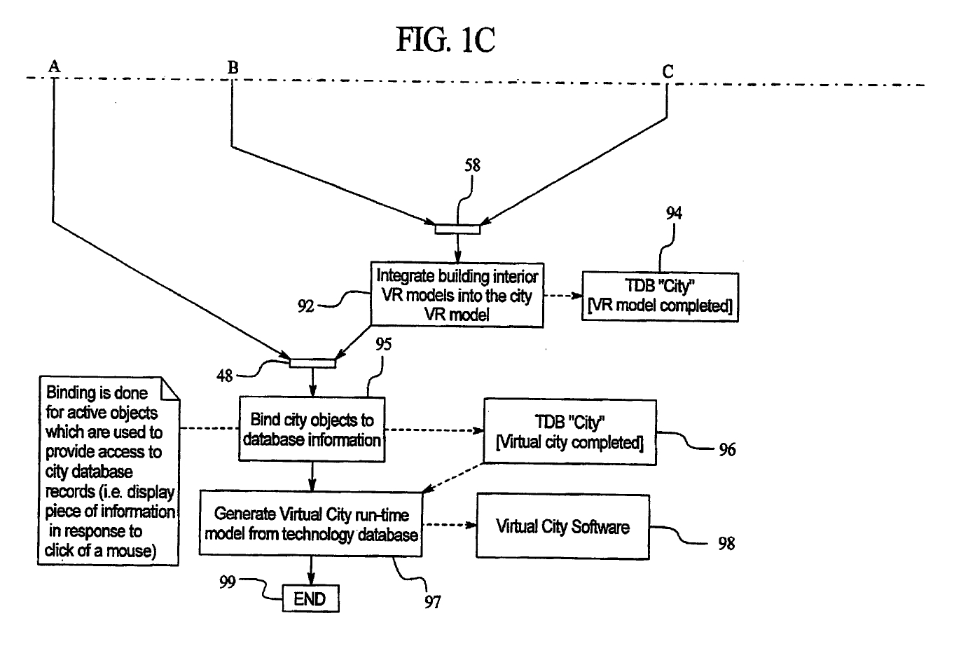

Referring now to FIG. 1, a flowchart generally illustrates one embodiment of a method for creating a virtual three-dimensional environment in accordance with the present invention. In this embodiment, the virtual three-dimensional environment is a virtual three-dimensional model of an actual city.

In this embodiment, the flowchart shown in FIG. 1 is variation of a Unified Modeling Language™ (UML) Activity Diagram. It should be appreciated that UML is well known in the computer field as a language for specifying, visualizing, constructing, and documenting software systems and the like and that it is used in part to simplify software and related design processes. In addition, UML diagrams can be used for database design, thereby allowing, for example, a business and an application team who are using UML for their designs to share a common language and to communicate with a database team. In this regard, UML can be used as a common modeling language, thereby linking various business teams, design groups and the like. However, it should be appreciated that the embodiments discussed herein are not limited to the use of UML and its terminology.

As discussed above, the virtual three-dimensional environment in this embodiment is a city. However, it should be appreciated that in alternative embodiments, the virtual three-dimensional environment could be any suitable environment such as a town, a village, a province, a county, a state, a country, a ward, a community, or an other suitable geographic location. Moreover, it should also be appreciated that the virtual three-dimensional environment in further alternative embodiments could also be a geographic subset of a larger geographic location. Examples of such a geographic subset include a university campus, a shopping center, a sports complex, and the like. The term city is used herein to be inclusive individually or jointly of all of the above.

In this embodiment, information relating to a plurality of city elements including business and tourism elements is collected and analyzed. In addition, geographical data relating to the city is also collected and analyzed. The analyzed results are used to select a general city boundary, that is, a city target area. The city target area defines the physical boundary for implementing the virtual three-dimensional model of the city.

Select actual city elements within the city target area are defined and information relating to these actual city elements is attached or made accessible through the city element itself. In addition, a plurality of actual city elements within the city target area are included in the three-dimensional model of the city, thereby making the three-dimensional model of the city more realistic and more of an actual representation of life within the city target area. In this, manner, a user can explore and use the city target area through the three-dimensional city model and feel as if they are actually visiting the city target area.

Creation of the virtual three-dimensional city model starts at start block 10 as illustrated in FIG. 1. Synchronization bar or dividing bar 12 illustrates that separate but general actual city information is collected and analyzed as illustrated by blocks 14 and 16. In this embodiment, the collection and analysis of information illustrated by the blocks 14 and 16 is completed simultaneously. However, it should be appreciated that the information can be collected and analyzed either simultaneously or in a staggered or predetermined chronological order. Moreover, it should also be appreciated that any task illustrated by blocks that follow a dividing bar in this embodiment can be completed either simultaneously or in a staggered or predetermined chronological order.

Information relating to city elements including city business and tourism information is collected and analyzed as indicated by the block 14. It should be appreciated that this information can be collected from a number of suitable different sources. For instance, paper and electronic city maps, business and other directories, tourist guides and buyer's guides provide large volumes of data relevant to city elements. Internet websites are one example of a source of such relevant information.

City elements include actual things found in an actual city such as but not limited to businesses, buildings, attractions, services, facilities, objects, and inhabitants. It should be appreciated that the city elements listed may overlap. For example, a business may occupy an entire building or an attraction can also be a business. In addition, the above listed elements are not meant to be exhaustive of all conceivable and suitable city elements.

Businesses as city elements include but are not limited to professional offices, trade offices, banks, factories, real estate offices, hotels, motels, restaurants, diners, coffee shops, bars, night clubs, casinos, stores, shops, malls, and salons. Buildings include but are not limited to skyscrapers, towers, temples, churches, halls, apartments, house, condominiums, theaters, libraries and museums. Attractions include theaters, museums, architectural landmarks, prominent and/or historical buildings, sculptures, art galleries, aquariums, planetariums, sports stadiums, scenic vistas, amusement parks, fountains, beaches, bodies of water such as rivers, lakes, and canals, and other similar venues and points of interest.

Services as city elements include but are not limited to city services such as police, fire and emergency services; transportation services such as taxis, buses, trains, trams, shuttles, and subways; medical services such as hospitals, urgent care centers and doctor's offices; and academic services such as schools, universities, libraries and colleges; and religious services such as temples, churches, synagogues, chapels, mosques and other like places of worship.

Facilities include but are not limited to meeting places such as plazas, squares, convention centers, convocation centers, stadiums and arenas; and transportation facilities such as airports, train stations, bus depots and taxi stands.

The information collected and analyzed includes information that is suitable to an end user of the virtual city model. Thus, it should be appreciated that the information which is collected and analyzed can be tailored and customized based on the intended audience or intended use. Moreover, the number of city elements for which information is collected can also be based on the intended audience or intended use. For instance, if the core audience in one embodiment is made up primarily of tourists, a large portion of the information collected and analyzed might be focused on tourist attractions. In another example, if the intended use is zoning, the information can be primarily roads, building and other city infrastructure.

The city element information collected and analyzed, in one embodiment includes, the type, function, the address and general location of the city element as well as its hours of operation, phone number(s), contact information and Internet website address. Further information may also be collected and analyzed such as transportation information with respect to the city element, the availability of nearby parking, handicapped access capabilities, a general description of the city element, and other useful and descriptive information concerning the city element.

Meanwhile, available geographic data for the city is collected and analyzed as indicated by the block 16. Geographic data includes data that records the shape and location of a feature as well as any associated characteristics that define and describe the feature. Generally, geographic data is processed using suitable computer systems for capturing, storing, checking, integrating, manipulating, analyzing, and displaying data related to positions on the Earth's surface. A Geographic Information System (GIS), or Spatial Information System (SIS), is typically used for handling various types of maps, which might be represented as several different layers where each layer holds data about a particular kind of feature. Generally, each feature is linked to a position on the graphical image of a map.

Actual geographic data is commercially available from a number of vendors including Vexcel, Urban Data Solutions, and Kodak. Examples of commercially available geographic data include aerial orthophotographic images, GIS data models, SIS data models, digital surface models, and geo-spatial three-dimensional models. Geographic data such as that listed above is collected from a suitable number of sources and subsequently analyzed.

Synchronization bar or joining bar 18 indicates that in this embodiment, all activities above joining bar 18 must finish before any activities beneath joining bar 18 can begin. Thus, after collecting and analyzing the geographic data and the city element information in blocks 14 and 16, the boundaries of the city target area are selected as illustrated by block 20. The boundaries selected for the city target area will determine the coverage area for the virtual city model.

The boundaries of the city target area can be determined using any suitable techniques. In one embodiment, the boundaries of the city target area are determined by analyzing a plurality of tourist maps of the city and defining the boundaries based on commonality of areas between the plurality of tourist maps. It should be appreciated that there are many suitable alternative techniques for determining the boundaries of the city target area. For instance, it might be desirable to compare and contrast transportation maps with tourist maps in order to determine the target boundaries, just as it is might be desirable to determine the boundaries based on the availability of higher quality geographic data for the city.

In addition to determining the coverage area for the virtual city model, it may be necessary to further define the contents of the coverage area. In this embodiment, the coverage area for the virtual city model includes an inner or detailed area and an outer or undetailed area. The outer area includes the boundaries of the modeled city streets layout, while the inner area, which lies inside the outer area, defines the boundaries of modeled city action blocks, that is, modeled streets, buildings, objects and the like.

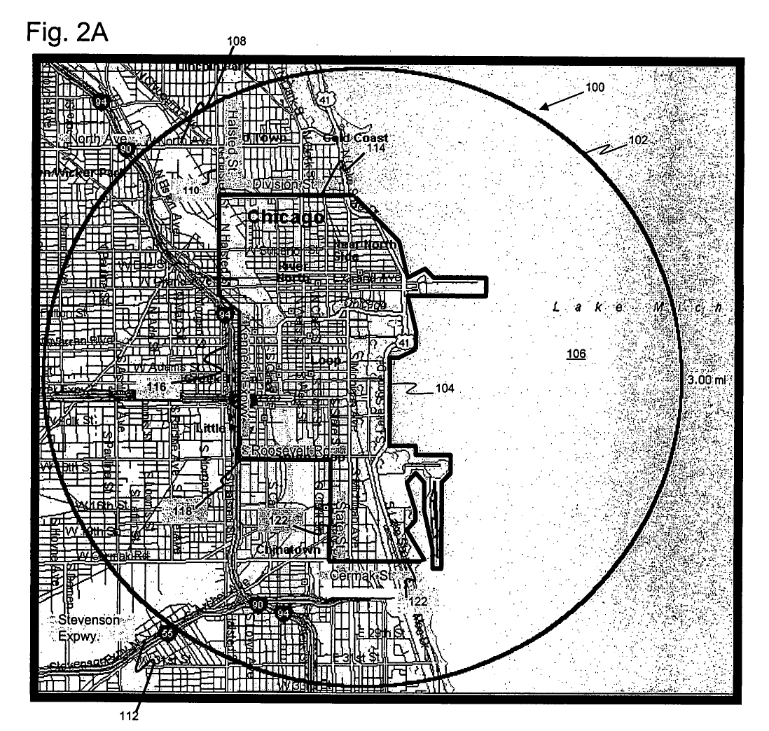

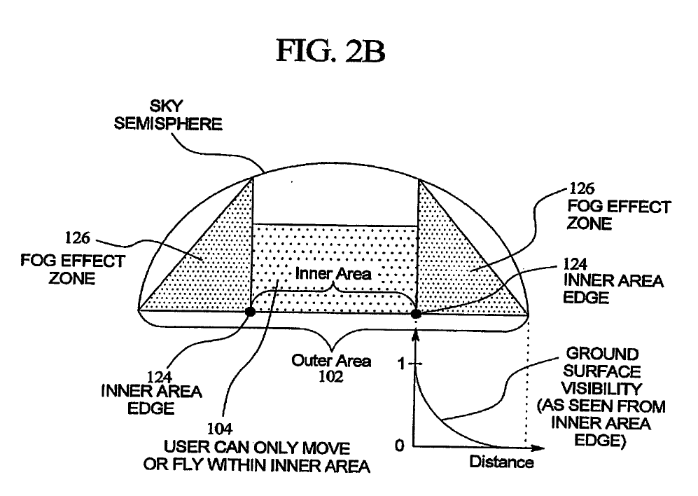

An overhead map 100 of a portion of a city is illustrated in FIG. 2A. The city used for this example is Chicago, Ill., USA. Included within the overhead map 100 are an outer area 102 and an inner area 104. In this embodiment, the outer area 102 defines a portion of the city which includes a lake 106 while the inner area defines a subset of the outer area 102 that excludes the lake 106. Thus, it should be appreciated that the outer area 102 defines the general or less detailed coverage area for the virtual city model, while the inner area 104 defines the more detailed coverage area for the virtual city model.

The approximate boundaries, excluding the lake 106, for the outer area 102 in a counterclockwise direction starting from North are North Avenue 108, Halsted Street 110 and Stevenson Expressway 112. The approximate boundaries for the inner area 104 in a counterclockwise direction starting from North are Division Street 114, Kennedy Expressway 116, Roosevelt Road 118, State Street 120, Cermak Street 122, and the shore of the lake 106.

The average inner area 104 size in city blocks from North to South is forty city blocks, and fifteen city blocks from East to West. The approximate total number of city blocks in the inner area 104 is six hundred city blocks. The average number of buildings on each city block in the inner area 104 is five buildings. The total number of modeled building is about three thousand buildings. The size of the inner area 104 in square miles is about five square miles.

Referring now to FIG. 2B, a side view of the inner area 104 and the outer area 102 is illustrated. The outer area 102 in this embodiment is defined such that it avoids sharp margins in the modeled area where streets and the like turn into dead-ends at edges 124 of the inner area 104. Thus, the outer area 102 which surrounds the inner area 104 introduces a visual effect such that the edges 124 of the inner area 104 are faded out via fog effect zones 126. Thus, the virtual city model in this embodiment appears to be surrounded by fog at a distance and no streets or the like have visual sharp dead-ends.

In addition, employing the visual effect of this embodiment decreases the size of entire virtual three-dimensional model since terrain leading away from the outer area 102 need not be modeled. However, objects inside the outer area 102 such as streets and the like still remain identifiable and can be used to provide information to a user of the virtual city model.

After defining the city target area, a city technology database is created as illustrated by block 22 of FIG. 1. In this embodiment, the city technology database includes building and street information as indicated by data object box 24. While the city technology database is being created and compiled, creation of a customers technology database also preferably begins as illustrated by block 26. The customers technology database includes customer contact information as indicated by data object box 28.

Referring now to FIG. 7, one embodiment of the customers technology database 700 is illustrated. The customers technology database 700 includes a plurality of classes and relationships. Object class 702 contains basic information such as contact information about a city element including a city object or place such as a business or other city entity. Information for records of object class 702 are primarily gathered during preliminary collection of information as illustrated by block 26 of FIG. 1. Sources for this preliminary information include, for example, yellow pages and mailing lists. However, further information may be added at a later step in the method illustrated in FIG. 1.

Referring back to FIG. 7, records of object class 702 may be interconnected via subordination relationships 704. For example, a record pertaining to a large corporate entity can be interconnected to each of its individual branch locations or entities. This subordinated relationship 704 is important because it facilitates the handling of corporate advertising options where a corporation may choose an option to provide a single informational presentation such as a multimedia presentation or a website link, which will be shared by all related subsidiary business places represented in the virtual city model, while all other advertising information will be submitted by these subsidiaries independently.

Object_type class 706 includes instances or records which are interconnected via object_subtype relationship 708 and form a user-oriented classifier of city places. In this embodiment, there is only one top level class record in this classifier with regard to object_subtype relationship 708 which is referred to as a root record. A second level record is represented by major places or business categories, for example, “shopping,” “wining and dining,” “professional and business services” and the like. A next level record contains a more detailed classification than above levels. In general, the number of levels is not restricted but will typically not exceed three.

It should be appreciated that some of the lower level types may belong to more then one higher level type. For example, a business type “car rental service” may belong both to “business and professional services” and “transportation” types. The actual contents and structure of this user-oriented classifier depends on the scope and purpose of the virtual city model and will, of course, vary for different embodiments. Each object class record 702 must have at least one defined object_type class record 706 that it belongs to. Thus, each object class record 702 must be connected to a certain object_type instance or record 706 via object_classification relationship 710. Moreover, this object_type instance 706 must be at a lower level of classifier, that is, it should not have children or subtypes as illustrated by formal constraint 712 (i.e., object_type.children.size=0).

NAICS class 714 instances or records represent a North American Industry Classification system (formerly SIC). Each object class instance or record 702 must have at least one NAICS class instance 714 connected to it via standard_classification relationship 716. Unlike object_type instances 706, instances of NAICS class 714 are organized in a strict hierarchical manner via industry_subtype relationship 718. NAICS classification may be used as an alternative method for business oriented product users who may choose to lookup city objects according to NAICS classification.

Two classifiers are mapped to each other via classification_mapping relationship 720, such it is easy to switch between classifiers, as well as to automatically determine an object type for a particular business based on its NAICS code and thus, to automatically build object_classification relationship 710. Using mailing lists to provide information for the records and instances of the customers technology database 700 will provide an advantage in one embodiment since mailing lists usually provide NAICS or SIC codes for each listed business.

Class attribute 722 contains descriptions of attributes for object types declared in object_type class 706. Each object type has a set of attributes assigned to it via attribute_set relationship 724. An actual set of attributes depends on object type. For example, for object type “Restaurant”, possible attributes will include “Name”, “Address”, “Working Hours”, “Cuisine”, “Price Range”, “Smoking Allowed” (Yes/No), and the like. Attributes defined for each lower level object type are inherited from higher level or parent object types. Attribute inheritance is a standard Object Oriented Programming (OOP) mechanism.

With the exception of name parameter 726 there are several important parameters defined for attribute class 722. Parameter cardinality 728 defines whether this attribute is a single (i.e., one value) or multiple (i.e., array of values). For example, attribute “Payment Method” for object “Restaurant” will be multiple with possible values of such an attribute being, for example, “Cash”, “Visa” or “Check” for a first restaurant or just “Cash” for a second restaurant.

Access parameter 730 defines access rights for a customer or client, or a user using the virtual city model. Examples of access rights include invisible, read only or full access. Some object attributes should not be visible to a client, since they are completed, accessed, modified and used only by company staff for internal processing. For example, an attribute “Art Designer” will hold the name of a designer responsible for processing graphics materials submitted by clients and this attribute might be used for project management purposes only.

Some attributes will be completed by company staff and should not be changed by clients. For example, an attribute “Company Logo” may contain final graphics for a client logo, which was created by a company designer in accordance with materials submitted by client. Thus, a client may be able to access an online account and see the final logo rendering, but can not change the final logo rendering.

Scope parameter 732 defines whether an attribute is final (i.e., it will be used in a finished copy of the virtual city model), or whether an attribute is merely a technology parameter used in the data preparation phase. For example, “Company Logo Draft” is a temporary technology parameter used in the data preparation phase as it may be a graphics file submitted by a client, which will be used by an art designer to create company final logo graphics according to system requirements. Conversely, the attribute “Company Logo” described above is a final parameter which will be incorporated into the virtual city model, and displayed on a user's screen.

Type parameter 734 defines which type of data an attribute will store. Typical values may include, for example, simple data types like “Integer”, “Float” or “Text”, or more complex data such as “Windows Bitmap File” or “Word Document File”. TypeData parameter 736 may store specific constraints for attribute type 734. For example, for attribute type 734 “Text”, TypeData parameter 736 could be maximum text length, or for “Windows Bitmap File”, it could be a specified width and height in pixels of the bitmap. This kind of data is read and interpreted by program classes, which implement particular data type. These classes should have methods for creating, reading and storing attribute values.

Some attributes may be interconnected via attribute_dependency relationship 738. This relationship usually exists between final and intermediate or technology attributes, and defines which source attributes are needed as input values to create or produce target attribute as output. The process of creating target attribute value can be either automatic (e.g., implemented by program class) or manual.

By way of example, for automatic creation, a client could submit as part of the client information set (which includes all relevant information about a client such as a business) a picture of the client's business place as a bitmap file which the client wants to be used as a part of wallpaper for the client's business passport screen. The bitmap file would then be stored as a value of the attribute “Passport Wallpaper Photo”. Another attribute “Passport Wallpaper Texture” is a technology attribute which value is predefined for a particular type of object. Once these two values are set, a method of creating passport wallpaper can be launched for automatically setting the value of target attribute “Passport Wallpaper”. Thus, the value of target attribute will be a bitmap image generated from the two source images by, for example, mixing them according to a certain algorithm.

By way of further example, for manual creation, a client could submit as part of the client information set (which includes all relevant information about a client such as a business) a scanned image of client's business card including a corporate logo. This submitted image would stored as a value of “Company Logo Draft” which is connected with “Company Logo” attribute via attribute_dependency relationship 738. Once this value is set, a system reminder can be generated and processed to inform a graphics designer that input materials for creating a logo are in place and that the graphics designer can start the job of creating the logo.

Some attributes known as descriptors may have a finite set of permissible values. On a user interface level, these attributes are usually represented by drop-down boxes or similar user interface elements that enable a user to choose one or several values from the list, and in some cases to add a new value to the list. Such sets of values are represented by vocabulary class 740. Vocabulary class 740 is a container class linked to a set of vocabulary values 742 via vocabulary_content relationship 744. In addition, vocabulary class 740 is also connected to at least one instance of attribute class 722 via attribute_domain relationship 746. Each attribute instance 722 may be connected to not more than one vocabulary class 740.

Parameter extendibility 748 defines whether a set of vocabulary values which can be extended by a client. One example of extendable vocabulary is a set of keywords. For example, each client may choose a set of keywords for the client's business and add them to a vocabulary Keywords. Based on the content of this vocabulary, a global index will be generated which will enable users of the virtual city model to lookup businesses and the like by associated keywords. One example of non-extendable vocabulary is a set of values such as “Yes” and “No” for object “Restaurant” attribute “Smoking Allowed”.

Class instance 750 is a container for actual attribute values 752 for each object instance 702, and is connected with attribute values 742 via value_set relationship 754. Depending on attribute multiplicity, instance object 702 can contain one or several attribute values 742. Some of these values can belong to a certain vocabulary if a corresponding attribute 722 has associated vocabulary 740. Instances of these classes can be completed online by clients or by company staff in the method illustrated in FIG. 1.

Ad_option class 756 and ad_attributes class 758 includes records or instances which contain information about advertising options. Each advertising option 756 includes the following parameters, name 760, description 762, availability 764, and deadline 766. Description parameter 762 includes pricing and technical requirements information while availability parameter 764 defines whether an advertising option is still available. Some advanced advertising options may become unavailable because of development time or other development limitations and the like. Deadline parameter 766 defines an information submission deadline for the advertising option. After a specified date, an advertising option will automatically become unavailable, even if it was chosen beforehand but the required data was not submitted by a client in a suitable time to meet the deadline.

Each ad_option instance 756 is connected to a set of object_type instances 706 for which it was designed via object_ad_options relationship 768. Different types of objects may have different sets of advertising options available. For example, media companies such as newspapers or magazines may have an option to set up virtual newsstands throughout the virtual city model and this option would not be available for other types of objects for obvious reasons.

Ad_attributes class 758 is a container class for holding references to all object type attributes 722 required for a certain option. The attributes identified by ad_attributes class 758 should be filled out either by a client or by company staff depending on the nature or the attribute.

Client class 770 holds information about clients or advertisers. Each client may access a certain part of technology database an online via front-end web interface and fill out, lookup or modify their respective information. Examples of client actions are described below.

A client or potential client can “Sign On” logging onto a related website and signing on as a client. Upon initial sign-in, an instance or record of client class is created. A client then enters contact information 772 and email information 774. In response, the system generates and emails login information 776 and password information 778 back to the client.

Once a client logs on to the website and enters their respective login information 776 and password information 778, the client account web page is opened. Next, the client identifies an object or objects 702 that the client would like to have advertised in the virtual city model. For each object 702 the client would like to advertise in the virtual city model, the client must enter the object's name 780, address 782 and phone 784. A new instance or record is created for each object unless the record of the object already exists because it was identified by company staff as illustrated by block 26 of FIG. 1.

After creating or updating the object record, the client picks one or several object types for the registered object or business. Picking object types can be accomplished via an object user-friendly classifier or via standard NAICS classifier at the client's choice. After picking object types, instances of object_classification 710 and standard_classification 716 relationships are created by the system.

Next, the client chooses advertising options. Preferably, the client should choose advertising options for each created object instance. List of available advertising options will be retrieved by the system from the database via object_ad_options relationship 768 and displayed to the client along with descriptions of the advertising options. Only options designed for a particular chosen object type and currently available options based on availability 764 and deadline 760 parameters will be displayed. For each chosen option, an instance of selected_ad_options relationship 786 will be created between client 770 and ad_option instances 756.

The system then uses ad_attributes class instance 758 and ad_required_attributes relationship instances 788 to retrieve the list of all required object attributes 722. All such attributes 722 will be connected to the object instance 702 via attribute_values relationship instances 752 and an instance of instance container class 750 will be created. The system is now ready to accept client data.

To enter client data, the client logs on to website and proceeds to input information using, for example, a form on the web page. The system uses previously created instances of attribute_values relationship 752 to retrieve and display a list of attributes 722 and their values 742. If a client enters some attribute value 742 for the first time, the system creates value class instance 742 and connects it to instance container object 750 via value_set relationship 754. If an attribute 722 has an associated vocabulary 740, then the client will choose an attribute value 742 from already existing value instances 742, which belong to this vocabulary 740 and connect them to instance container object 750 via value_set relationship 754 in the same manner described above.

The city technology database is similar to the customers technology database in terms of structures of classes and relationships. However, the city technology database includes a plurality of records or instances related to city buildings, size, shape, location, textures, geometry and the like rather than city elements defined by clients and their respective attributes.

After creating and updating the city and customers technology databases, the method for creating the virtual city model divides into three larger action branches 32, 33 and 34 as indicated by dividing bar 30. The first action branch 32 deals primarily with customer related actions while the second action branch 34 and the third action branch 36 deal primarily with city related actions such as three-dimensional modeling of the virtual city model.

Under the first action branch 32, city element such as customer information is acquired is illustrated by block 38. The customer information acquired includes more detailed information concerning the customers in the customers technology database. Upon acquiring the customer information, the information in the customers technology database is then completed as indicated by data object box 40. The customer information is then integrated into the city technology database as illustrated by block 42. Integrating the customer information into the city technology database includes adding the customer data to the city technology database as indicated by data object box 44.

Preferably, while still acquiring and completing customer information as illustrated by the block 38 and the data object box 40, dividing bar 46 indicates customer information and data can be integrated and added to the city technology database as illustrated by the block 42 and the data object box 44. Thereafter, this integrated information and data is joined or merged, as indicated by joining bar 48, with information and data from each of the three action branches 32, 34 and 36.

In addition, as illustrated by block 50, building interiors of selected buildings are also preferably being photographed. The building interiors selected to be photographed in this embodiment include major commercial buildings, attractions, office buildings, residential and commercial real estate, government buildings, transportation depots, universities, hospitals and the like. In general, the building interiors being photographed serve a basic or necessary need, have an interesting architectural design, or are in need of a visual representation to help clarify their interior structure. These buildings in turn act as anchor sites that are preferably evenly located throughout the entire virtual city model. In this manner, these actual buildings represent a full spectrum of the city and cause a flow of exploration throughout the area surrounding the anchor building and thereby encourage end users to access the entire virtual city model. After several of the major buildings in these various categories are defined and located, a selection process begins. The number selected depends on how many building interiors can be completed in the project time frame and which customers or clients will ultimately participate in the virtual city model.

However, it should be appreciated that the interiors of all buildings or points or interested could preferably be photographed in alternative embodiments. Three-dimensional models of the buildings interiors selected to be photographed are subsequently created as illustrated by block 52. Digital photographs, panoramic views, videos, and basic measurements are used in this embodiment for the purpose of creating the object interiors.

Block 54 illustrates that interior navigation schemes are then programmed for the interior three-dimensional models that have been created. Programming navigation schemes includes outlining navigation boundaries, setting up teleporting zones and defining automatic navigation routes such as virtual tours.

Active objects are then defined and their behavior is programmed as illustrated by block 56. Active objects generally react to user input, such as a mouse click, or an external event, such as timer events and signals from other objects. Some objects may include artificial intelligence function and control the behavior of other objects.

After defining and programming the active objects, joining bar 58 illustrates that all three of the action branches 32, 34 and 36 are joined or merged. Before proceeding with the description of the merging the three action branches 32, 34 and 36, the second action branch 34 and the third action branch 36 will be described in further detail.

Under the second action branch 34, block 60 illustrates that ground photography of object exteriors within the target city area is performed. It should also be appreciated that photographing object exteriors includes photographing city objects and inhabitants which include vehicles such as boats, helicopters, planes, trains and automobiles; as well as lampposts, mailboxes, bridges, traffic lights, utility poles, wires, dumpsters and trash cans; and other similar objects which can be found in a city. Inhabitants include but are not limited to people, animals, other wildlife, and plants such as trees, bushes, grass and other suitable kinds of foliage. Digital photographs, panoramic views, videos, and basic measurements are used in this embodiment for the purpose of creating the object exteriors.

Joining bar 62 illustrates that the second action branch 34 merges with the third action branch 36. Accordingly, the third action branch 36 will now be described.

Under the third action branch 36, block 64 illustrates that geographic data for the city target area is acquired. Dividing bar 66 illustrates that the acquired geographic data is preferably utilized in a number of subsequent functions. For instance, block 68 illustrates that the acquired geographic data is used to create low-polygonal wireframe object models. In addition, data object box 70 indicates that three-dimensional geometry is added to the city technology database.

The joining bar 62 indicates that the low-polygonal wireframe object models are then combined with the ground photography. As a result, high-polygonal detail is added to the wireframe object models as illustrated by block 72. In addition, data object box 70 indicates that further three-dimensional geometry is added to the city technology database.

Block 74 illustrates that graphic textures are created for the wireframe models. Three-dimensional graphics are then added to the city technology database as indicated by data object box 76. The resulting three-dimensional models and data are then preferably merged with the results of the remaining functions of the third action branch 36 as indicated by joining bar 78.

Block 80 illustrates that the acquired geographic data is also preferably used to create three-dimensional models of the target area landscape. Thus, data object box 82 indicates that the city layout is created in the city technology database.

Again, the joining bar 78 indicates that the resulting three-dimensional model of the target area landscape is combined or merged with the wireframe object models and related three-dimensional models and data. As a result, block 84 illustrates that the three-dimensional object models are integrated into the city model. The three-dimensional terrain for the city model is therefore completed as indicated by data object box 86.

Completing the three-dimensional terrain for the city model enables the navigation scheme for the city model to be programmed as illustrated by block 88. As described above, programming the navigation scheme includes outlining navigation boundaries, setting up teleporting zones and defining automatic navigation routes such as virtual tours. Block 90 illustrates that active objects are then defined for the city model and their behavior is programmed. Again, active objects react to user input, such as a mouse click, or an external event, such as timer events and signals from other objects. In addition, some objects may include artificial intelligence function and control the behavior of other objects.

The joining bar 58 indicates that the three-dimensional city model information and data created and compiled under the second and third action branches 34 and 36 is then preferably merged with the building interior information and data created and compiled under a portion of the first action branch 32. Merging this information and data enables the building interior virtual reality models to be integrated with the virtual reality city model as illustrated by block 92. Data object box 94 illustrates that the virtual reality model is then preferably completed in the city technology database.

The joining bar 48 illustrates that the completed virtual reality model is then combined with the integrated customer information from a final portion of the first action branch 32. Block 95 illustrates the binding of city elements and objects to underlying city technology database information. Binding the city elements and objects to the underlying city technology database information enables access to city technology database records. For instance, binding would be performed for an active object (e.g., a sculpture) in the city model where a piece of information (e.g., a description of the sculpture) is to be displayed in response to a mouse click on the active object. Data object box 96 illustrates the virtual city is now preferably completed.

The run-time model of the virtual city is generated from the city technology database as illustrated by block 97. Data object box 98 illustrates that the virtual city software package including the three-dimensional virtual city model is produced from the run-time model of the virtual city. Block 99 illustrates that the method for creating the virtual city model has ended.

The completed software package created by the above-described method of this embodiment is preferably distributed to end users. However, it should be appreciated that in alternative embodiments, the software package can be continually updated and distributed. Thus, changes can continually be made to the software package and the virtual city model in order to reflect changes in the corresponding real-world city. In addition, additional city elements can be added, updated and modified in the virtual city model. In this manner, the virtual city model and the underlying city technology database represent a dynamic and ever changing three-dimensional model of a real-world city.

### Navigating the Virtual Three-Dimensional Environment

The virtual three-dimensional environment in this embodiment is a virtual three-dimensional model of a city, as described in the previous embodiment. However, just as with the previous embodiment, it should be appreciated that in alternative embodiments, the virtual three-dimensional environment could be any suitable environment or geographic location such as those described in the above embodiment.

In this embodiment, the virtual three-dimensional city model is displayed on a display and a user navigates the virtual three-dimensional city model and its associated interface using input devices such as a mouse, a keyboard, a touchscreen, voice-command or the like. The user navigates the city model for any suitable reason including to virtually explore and discover the city as well as to access defined city and business elements.

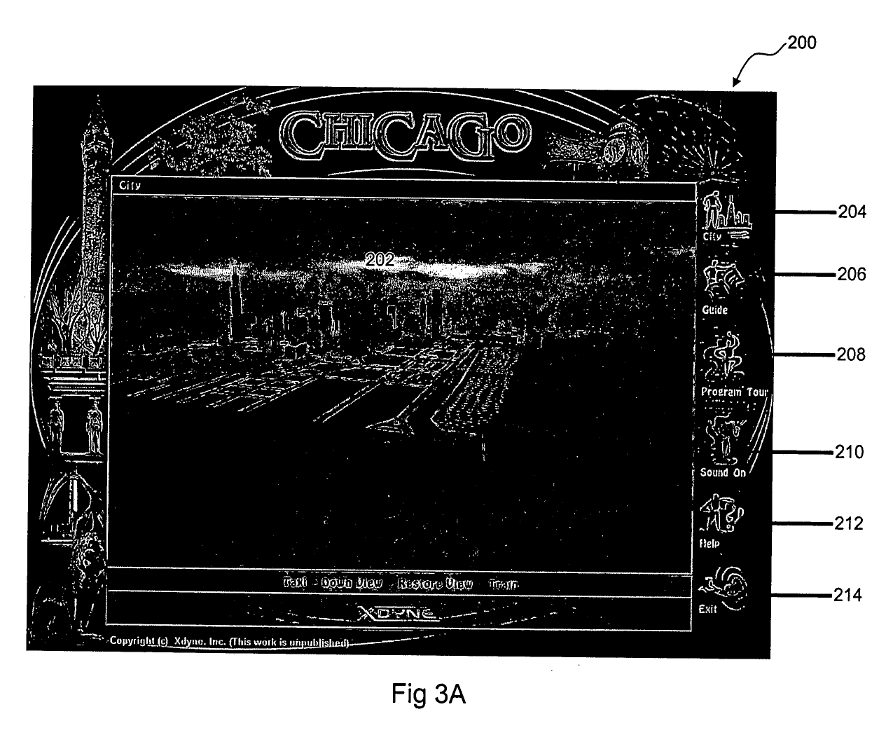

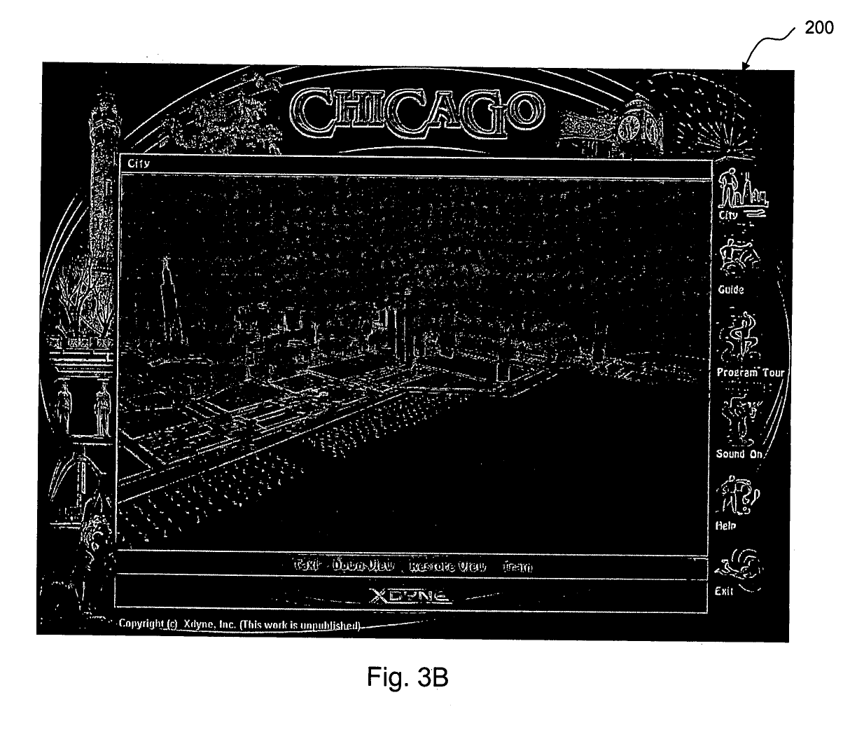

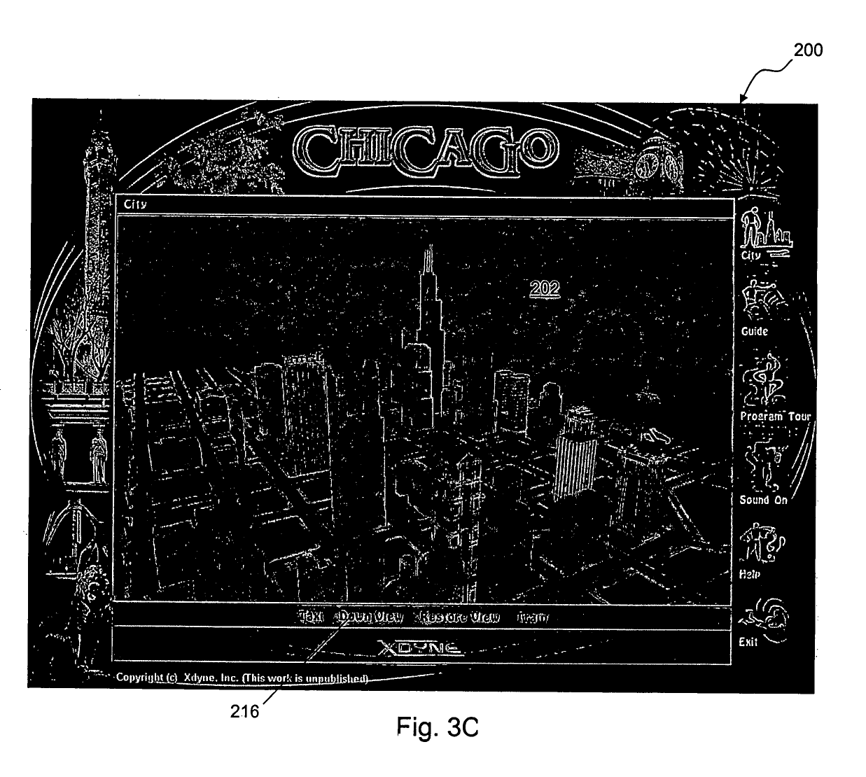

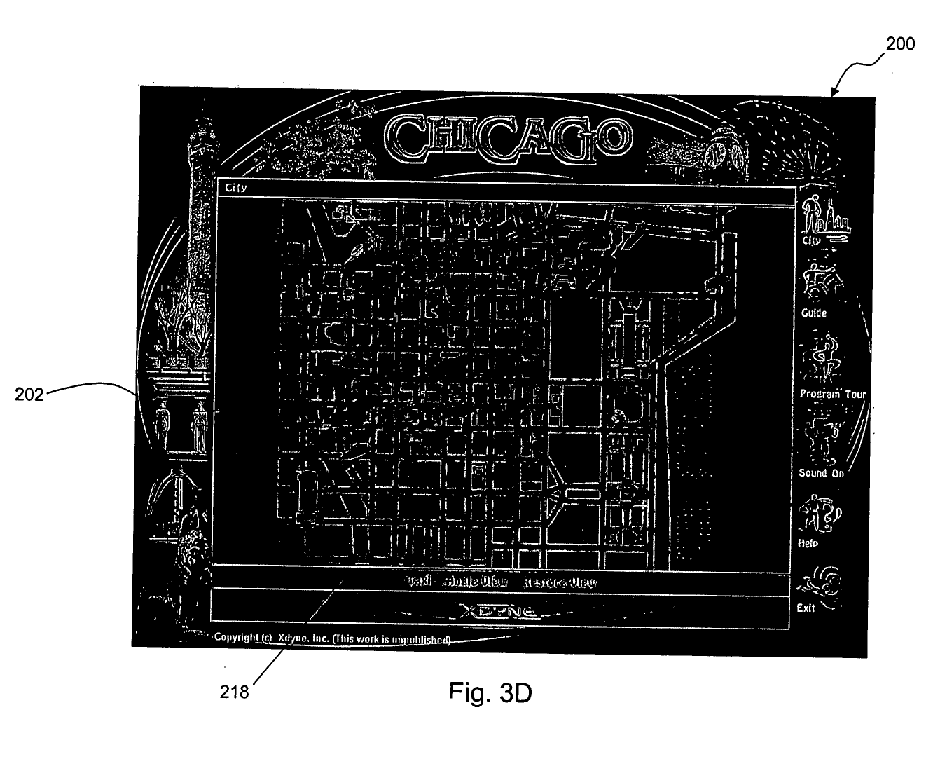

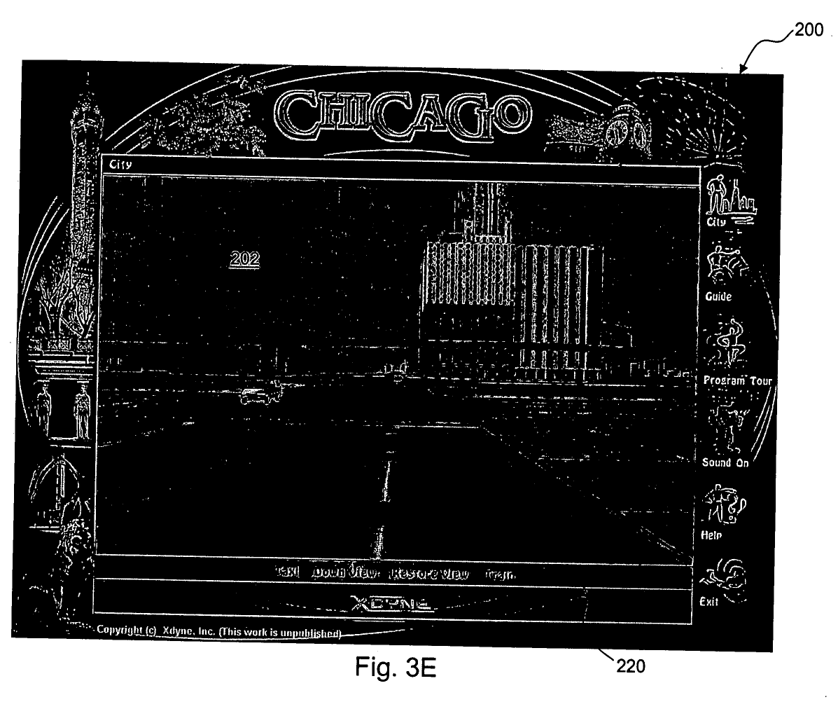

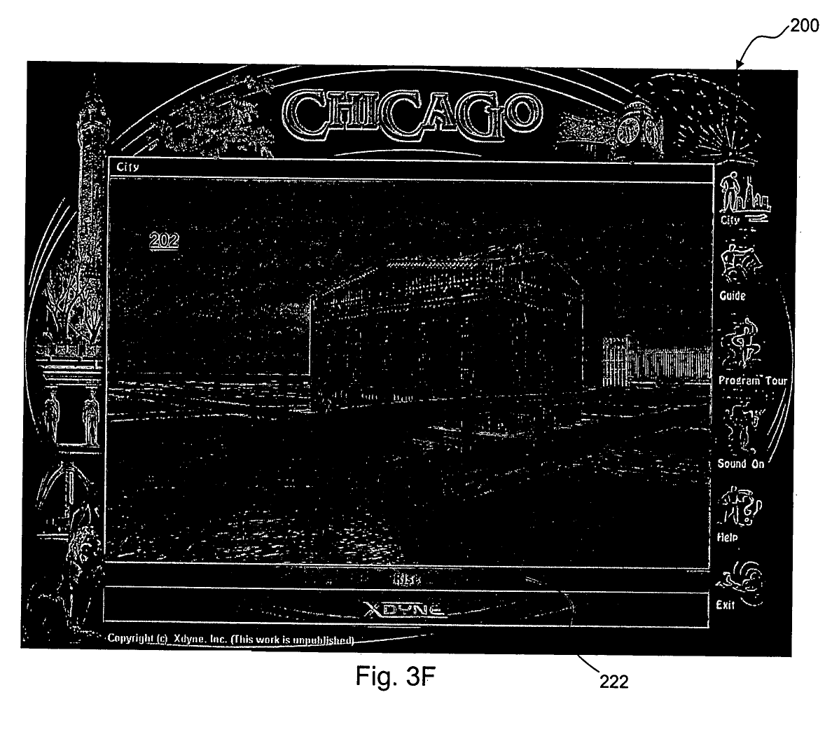

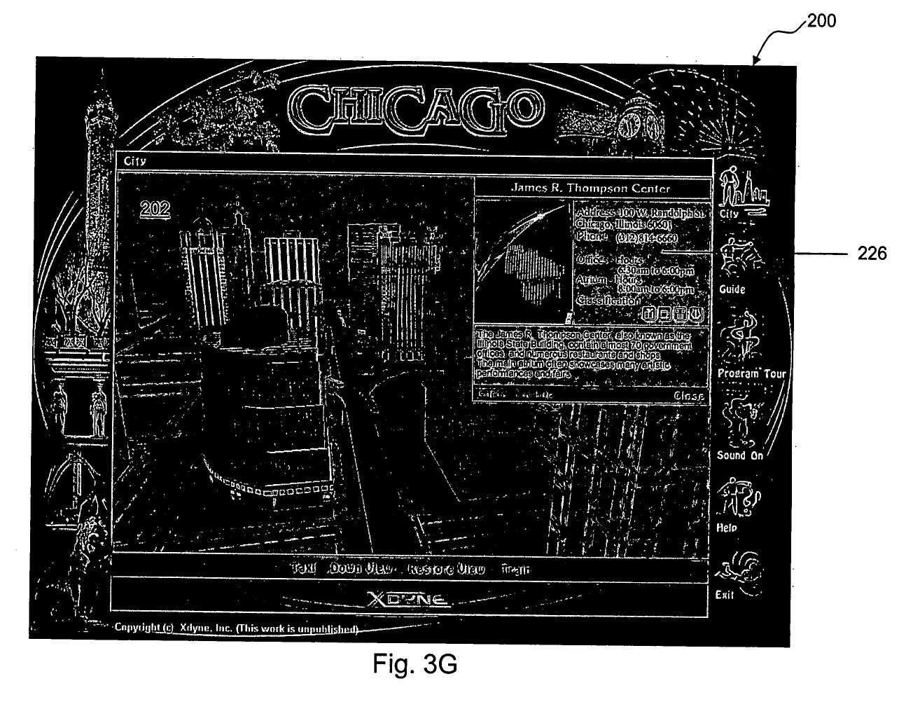

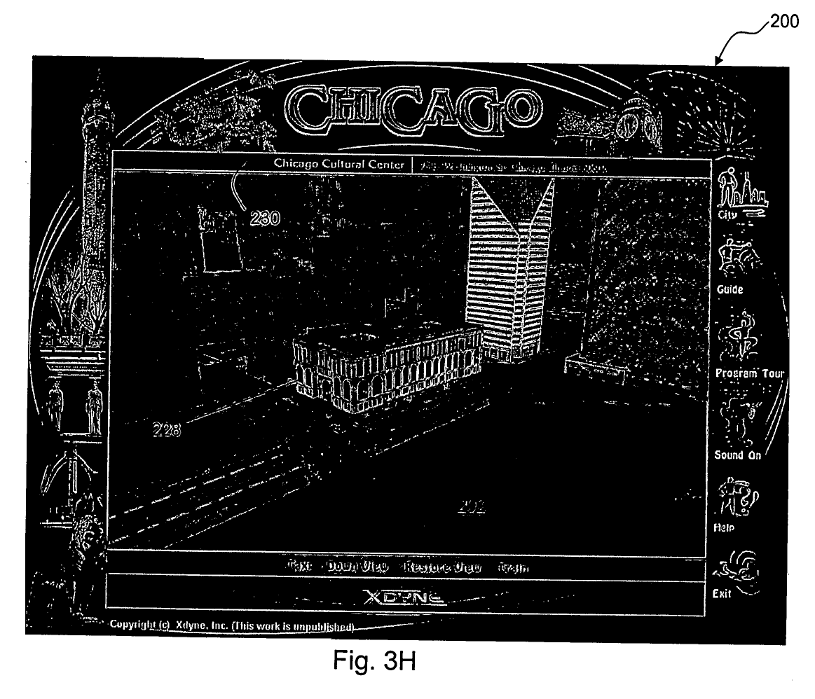

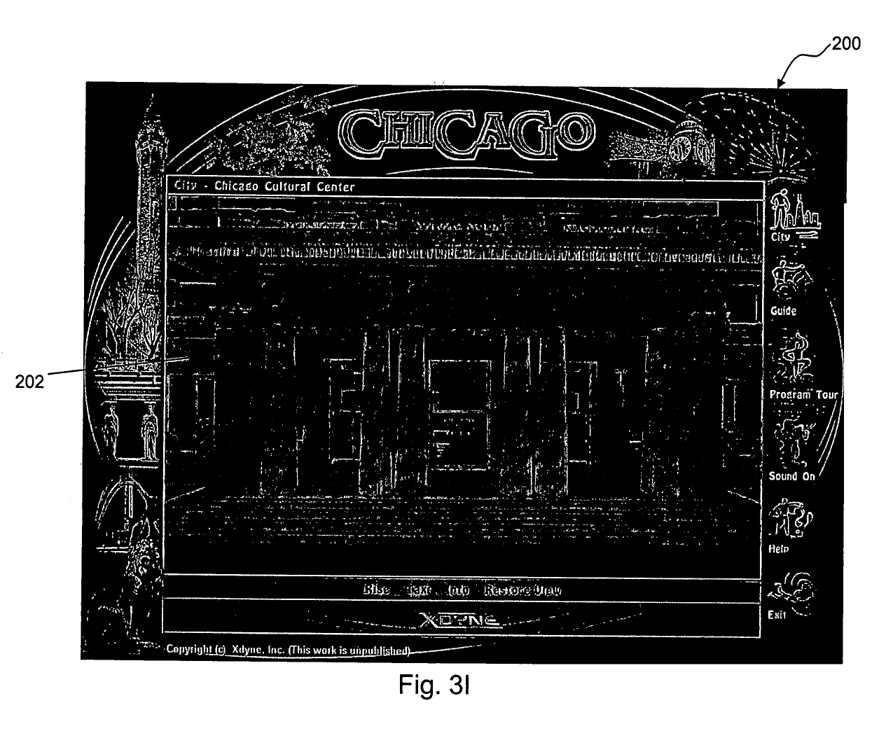

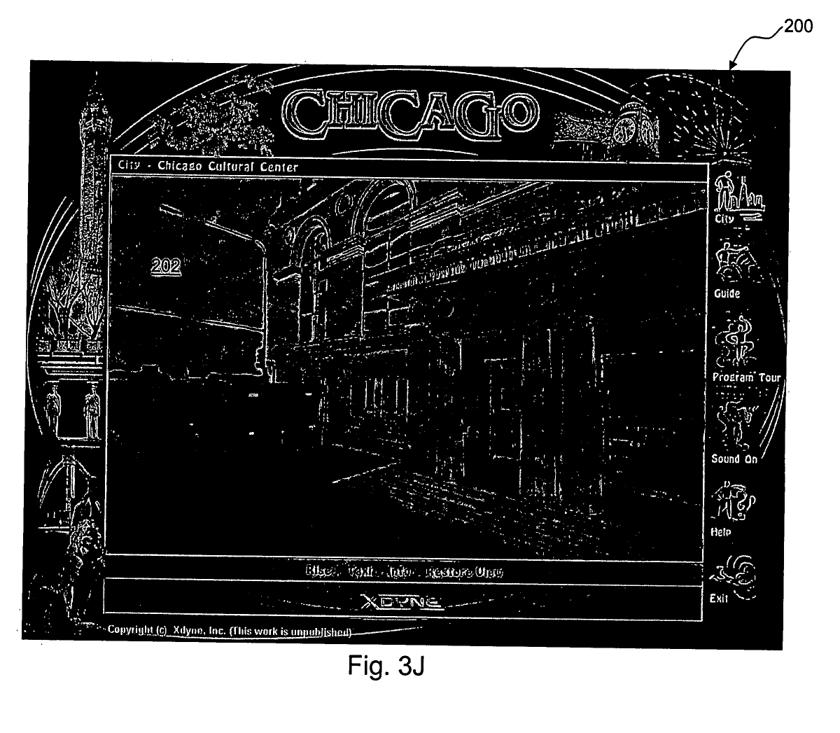

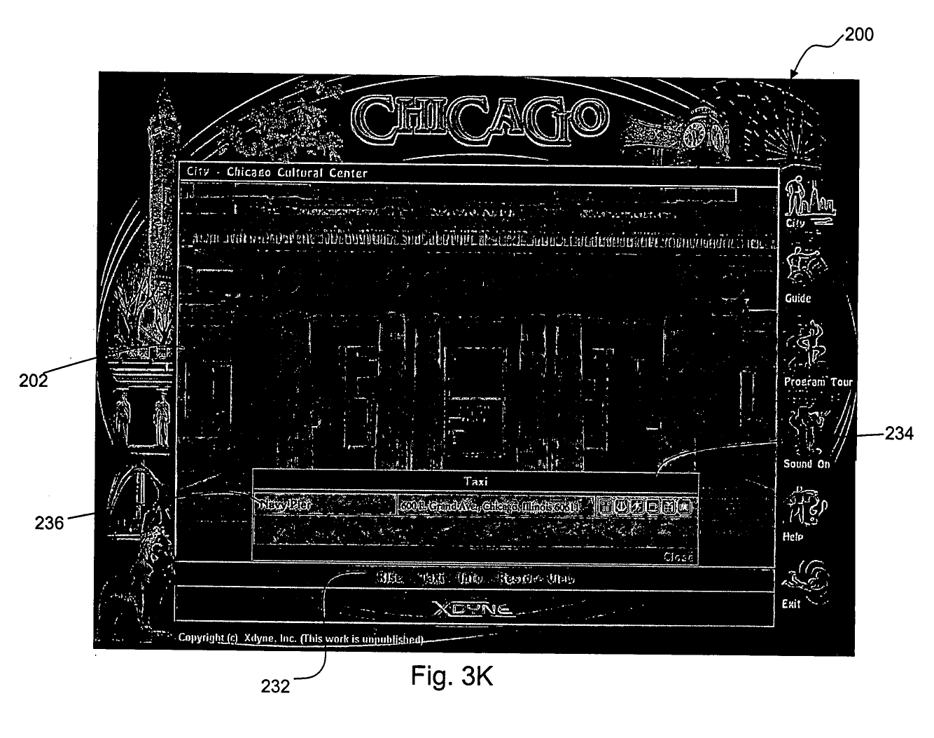

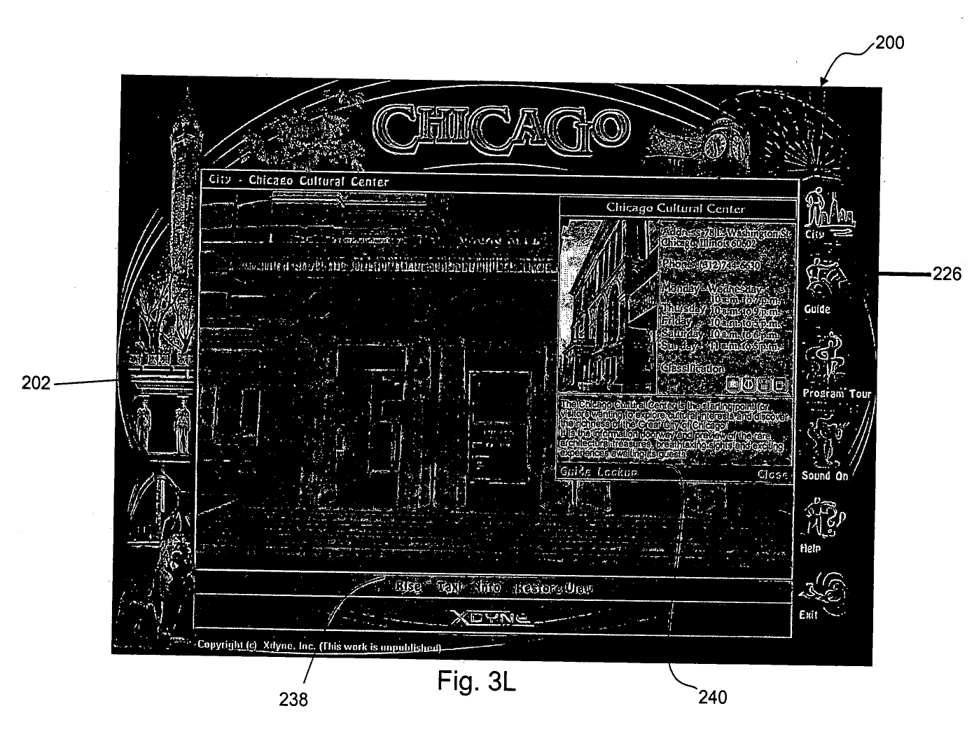

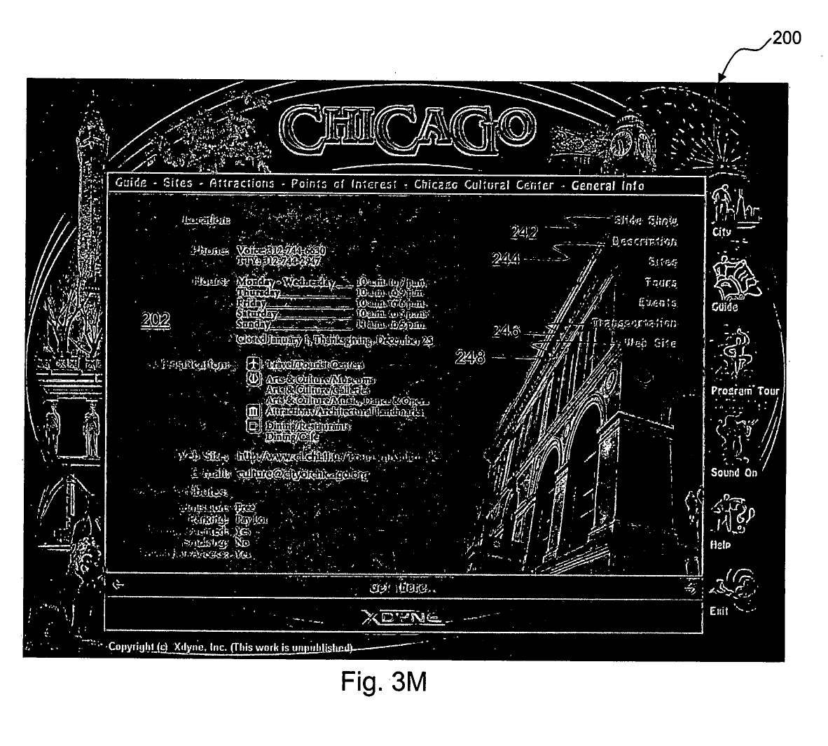

Referring now to FIG. 3A, an interface window 200 for the virtual three-dimensional environment of this embodiment is illustrated. In this embodiment, the interface window 200 includes an inner window 202 which currently displays an incomplete example of the virtual city model of one embodiment of the present invention. To access and/or activate the inner window 202 in a city mode, the user activates or presses the city input or button 204. Alternatively, the user could activate the inner window 202 by clicking inside the inner window 202. Once the inner window 202 is activated in the city mode, the user is able to navigate throughout the virtual city model.

In addition to or instead of navigating throughout the virtual city model, the user may want to obtain further information about the virtual city model. In this embodiment, the user can access a city guide by activating or pressing the guide input or button 206. The city guide is also displayed in the inner window 202 and includes information relating to the defined city and business elements within the virtual city model. The city guide will be discussed in greater detail below. If desired, the user may also activate a demonstration feature by activating or pressing the program tour input or button 208. Upon activating or pressing the program tour input or button 208, the user is guided through a brief tour of the virtual city model.

In this embodiment, the virtual city model includes audio features such as sounds effects and musical accompaniment designed to enrich the user's experience. The audio features for virtual city model can be toggled on and off by activating or pressing the sound input or button 210. If the user has any questions about the virtual city model, assistance can be requested by activating or pressing the help input or button 212. In addition, if the user is finished exploring the virtual city model, the user can exit the virtual city model by activating or pressing the exit input or button 214.

As described above, the user has the ability to freely navigate throughout the virtual city model. Any suitable navigation tool may be employed in the present invention. Referring now to FIG. 3B, it is noted that the user has zoomed in on the city model and is now examining the details of the virtual city model from a shorter distance. FIG. 3C illustrates a further view of the virtual city model accessible via the user navigation ability.

In FIG. 3C, just as in FIGS. 3A and 3B, the viewing angle afforded to the user may be described as a perspective or angle view of the virtual city model. However, it should be appreciated that alternative viewing angles of the virtual city model may be available to the user in accordance with the present invention. In this embodiment, the user can change the viewing angle to a top or down view of the virtual city model by activating or pressing the down view input or button 216, or by double clicking the right mouse input or button in the city window 202.

The down view of the virtual city model is illustrated by FIG. 3D. Just as with the perspective viewing angle of FIGS. 3A to 3B, the user is able to freely navigate the virtual city model while the viewing angle is in the down view illustrated by FIG. 3D. Thus, the virtual city model enables a user to virtually experience and become accustomed with the city from a number of different viewing angles. This provides one advantage which is to facilitate a user becoming familiar with a city. To return to the perspective viewing angle, the user activates or presses the angle view input or button 218.

In addition to the above-described viewing angles, this embodiment of the virtual city model includes two additional viewing angles. In this embodiment, the user activates a car view as illustrated in FIG. 3E by activating or pressing the letter ‘C’ on an attached keyboard. Here, the user is able to view the virtual city model as if they were riding in an automobile through the city. Alternatively, the user may view the city from a train view by activating or pressing the train input or button 220. The train view of the virtual city model is illustrated in FIG. 3F. To exit the train view and return to angle view, the user activates or presses the rise input or button 222.

This embodiment includes four distinct viewing angles. However, it should be appreciated that in alternative embodiments, a plurality of suitable views of the virtual city model may be available including, for example, a helicopter view, a boat view, an observation deck view, a pedestrian view, and a user-defined view.

While navigating the virtual environment, the user may encounter or desire to see a defined city element that the user would like to explore further. In this embodiment, the user is able to right click on the defined city element to request further information pertaining to the defined city element. Additionally, the user may double right click on the defined city element to obtain detailed information pertaining to the defined city element.

Referring now to FIG. 3G, the user has navigated to a James R. Thompson Center 224 in the city of Chicago, which is a defined city element in this embodiment. When the user right clicks on the James R. Thompson Center 224, an information window 226 is activated. The information window 226 displays information pertaining to the defined city element with which it is associated. In this embodiment, the information window 226 is associated with the James R. Thompson Center 224 and displays information pertaining to same including an address, a phone number, hours of operation and a description.

In this embodiment, the information window 226 provides the user with general information pertaining to the associated city element. However, it should be appreciated that in alternative embodiments, the information window 226 could display more or less information pertaining to the defined city element with which it is associated depending upon the level of detail required by the intended user.

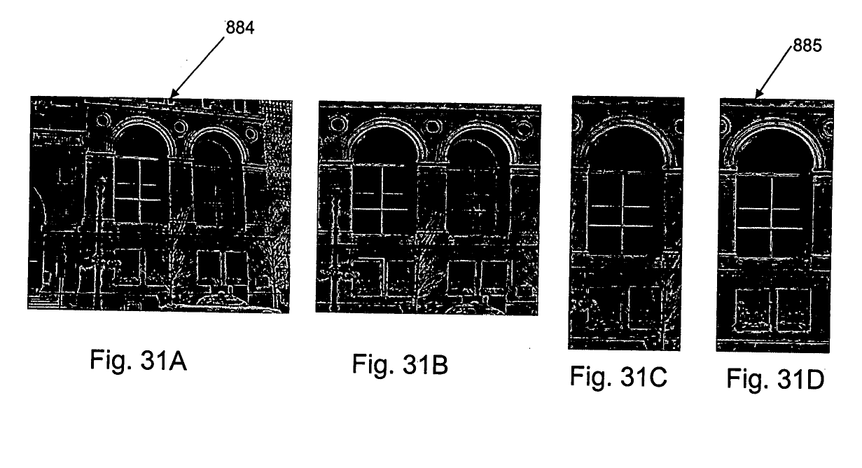

Referring now to FIG. 3H, the user has navigated to a Chicago Cultural Center 228, which is a defined city element in this embodiment, as indicated by location bar 230. When the user double right clicks on the Chicago Cultural Center 228, the inner window 202 presents the user with a street level view of the Chicago Cultural Center as illustrated by FIG. 31. From the street level view, the user is still able to navigate and explore their surroundings. For instance, the user can look to their left in the inner window 202 as illustrated by FIG. 3J. Thus, at each active or defined city element, the user can view surrounding structures in the city to become familiar with the area of the city around the defined city element.

Referring now to FIG. 3K, the user has pressed the taxi input or button 232 and is presented with a list of available locations as indicated by taxi window 234. In this embodiment, the available locations correspond to defined city elements within the virtual city model. Thus, the user can go to a Navy Pier 236 by clicking same within the taxi window 234. In this embodiment, only one defined city element is listed in taxi window 234. However, it should be appreciated that any suitable number of defined city elements may be listed in taxi window 234 in alternative embodiments.

Referring now to FIG. 3L, the user has pressed the info input or button 238 and the information window 226 for the Chicago Cultural Center is displayed. As previously described, the information window 226 in this embodiment includes displays information pertaining to defined city element including an address, a phone number, hours of operation and a description. In addition, the information window includes the guide lookup input or button 240.

By activating or pressing the guide lookup input or button 240, the user causes the inner window 202 to display the associated guide information for the defined city element as indicated by FIG. 3M. The guide information includes detailed information pertaining to the defined city element. In addition, it includes links to further information concerning the defined city element.

For instance, by activating or pressing the slide show input or button 242, the user can view a slide show of the defined city element. A detailed description of the defined city element can be viewed by activating or pressing the description input or button 244 while transportation information related to the defined city element can be viewed by activating or pressing the transportation input or button 246. In addition, the user can view the website for the defined business or city element by activating or pressing the website input or button 238.

It should appreciated that links to any suitable source of information pertaining to the defined city element can be included in the guide information displayed in inner window 202. For example, the guide information may include videos, detailed tours, products, services or other features pertaining to the defined city element in accordance with the present invention. In this manner, the guide information enables the user to explore and become familiar with the defined city element and its surroundings.

In addition to the above-described features, the virtual city model of this embodiment includes a number of features that relate to environmental aspects within the virtual city model. For instance, the virtual city model may include conventional artificial intelligence for simulating vehicles, signs, signals and the like within the virtual city model. In addition, weather conditions, seasons and time can be simulated within the virtual city model. For example, conditions in the virtual city might get darker to simulate the transition from day into night.

All of the above-described environmental aspects of the virtual city model can be preprogrammed or may be obtained and influenced through the Internet. For instance, the actual time in the real-world city could be obtained through the Internet and used to influence the simulated time in the virtual city. Similarly, the actual weather conditions in the real-world city could be obtained through the Internet and used to influence the weather conditions in the virtual city. In addition, the environmental aspects could also be user-selectable. In this manner, the user is able to experience varying environmental conditions in the virtual city in order to become more familiar with how the real-world city might be presented in the given environmental conditions.

It should thus be appreciated that various embodiments of the present invention can provide a plurality of different view of the city. For instance, the views of the city can include riding or driving through the city, flying through the city, walking through the city, jumping between different related or unrelated city elements and city element identification. It should be appreciated that the other views of the city could be provided in accordance with the present invention.

### Methods of Generating Revenue Based on the Virtual Three-Dimensional Environment

The virtual three-dimensional environment described in the above embodiments presents a user with a versatile tool for virtually discovering and exploring a real-world environment without the associated time, risks and costs involved in actually exploring the real-world environment. It should be appreciated that this versatile tool, that is, the virtual three-dimensional environment, can be used to generate revenue in a number of ways. Suitable uses for the virtual three-dimensional environment and corresponding methods for generating revenue therefrom will be described below.

At the outset, the virtual three-dimensional environment can be used a an economic development tool. The virtual three-dimensional environment provides a comprehensive visual representation of an existing or non-existing building with a comparative surrounding dynamic and static data which can be used for redevelopment of residential areas and sales and investment in business. It should be appreciated that one intended use of the virtual three-dimensional environment as an economic development tool would be in business relocation. Businesses or organizations can simulate an intended or proposed business location without actually developing the business location beforehand. In addition, the virtual three-dimensional environment could also be used for zoning purposes. Thus, a proposed building or similar structure could be simulated in a given location before a zoning decision is made in the real-world.

In addition, the virtual three-dimensional environment in the form of a virtual city could serve as an Internet portal. In this manner, the virtual city would serve as an entry point to a number of websites corresponding to defined city elements within the virtual city. In addition, the interface for the virtual city could provide access to a search engine for locating additional web resources within or outside of the virtual city.

Another use of the virtual three-dimensional environment could be for market research purposes. Data collected from end-users of the virtual three-dimensional environment could be used to compile market research statistics. Market research statistics could be compiled by monitoring and analyzing the end-user's interaction or behavior within the virtual three-dimensional environment. In addition, demographic information could be collected from the end-users to enhance the market research statistics. Demographic information could include many factors relating to the end-users including, for example, their address, zip code, phone number, salary, marital status, gender, profession, ethnic background, homeowner status, age, and education level.

One additional suitable use of the virtual three dimensional environment is for business and/or organization promotion. Specifically, defined city and business elements within a virtual city model serve to promote a corresponding business or organization. In turn, money is collected from these businesses and organizations in order to have their interest represented as a defined city element in the virtual city model.

Although a number of suitable uses are described herein, it should be appreciated that there are a plurality of suitable commercial uses for generating revenue using the virtual three-dimensional environment of the present invention.

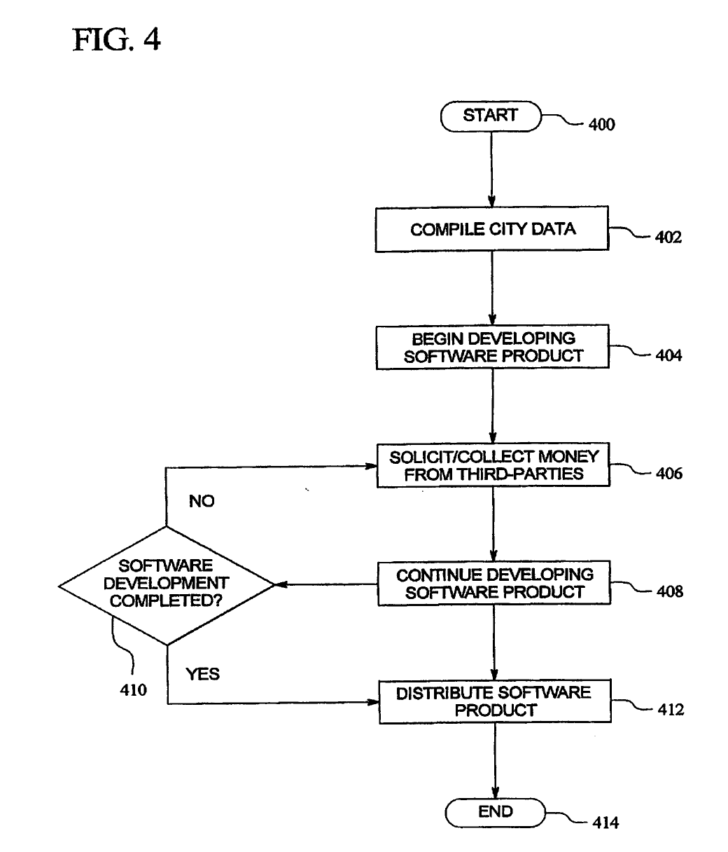

Referring now to FIG. 4, a method for building a software product to generate revenue is illustrated. The method starts at block 400 and continues to block 402 where city data is compiled. The city data in this embodiment includes information relating to city business and tourist information as well as to city geographical information. City data can be collected and compiled using any suitable technique. One suitable technique is described above in greater detail in the embodiment for creating the virtual reality three-dimensional environment.

After the city data has been compiled, development of the software product begins as indicated by block 404. The software product in this embodiment includes a virtual three-dimensional model of a city and is created using the compiled city data. The creation of the three-dimensional model of the city to be used in the software product can be accomplished using any suitable technique. One suitable technique is described above in the embodiment for creating the virtual reality three-dimensional environment.

After development of the software product has begun, money is solicited and/or collected from third-parties as indicated by block 406. The third-parties include any suitable party that has a realizable interest in the software product, particularly the virtual city model. For instance, a retail business located within the inner boundaries and desiring to promote awareness of its business by enabling access to its business and related information in the virtual city model would be one suitable third-party. Additionally, a sports franchise desiring to promote its products, facilities and talent in the virtual city model would be another suitable third-party. It should be appreciated that there are a plurality of suitable third-parties that have business and/or promotional interests that can be represented using the virtual city model of this embodiment.

After money is solicited and/or collected from the third-parties, development of the software product continues as indicated by block 408. Then, a determination is made as indicated at decision diamond 410 as to whether software development is completed. Money is once again solicited and collected from suitable third-parties as illustrated by the block 406 if software development is not completed. Thus, development of the software product is ongoing while money is continuously solicited and collected from interested third-parties. The money collected from third-parties can therefore be used to fund the development of the software product and to generate revenue.

It should be appreciated that the addition of initial third-parties to the virtual city model will make the end product more attractive to additional third-parties. For instance, attracting a recognizable anchor tenant or business for the virtual city model would attract other companies to be a part of the virtual city model. It should also be appreciated that the money charged to third-parties may reflect the level of involvement and interaction the third-party desires within the virtual city model. In-depth interaction and involvement will require a more significant monetary investment on the part of the third-party while a lesser role in the virtual city model will not require as significant of a monetary investment.

For example, in this embodiment, there are three participation levels or packages available to third-party investors. The first package is a basic package and it includes basic information or passport data pertaining to the third party such as the name, address, phone number, facsimile number, a picture or logo of the third party, and an integrated electronic mail and website. The approximate price for the basic package is about three thousand dollars and that price includes twenty five copies of finished software product for the third-party to distribute.

In this example, the second package is an advanced package and it includes extended passport data. Extended passport data includes the basic passport data listed above and integrated electronic mail and website as well as multimedia content that is provided by the third-party. The approximate price for the advanced package is about eight thousand dollars and that price includes one hundred copies of finished software product for the third-party to distribute.

The third and final package in this example is an elite package and it includes all of the same information as the advanced package in addition to a custom interactive virtual reality environment including building interior modeling. The approximate price for the elite package is about thirty thousand dollars. In one embodiment additional costs will be incurred for additional development of the package. The elite package includes one thousand finished copies of the software product for the third-party to distribute.

When it is determined at decision diamond 410 that the software product has been completed, then the software product is distributed as indicated by block 412. The software product is distributed to any suitable party. For instance, consumers will be a likely target for distribution because they will be the largest audience for retail and commercial businesses as well as sports franchises, tourist attractions, and the like.

Another suitable party includes travel agents and the like because they will be better able to make informed decisions for clients regarding lodging, dining, shopping and the like based on their experience with the virtual city model. One other suitable party includes convention attendees who will be visiting the real-world city and might require information related to lodging, dining, entertainment, shopping and the like. Another suitable party includes real estate agents who could use the virtual city model in sales programs to sell city property and banks, businesses and trade offices to increase trade and revenues. It should be appreciated that the suitable parties for distribution is a very large pool and will be greatly influenced by the third-parties that invest in the virtual city model.

In this embodiment, a limited number of copies of the software product are given to the third-parties as part of their initial investment. Additional copies of the software product can be purchased, thereby generating additional revenue. In addition, the creator of the software product is able to sell copies of the software product to interested parties in an effort to generate additional revenue. The third-parties are able to distribute their copies as they desire. The method subsequently ends as indicated by block 414.

In this embodiment, the software product is completed and subsequently distributed and the method ends thereafter. It should be appreciated that in alternative embodiments, development of the software is a dynamic and ongoing process. Thus, the software product is temporarily completed and distributed. That is, a run-time version of the software product is created and distributed, but development of the software continues. Further money is collected and solicited from third-parties, thereby generating further revenue. In this fashion, a plurality of updated run-time versions can be created and distributed while development of the software continues.

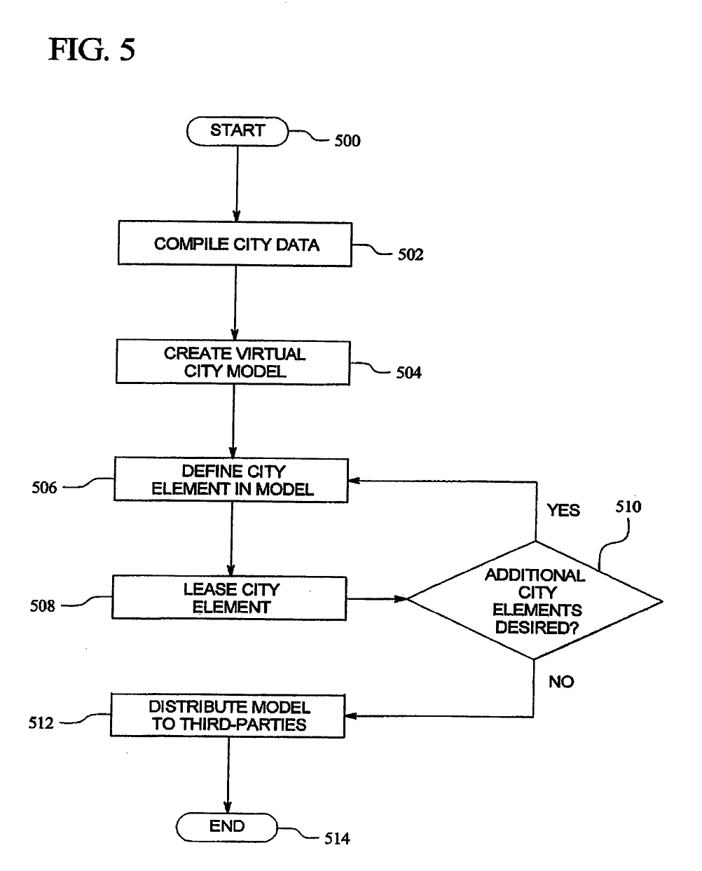

Referring now to FIG. 5, one other method for generating revenue is illustrated. The method begins at block 500 and continues to block 502 where city data is compiled. As described above, the city data in this embodiment includes information relating to city business and tourist information as well as to city geographical information, and can be collected and compiled using any suitable technique. One suitable technique is described above in greater detail in the embodiment for creating the virtual reality three-dimensional environment.

After the city data has been compiled, a virtual three-dimensional city model is created as indicated by block 504. The creation of the virtual city model in this embodiment is accomplished according to the process described above in the embodiment for creating the virtual reality three-dimensional environment.

Once the virtual city model is created, a city element is defined in the virtual city model as indicated by block 506. It should be appreciated that a defined city element can be any suitable element within the city as described above. The city element is then leased to a corresponding real-world party as indicated by block 508.

Generally, even though not required, the corresponding real-world party as the lessee will have some affiliation with the leased city element. For instance, where the defined city element to be leased is a hotel, the lessee could be the hotel owner. Alternatively, it should be appreciated that the lessee of the hotel could also be the franchisor where the hotel is part of a larger franchise.

It is determined at decision diamond 510 whether additional city elements are desired. If additional city elements are desired, then an additional city element is defined as indicated by block 506. The newly defined city element is then leased as indicated by block 508. In this fashion, a plurality of city elements can be defined and leased, thereby generating revenue for the lessor.

When it is determined at decision diamond 510 that no additional business elements are desired, then the virtual city model is distributed the third-parties as indicated by block 512. The virtual city model in this embodiment is distributed to any suitable third-party. As described above, consumers will be a likely target for distribution because they will be the largest audience for lessees within the virtual city model such as retail and commercial businesses as well as sports franchises, tourist attractions, and the like.

Again, suitable third-parties for distribution would also include travel agents, convention attendees, business travelers and the like. Of course, it should be appreciated that the suitable third-parties for distribution includes a very large pool of possible parties that will be greatly influenced by the lessees in the virtual city model.

In this embodiment, a limited number of copies of the virtual city model are given to the lessees as part of their initial investment. Additional copies of the virtual city model can of course be purchased, thereby generating additional revenue. In addition, the creator of the virtual city model is able to sell copies of the to interested parties in an effort to generate additional revenue. The lessees are able to distribute their copies as they see fit. The method subsequently ends as indicated by block 514.

In this embodiment, the virtual city model is completed and subsequently distributed and the method ends thereafter. It should be appreciated that in alternative embodiments, development of the virtual city model is a dynamic and ongoing process. Thus, copies of the virtual city model may be periodically distributed, but development of the virtual city model may continue. Further city elements are defined and leased, thereby generating further revenue. In this fashion, a plurality of updated copies of the virtual city model can be created and distributed while development of the software continues.

It should be appreciated that the virtual city model of the present invention can be stored and distributed via any suitable storage and/or distribution medium. For example, the virtual city model may be stored on optical storage such as compact discs (CDs) and digital versatile discs (DVDs). CDs and DVDs provide a convenient and inexpensive mode of mass storage and distribution. In addition, the virtual city model may be distributed over a network such as the Internet. Another example of a network is a broadband network such as a cable or satellite network. Alternatively, copies of the virtual city model could be distributed via CDs or DVDs and updates to the virtual city model could be obtained via the Internet. It should be appreciated that a software product containing the virtual city model may be distributed in the same fashion.

Based on the above described methods of generating revenue, it should be appreciated that the present invention serves to illustrate methods of generating revenue based on business promotion where the location of the business is physically illustrated in three-dimensions in a virtual city model in relation to a plurality of points of interest in the city within proximity to the location of the business. The business is preferably charged a sum of money in order to have its business so illustrated. In this embodiment, the proximity in the virtual city model can be either predetermined or defined by a user. The user is therefore able to virtually explore the business in relation to other businesses within a proximity to the business. This also enables the user to become familiar with the environmental surroundings of the business.

It should be appreciated that the methods of generating revenue are not limited to business promotion and can be applied to promotion of any element within the city including tourist attractions, transportation facilities, hospitals, universities and the like. It should also be appreciated that the methods of generating revenue are not limited to a virtual city model and can be applied to any virtual model of a suitable environment or geographic location.

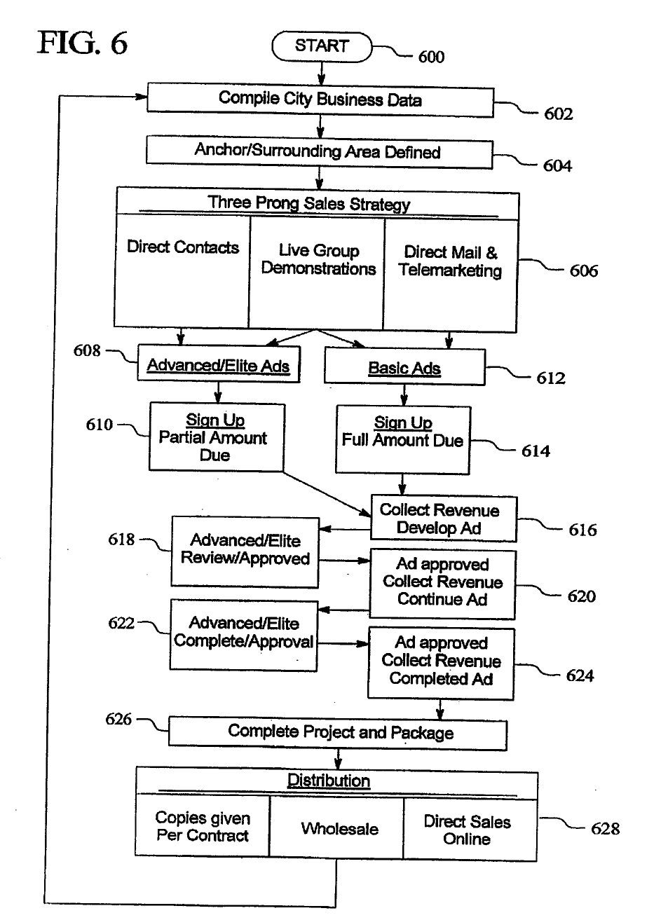

Referring now to FIG. 6, one other method for generating revenue by marketing a three-dimensional city model in a cyclical revenue stream is illustrated. The method starts at block 600 and continues to block 602 where city business data is compiled. Compiling city business data according to this method includes compiling information relating to city businesses, tourism information, real estate and development plans, as well as city geographical information and the like. City business data can be collected and compiled using mailing lists, tourist guides, business magazines and newspapers or any other suitable information source. One suitable technique for compiling city business data is described above in greater detail in the embodiment for creating the virtual reality three-dimensional environment.

Once the city business data has been compiled, suitable anchor buildings and area businesses are located and chosen, and a surrounding area is defined as indicated by block 604. Major commercial buildings, attractions, office buildings, residential and commercial real estate, government buildings, transportation depots, universities, and hospitals are examples of sites that should be considered as anchor buildings. In general, anchor buildings serve a basic or necessary function, have an interesting architectural design, or are well suited for a visual representation that helps clarify the interior structure of the anchor building. The buildings act as anchor sites in that they are evenly located throughout the entire virtual city model. Anchor building are chosen in order to represent a full spectrum of the city and to cause a flow of exploration throughout the area surrounding the anchor building, thereby encouraging the end user of the virtual city model to access the entire city model. After locating and defining several major buildings in various categories, a selection process begins whereby buildings are chosen such that the building interiors can be completed in a predetermined project time frame and according to parties who have indicated an interest in participating in the virtual city model. It should be appreciated that anchor building and sites can be located and chosen according to any suitable technique. One suitable technique is described above in greater detail in the embodiment for creating the virtual reality three-dimensional environment.

After defining anchor buildings and the corresponding surrounding area, a three prong sales strategy begins as illustrated by block 606. The three prong sales strategy includes three general sales approaches that serve to general advertising revenue. First, selected third party anchor buildings are contacted directly about advertising opportunities in the virtual city model. Second, live demonstrations of the virtual city model are presented to business and professional associations, chambers of commerce, city organizations and scheduled groups of interested parties in order to further generate advertising interest in the virtual city model. Finally, direct mail and telemarketing is used to contact third parties surrounding the anchor buildings in order to generate further interest in the virtual city model.

The three prong sales strategy described above with reference to block 606 generates interest in the virtual city model and enables parties who are interested in advertising via the virtual city model to consider two categories of advertising development. The first category of advertising development includes advanced and elite advertising packages as illustrated by block 608. Parties choosing the advanced or elite advertising packages generally originate from direct contact or from live group demonstrations.

Parties choosing an advanced or elite advertising package must sign up for the package as illustrated by block 610. Signing up an advanced or elite advertising package requires a deposit or a partial up-front amount and an approval process that includes two other partial payments. Generally, payments for an advanced or elite advertising package are accepted either in person or through the mail. However, it should be appreciated that any suitable form of payment will be accepted in alternative embodiments.

The second category of advertising development includes a basic advertising package as illustrated by block 612. Parties choosing the basic advertising packages generally originate from live group demonstrations or from direct mail and telemarketing. The basic advertising package includes a sign up process as indicated by block 614 which requires that the total amount for the basic advertising package is due once all of the party's information is submitted. Generally, the party signing up for the signs up online and submits information online including pictures and logos. The advertisement for the basic advertising package is automatically developed using an online program, and the party approve the finished advertisement and submits payment online. However, it should be appreciated that the basic advertising package can be modified in alternative embodiments to include other forms of advertising development and payment acceptance.

After the sign up process has been finished, revenue collection and advertising development begins as illustrated in block 616. It should be appreciated that basic advertising packages are generally completed automatically and revenue collection and advertising development will apply in general to advanced and elite advertising packages. Development and production of advanced and elite advertising packages begins once money is collected as illustrated by block 618 and are subject to review and initial approval by the party requesting the package. Once the party approves the initial advertising package, further revenue is collected and the development of the advertising package continues as indicated by block 620. The completed advanced and elite advertising package must be reviewed and approved by the party requesting the package as illustrated by block 622. After the party approves the completed advertising package, the final amount due under the advertising package is collected as indicated in block embodiment 624.

After a selected number of advertising packages have been completed, development of one version of the virtual model city is completed and packaged as indicated by block 626. Completion of the virtual city model is described above in greater detail in the embodiment for creating the virtual reality three-dimensional environment.

Block 628 indicates that distribution of one finished version of the virtual city model begins includes three distribution approaches. First, copies of the virtual city model are given to the basic, advanced, and elite third parties per their respective advertising development contract. The parties are free to distribute these copies as they see fit. Second, copies of the virtual city model are distributed wholesale to other third parties, specific industries and retail stores. Lastly, copies of the virtual city model are distributed via direct online sales.

After distribution of the finished version of the virtual city model is complete, block 102 illustrates that the method begins again. That is, the development cycle repeats and new third parties are added to the virtual city model and contracts are renewed with parties from the previous version of the virtual city model. Each cycle increases the information contained in the virtual city model, thereby enhancing the virtual city model and increasing the overall revenue stream. In this regard, it should be appreciated that interest in the virtual city model will increase over time and the revenue stream will therefore increase over time.

### Public Domain Objects and their Representation

As indicated above, objects such as public domain objects in the virtual actual city of the present invention can be represented in many different manners. In one embodiment, the city database contains information about number of city objects, referred to s “objects in public domain”. The database includes general non-commercial information about city physical structures, layout and transportation. The set of public domain objects includes, but is not limited to: (a) buildings (purely as architectural objects, i.e. not as places of business); (b) unique architectural objects (such as bridges, sculptures, fountains, etc.); (c) streets, squares/plazas, parks and beaches; and (d) train lines/stations, bus/trolley routes/stops, parking places, taxi stands, piers, etc. Such public domain objects descriptions do not need to contain any specific business-related data, such as business names and trademarks, telephone numbers, web & e-mail addresses, etc (except if the virtual actual 3-D city of the present invention is being used for city planning, zoning, etc. where the business-related data may be the governmental agency controlling or managing such object.) The publicly available information can be restricted to: (a) the unique (non-business) name (for example—“Navy Pier” or “Madison St.”); (b) the generic (type) name (for example “Parking Lot” or “Bus Stop”); (c) the neighborhood location (for example, “The Loop” or “River North”); (d) the city address; and (e) the general short description. It should be appreciated that not all items from the above list are applicable to particular type of object. For example, parking places or bus stops may not have any description (if this was not specifically acquired by a business entity managing such object), and streets or unique architectural objects may not have an address.

In various embodiments of the present invention, certain additional information may also be provided for certain object types. For example, street information may include traffic direction, a list of buildings located on the street, and/or a list of intersecting streets. This may require introduction of additional information displays for certain object types, which will be accessible via bookmarks or “tabs” similar to standard bookmarks reserved for web and multimedia displays.

Similar to business objects, public domain objects can be represented in a city guide via sets of full-screen informational displays, though originally such displays may not contain as much information as commercial object displays. This will depend in part on the desired use of the virtual actual 3D city.

### Alternative 3D Virtual Actual City/Environment Uses

As discussed above, it should be appreciated that the same 3D virtual actual city and database structure can produce several different streams of revenue. After the 3D virtual actual city is completed at least to a minimum level, the 3D virtual actual city can be modified and used for several diverse and compelling purposes. The following are distinct revenue-generating uses for the 3D virtual actual city of the present invention which meet individual, government or business needs.

The 3D virtual actual city can be employed as a greatly improved yellow page concept that goes from point of interest examination, to purchase, all in one sequence. A user can select either an object (such as building in the virtual city) or through a listing find a business, attraction, real estate investment, etc. The user can examine all the available information within the objects database and web site by selecting all the options in the object. The user can also go to the corresponding web site and “purchase” products and services available on their web site.

The 3D virtual actual city can be used as a market research gathering tool for business, city and product information. The 3D virtual actual city can be used to create a database of dynamic market information for sales. For instance, the 3D virtual actual city can be used to enable an advertising client to know that a user went to his web site through the 3D virtual actual city. The cached information can be gathered from the user when he goes online (such as: what building or object did the user go to first?, what information did they look for?, how long did they spend there? etc.). This provides a database of market information that describes what, when, how and where people go in a city when they are searching for information. Thus, user behavior information can also be tracked using the present invention.

The 3D virtual actual city can be employed to create a generation of mini products such as individual promotional CDs which showcase features of a particular site and business within the area of the 3D virtual actual city and for their specific purpose. These “pull-outs” provide a marketing piece for universities, hotels, attractions, new real estate developments, etc. The parameters of these areas are wallpapers of the outside surrounding areas. In other words, if I walk out the door of a hotel and walk around the building, the buildings across the street become a panoramic wall view and are the end boundry of my environment, while the interiors of my building may be included in my “pull-put”.

The 3D virtual actual city can be employed as a retail DVD director, tour book, and comprehensive map for sale. This could be strictly a map and guide book with tourist information for direction and travel information.

The 3D virtual actual city can be employed as a historical archive of a city such as the City of Chicago architecture from year to year with potential highlights and points of interest. Over time as the city changes, these changes can be recorded and can enable the user to see the city, part of the city or specific locations at different time periods. The 3D virtual actual city can also go back in time (from when it was created) for an even more historical perspective. For instance, multiple buildings on one location which have been torn down and replaced could be viewable and accessible using the 3D virtual actual city of the present invention.

The present invention can also be employed to create specific 3D virtual actual cities for certain industry uses and can be used to become an interface to link or relate multiple databases that pertain to that industry and that contain data that is important to the end users. The 3D virtual actual city creates menus of humanistic, visually understandable perspectives, and that organizes, binds and makes available all pertinent information when accessing an object.

For example, the 3D virtual actual city can be employed to provide a consistent, understandable and easy to use interface to access city service informational databases for citizens, zoning regulators, land developers, assessor's offices, and other governmental and non-governmental agencies.

In another example, the 3D virtual actual city can be employed as a fire and safety tool to determine street and building locations, hazardous material situations, evacuation routes, water main sites, etc. The 3D virtual actual city can also be used to assist fire, police and other like personal in emergency situations where such people need to immediately become familiar with a location such as a high-rise building.

In another example, the 3D virtual actual city can be employed as a police and home security tool. The 3D virtual actual city can be employed to enable coordination of various policing bodies, video cameras, internal databases, specific locations and routes combined with internet or other network connections to provide safeguarding protection.

In another example, the 3D virtual actual city can be employed as a planning and urban development tool. The 3D virtual actual city can be employed for shadow casting problems, landscaping, traffic flow, and opposition concerns to be addressed before a development is started or in other situations.

In another example, the 3D virtual actual city can be employed as a plan and tree inventory/planning tool for park districts and forest preserves.

In another example, the 3D virtual actual city can be employed as a utility service tool such as for “J.U.L.I.E.” in the Chicago metropolitan area. The 3D virtual actual city can be employed for providing comprehensive, visual location information for electric lines, gas pipes, water and sewer lines, etc.

In another example, the 3D virtual actual city can be employed as an economic development tool to reveal the unrealized “big picture possibilities” to attract a greater number of potential property investors and other interested in the city.

It should thus be appreciated that the 3D virtual actual city can be employed for additional different purposes as employment location, sales route planning, real estate directory, real time catalog, and a variety of other uses.

The 3D virtual actual city of the present invention provides a virtual environment make access to large amounts of information less complicated, faster to use and in a format that is completely natural to the user. The 3D virtual actual city of the present invention provides the next generation medium for actual city or environmental information distribution. The present invention also facilitates the gathering and collecting of information regarding user behavior which can be tracked while the user is using any of the above embodiments of the present invention.

### General Database Software Structure for One Implementation of the Present Invention

The following generally sets forth a database and software structure for one implementation or embodiment of the present invention. One embodiment of the present invention includes a 3D-city database and a city guide/business directory database. One alternative embodiment also includes a client advertisement database. It should be appreciated that other databases could be employed in accordance with the present invention. It should also be appreciated that these databases could also be a single database with different files.

One embodiment of the present invention includes a 3D-city explorer software, 3D-interior navigator software, guide/directory browser software, client advertisement viewer software, script player software, and live update software.

In this embodiment, the 3D city explorer software provides the virtual reality user interface which facilitates real-time rendering of the virtual reality environment on a user display, navigation within the displayed virtual reality environment, and interaction with active 3D-objects. The 3D city explorer software also interacts with the guide/directory browser upon user request to display or go to client ad screens.

The guide/directory browser software implements the graphical user interface to city guide/business directories and client ad packages and provides browsing of various site and businesses listings, content searching, sorting and filtering, multimedia and web site display. The guide/directory browser software Interacts with the 3D city explorer upon user request to highlight search results on 3D-city map, or display or go to a site in the virtual city.

The online update client software provides program automatic updates via the internet or other suitable data network. The online update client software keeps the program database and code up-to-date by downloading necessary update packages from the implementer or implementer update server.

The virtual tour manager software facilitates virtual tours within the virtual city environment and automatic browsing of client ad packages content (such as multimedia presentations and slide shows). The virtual tour manager software is also used as an engine for program interactive help (which in one embodiment is a set of virtual tours used to explain the features of the system). This software may also provide both recording and playback of user-defined virtual tours.

One embodiment of the present invention includes an interactive web site, an online update server and an online client data server.

The interactive web site formed from a generic web site template (for any city), and provides general information about the product for users and potential or current clients. The interactive web site includes e-commerce support for online ordering of selected city DVDs, as well as client initial registration and online purchase of ad packages. The interactive web site may be linked to other virtual city web sites for other cities. The interactive web site interacts with the online client data server upon visitor request to create and register a new client account on the server.

The online update server software is an internet-enabled software which serves updates to client applications. When started, the online update server software can be configured to poll the update server for available updates. If new content is available for particular client, it will be assembled by the server into one integral a package based on current client configuration, and granted for download.

The online client data server has internet enabled software for providing a web user interface for implementing management of a virtual city client online account. The online client data server is architecturally integrated with the virtual city web site. This enables clients to enter/modify text and graphics for their ad packages and submit this information for scheduled updates. The online client data server includes e-commerce support (for online ordering of certain types of add-on option) and online technical support.

One embodiment of the present invention includes architectural photography processing tools, 3D city design tools, guide/directory design tools, and online update tools.

The architectural photography processing tools are a set of software utilities and technical documentation for photographers and software engineers. These are used for collecting and processing raw photographic data obtained during architectural photographing of city target area.

The 3D city design tools are a set of software utilities and technical documentation for 3D-artists and software engineers. The 3D city design tools are used in 3D-City production line for creating, processing, and integrating 3D-objects into the virtual city computer model as described above.

The guide/directory design tools are a set of software utilities and technical documentation for 3D-artists and software engineers. The guide/directory design tools are used in ad packages and guide production line for ad design and integration of client data and multimedia content into program database.

The online update tools are a set of software utilities and technical documentation for system administrators and software engineers. The online update tools are used for collecting and processing client online data updates, assembling and publishing product update packages on the internet server.

### Architectural Photography for Virtual Three-Dimensional City Modeling

One embodiment of the present invention provides a minimized data collection method which includes a method of minimizing the amount of data to be collected that is necessary to create three-dimensional virtual models of city elements of the virtual city environment of the present invention. One embodiment of the present invention includes a method of collecting, processing, organizing and storing photographic data of buildings and their architectural features within a city target area. A further embodiment includes a method of using the photographic data to create a three-dimensional virtual model of a structure such as a building. In one embodiment, the system and method of the present invention is incorporated into software, software utilities, or any other suitable communication or computing media or device.

To ensure accurate reconstruction of the virtual three-dimensional city, various types of information are collected and processed to acquire relevant data about the city elements, such as buildings, in the virtual city. The information can include details of the interior and exterior of the buildings, the geometrical shape and spatial location of buildings, and objects or structures in, on or near the buildings. General and perspective information used in three-dimensional modeling of this subject matter is obtained through informational sources such as aerial shots and digital elevation maps of the target city area, city plans, technical drawings, and on-site range sampling results.

In one embodiment, architectural photography is used to create a computer-generated three-dimensional model of a real city. Although the present invention refers to the collection of data by photography, it should be appreciated that collection of data can be achieved by videography, satellite imagery, or any other suitable known or subsequently developed visual recording process.

In one embodiment of the present invention, there are two main types of architectural photography used within the architectural photography framework of the present invention: survey and detailed photography. Each type of photography is used to accomplish a specific task for construction of a three-dimensional building model.

In one embodiment, survey photography includes photographic data taken of the whole building, or, in some cases, photographs taken of large fragments of building facades as viewed from certain sides or angles. Survey photography provides the location of the target building relative to neighboring buildings within a defined city target area such as a city block. Survey photography also provides information such as the geometry of the building and proportions of its major architectural components. In addition, the layout of regular structures found on building facades and any unique architectural shapes are included in the subject matter of the survey photography. Furthermore, survey photography provides the modeler with information of various “city clutter” objects surrounding the building such as mail boxes, trash cans, light poles and vegetation.

The survey photographic data must be sufficient for the modeler to construct an image of the building to initiate or complete the reconstruction process of both the building and its surrounding objects. For instance, in one embodiment, such information is used as a basis for creating a wireframe model of the object or structure. In addition, the survey photographic data of each building must provide a sufficiently detailed view of all objects to be further described in detailed photographic data. In one embodiment, the photographic data of survey photographs provides the computer modeler a clear understanding of the exact location of each object, either directly on a building facade or, for surrounding objects, relative to the building itself. Therefore, in one embodiment, survey photographic data is collected which includes each side or facade of a building having architectural details unique to that facade.

In one embodiment, detailed photography includes obtaining a set of high-quality, close-range photographs of architectural details of a building used as source material for retrieving graphical patterns for the texturing process described below. Therefore, it is preferable that each target of detailed photography be present and clearly visible on at least one of the survey photographs.

A variation of detailed photography in the present invention includes photographic data of city “clutter”. In one embodiment, the results of city clutter photography are used for reconstruction of the geometrical shapes and graphical textures of objects located in close proximity to a target building, but are not a part of the building itself. The targets of city clutter photography include any adjoining sidewalk, light poles, benches, trash receptacles, fences, flowerbeds, trees, other vegetation, vending machines, newsstands, playgrounds, subway entrances and other objects in close proximity to a target building. These objects create a feel of reality for the modeled virtual environment.

The complexity and labor intensive work of collecting, processing, organizing and storing diverse information of various city elements, in the form of, for example, numerous photographs, to create a virtual three-dimensional reconstruction of an entire virtual city requires a modeler to use a systematic approach to arrange and manage these tasks. In order to minimize the amount of photographic data to be collected to create the virtual three-dimensional reconstruction of the city, the present invention provides an architectural photography process framework and a reconstruction process framework within which photographic data is systematically analyzed, planned, collected, organized, stored and applied.

Referring now to FIG. 8, in one embodiment of the present invention, the creation of a three-dimensional model of an object or structure, such as a building, from an actual object or structure includes an interactive process between a photographer 800 and a modeler 801. The role of the photographer 800 in the architectural photography process framework includes producing a building image 800b from a real or actual building 800a in the form of photographic data 812a such as pictures and a textual description of the data in corresponding documentation 812b. The photographic data 812a and documentation 812b produced in the architectural photography process is transferred from the photographer 800 to the modeler 801 to be used in the model reconstruction process. The role of the modeler 801 in the model reconstruction process framework includes producing a virtual three-dimensional model 800c of the building from a building image 800b in the form of photographic data 812a and its corresponding documentation 812b. It should be appreciated that the role of the photographer and the role of the modeler can be carried out by the same person or by teams of individuals working together within the framework of the architectural photography and model reconstruction processes.

In one embodiment, the architectural photography process framework includes a process of analyzing, planning, collecting, evaluating processing, organizing and storing the photographic data in which a user, such as a photographer or computer modeler, is able to determine the minimal amount of photographic data necessary, in terms of content and quality, to perform the process of reconstructing a virtual three-dimensional model of an actual city. The architectural photography process framework also includes photographic techniques such as choosing the most effective positions and angles from which to collect photographic data of a target element, and other parameters of optimal photographic data collection. Once the target has been analyzed and photographic data of that target has been planned, collected, evaluated, processed, organized and stored, the photographic data enters the reconstruction process framework wherein the data is applied to a model of the three-dimensional structure to complete the reconstruction process of the present invention.

### Architectural Photography Framework

Referring now to FIGS. 9A and 9B, one embodiment of the present invention includes a systematic approach to execute procedures for photographing three-dimensional objects efficiently and effectively as well as organizing the photographic results. One embodiment of the present invention includes a sequence of the primary process steps for photographing three-dimensional objects for modeling of the objects illustrated in the flow charts of FIGS. 9A and 9B. It should be appreciated that the sequence of the process steps can vary. It should be further appreciated that process steps, not illustrated in FIG. 9A, can include work management, task assignment, further quality control and other steps related to internal activity of the architectural photography process framework.

In one embodiment, the architectural photography process includes target area analysis 802 to identify shooting tasks 803. The identification 804a, scheduling 804b and assignment 804c of the shooting tasks 803 precedes the actual photographing of the targets identified in the analysis. The photographing includes analysis and documentation of building architecture 806, planning the collection of photographic data or shooting tasks 807 and collecting the photographic data or shooting the actual photographs 808. Once the photographic data is collected, in one embodiment, the architectural photography process framework includes evaluating the results by performing an internal quality control 809a. If the photography team requires additional photographic data, the process includes issuing a re-work task 811a. Otherwise, the process includes processing and submitting results 812 to the modeling team 801. In addition to the internal quality control, the architectural photography process framework also includes evaluating the results by performing external quality control 809b by the modeling team 801. If the modeling team 801 requires additional photographic data to be collected to provide adequate data for modeling, the process includes issuing a deficiency report 811b to be included in the rework task issuance 811a. In addition to the process steps, FIG. 9A also illustrates relevant document and data flow such as shooting tasks 803, supply schedule 805, deficiency reports 813, and photographic data 812a and shooting log books 812b.

The first stage of architectural photography includes target area analysis 802. The target area analysis 802 is illustrated by dashed lines in FIG. 9A to indicate that, in one embodiment, the analysis is performed as a preliminary or an initial step to both architectural photography and modeling process frameworks. In one embodiment, the target area analysis is performed by the modeler as illustrated in FIG. 9. Alternatively, the analysis is performed by the photographer. In one embodiment, the target area analysis is performed using informational sources such as aerial shots and digital elevation maps of the target city area, city plans, technical drawings, and on-site range sampling results. The target area analysis 802 of the present invention includes analysis of an entire surrounding area or landscape of the target area to be modeled. The targets for modeling can include scenery, roads, bodies of water, etc.

The shooting tasks identification step 804a includes identifying a subset of the target area in which targets are chosen for a shooting task 803. The targets identified can include city blocks or buildings within a city block for which photographic data is collected. In one embodiment, the identified targets are included as a layout in the shooting task 803 discussed below.

The shooting task scheduling 804b is developed based on various factors included in coordinating the schedules of the clients and modeling team along with other factors affecting the timing of completion of the shooting task. For example, in one embodiment, the modeling team sets the sequence and priorities for the performance of the shooting tasks.

Once the shooting task is identified, and scheduled, the process includes assigning the shooting task 804c. It should be appreciated that the present invention can include one or more participants or team members involved in each of the steps of the process of the present invention. For example, in one embodiment, a modeler or modeling team 800 plans the shooting tasks 803 including photographic data to be collected and assigns the shooting tasks to a photographer or photography team 801. The shooting tasks are distributed among the photographers and executed according to the time schedule of the tasks execution plan or shooting task document 803. At least one photography team manager can assign the received shooting tasks to team members and provide reports or a supply schedule 805 about the status and completion dates of the shooting tasks on a regular basis. The supply schedule 805 of shooting task results is coordinated by the modeling team with the photography team to identify the expectations of both teams. It should be appreciated that the supply schedule is constantly updated and refined through the photography process.

The next step of the architectural photography process framework includes the photographing stage of the process. In one embodiment, the photographing stage includes building architecture analysis 806, shooting planning 807 and the actual shooting 808. In one embodiment, analysis of the architecture of the building 806 includes identifying and describing potential targets of photographic data collection. In one embodiment, the analysis of the architecture of the building 806 is performed using informational sources such as aerial shots and digital elevation maps of the target city area, city plans, technical drawings, on-site range sampling results in addition to survey photographic data. Alternatively, or in addition, the analysis of the architecture of the building 806 is performed at the actual target block, and is conducted in a spatial sequence such as proceeding around the building in a clockwise or counter-clockwise manner.

In one embodiment, the analysis of building architecture 806 forms a basis for determining the photographic data collection strategy 807 as further described below. The photographic data collection strategy 807 includes determining the targets or subject matter of the photographic data, which, in one embodiment, is used in the planning stage to determine corresponding reference points or shooting positions and direction of shooting. Accordingly, the analysis of building architecture 806, in one embodiment, includes determining the geometry of the building and proportions of its main architectural components including horizontal dimensions (a footprint layout) and vertical dimensions of the target. The analysis further includes identifying identical facades or portions of facades as well as areas of regular facade structures, the composition and interrelation of the areas of regular facade structures, any unique architectural details of the target, the form and, diversity of objects surrounding the target, the presence of various obstacles which may interfere with shooting the target, and the capacity to choose optimal shooting positions and conditions. It should be appreciated that conducting this preliminary analysis to identify elements to potentially included in the photographic data contributes to decreasing the volume of work associated with collecting the photographic data by increasing the efficiency of photographic data collection and by minimizing the number of photographs to be taken.

Referring to FIG. 10, in one embodiment, documentation of the analysis and the planning 807 stages of the architectural photography process is performed to provide a plan for efficient collection of photographic data. In one embodiment, the plan for collecting photographic data is described in two forms of documentation for architectural photography including a shooting task 803 and a shooting logbook 812b. In one embodiment, the photographic data collection strategy is described in a separate tasks execution plan or shooting task document 803 prepared for each shooting task segment. It should be appreciated that any suitable form of recording information can be used to document the analysis.

In FIG. 11, one embodiment of the shooting task document 803 includes a general description of a shooting target including identifying the target in a segment of a city plan. A shooting task in one embodiment includes a layout of relatively small segments of a target city area, such as city blocks, into which the target city area is divided. It should be appreciated that a shooting task segment may encompass several city blocks or include just one stand-alone building. In FIG. 11, a target city block is illustrated by bounding street names. Each building is identified by a unique identifier such as a letter, number or symbol to be used to refer to the building in the shooting task document 803 or in a shooting task logbook 812 to be described later. The segment of the city plan included in the shooting task 803 includes a footprint 820 of the building(s) of the target city block. In one embodiment, the footprint 820 of the building(s) of the target city block is placed in the center of the plan. In one embodiment, the shooting plan includes a diagram indicating a fragment of a target such as a building facade of which photographic data is to be collected. In one embodiment, the fragment is identified by a unique fragment identifier, such as a letter or number, to be used to refer to the reference point in the shooting task logbook.

Other descriptive details in the shooting task include the orientation of the target city block with respect to compass settings identified along the perimeter of the layout. FIGS. 12A and 12B illustrate individual city plan segments or layouts in the form of normal and small scale layouts 818a and 818b, respectively, of a target area such as a city block. In one embodiment, a normal scale layout includes a target city block and portions of the blocks immediately surrounding the target city block. In one embodiment, a small scale layout includes a target city block and a complete layout of each of the blocks immediately adjacent to the target city block.

Referring back to FIG. 10, in one embodiment, analysis of the architecture of the buildings includes making notations in a log or logbook 812b. In one embodiment, the logbook 812b includes a list of distinctive details or peculiarities of each building facade as well as a comparison of the facades 817.

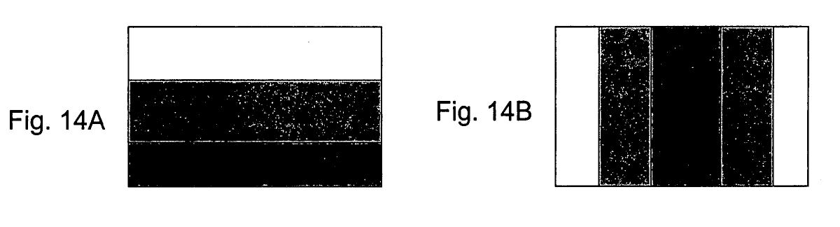

The architectural photography planner notes any peculiarities of the facades and visible parts of the object or structure including symmetry, homogeneity, patterns or similarities of the structure. The distinctive details or peculiarities of a building to be identified include the facades or portions of facades and the types of areas of regular pattern or homogeneity of the facades. Areas of regular pattern of the facades include windows or architectural details which are substantially similar to one another and are often distributed in a repeatable fashion in an area on a facade. As illustrated in FIGS. 14A and 14B the repeatable elements can be distributed horizontally or vertically along the areas of the facade. It should be appreciated, however, that other, more complicated, arrangements of these elements can be encountered.

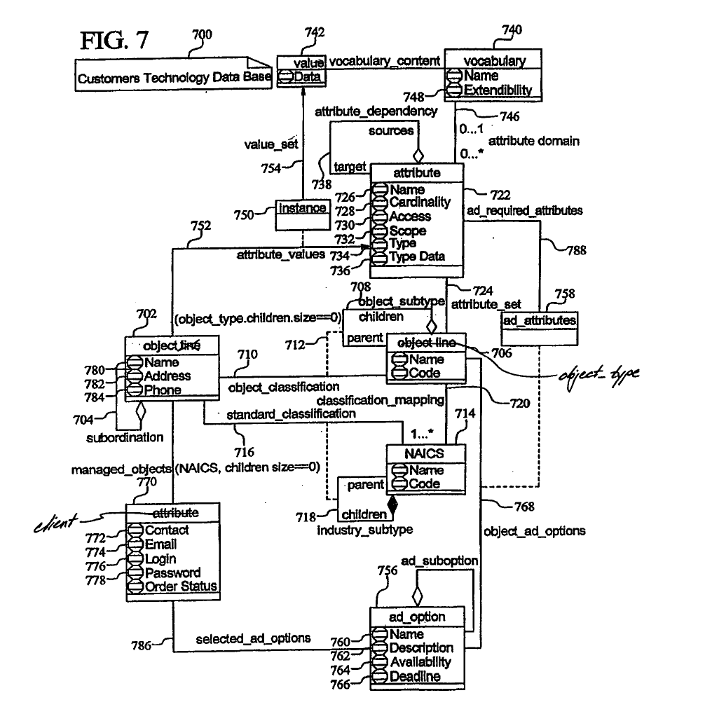

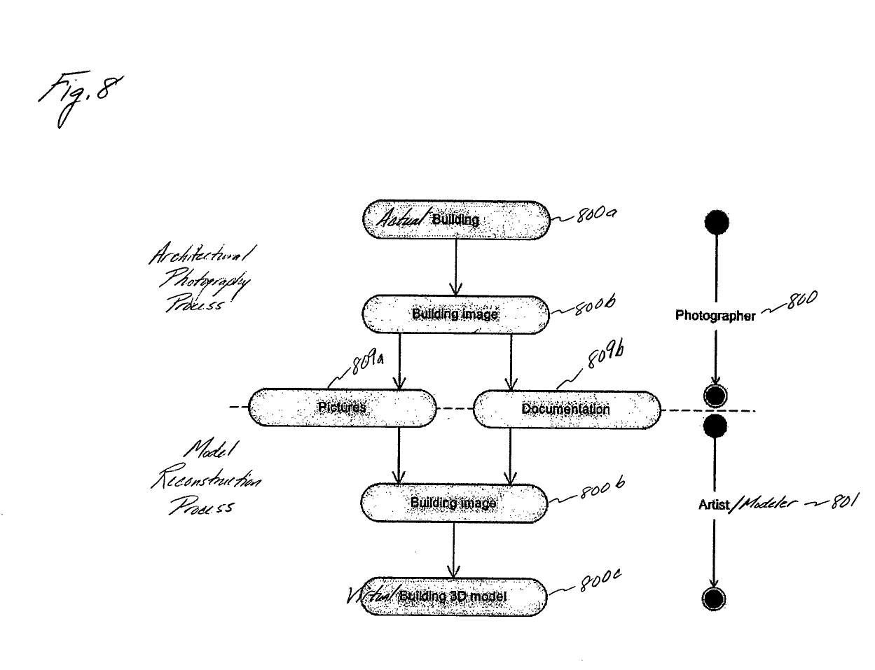

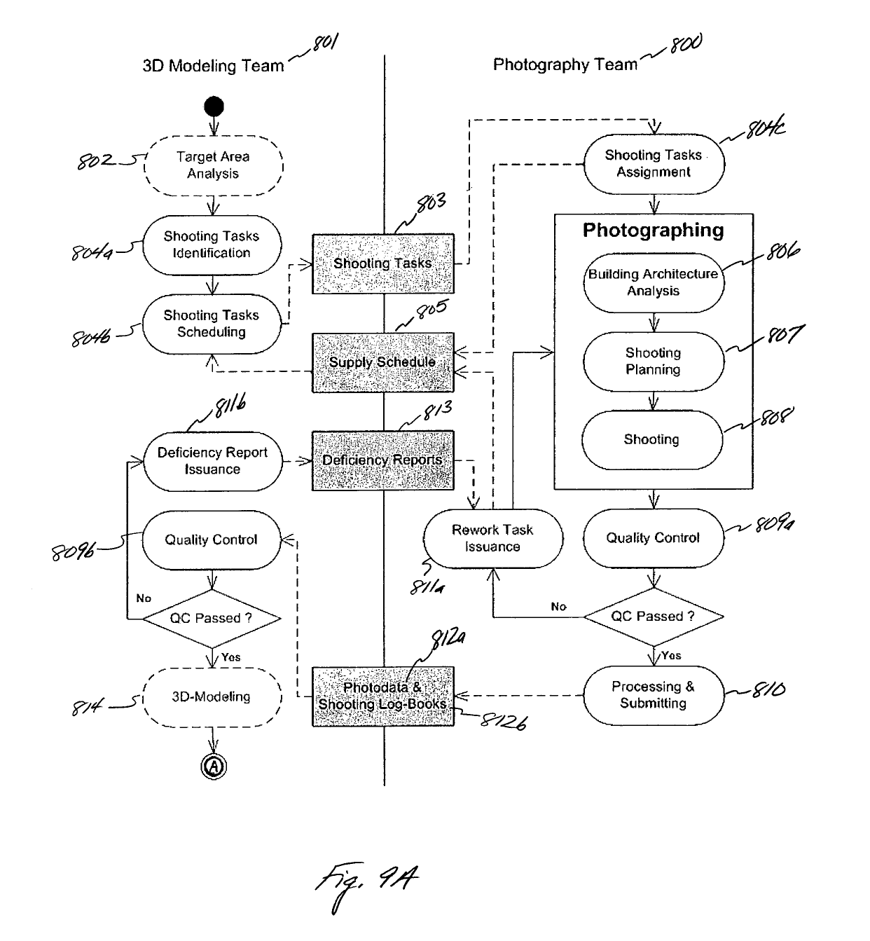

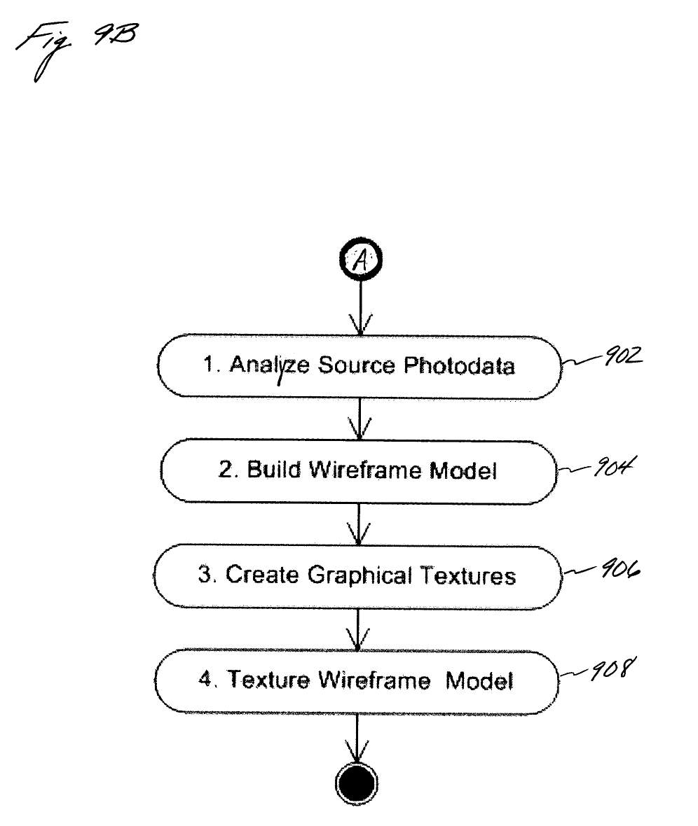

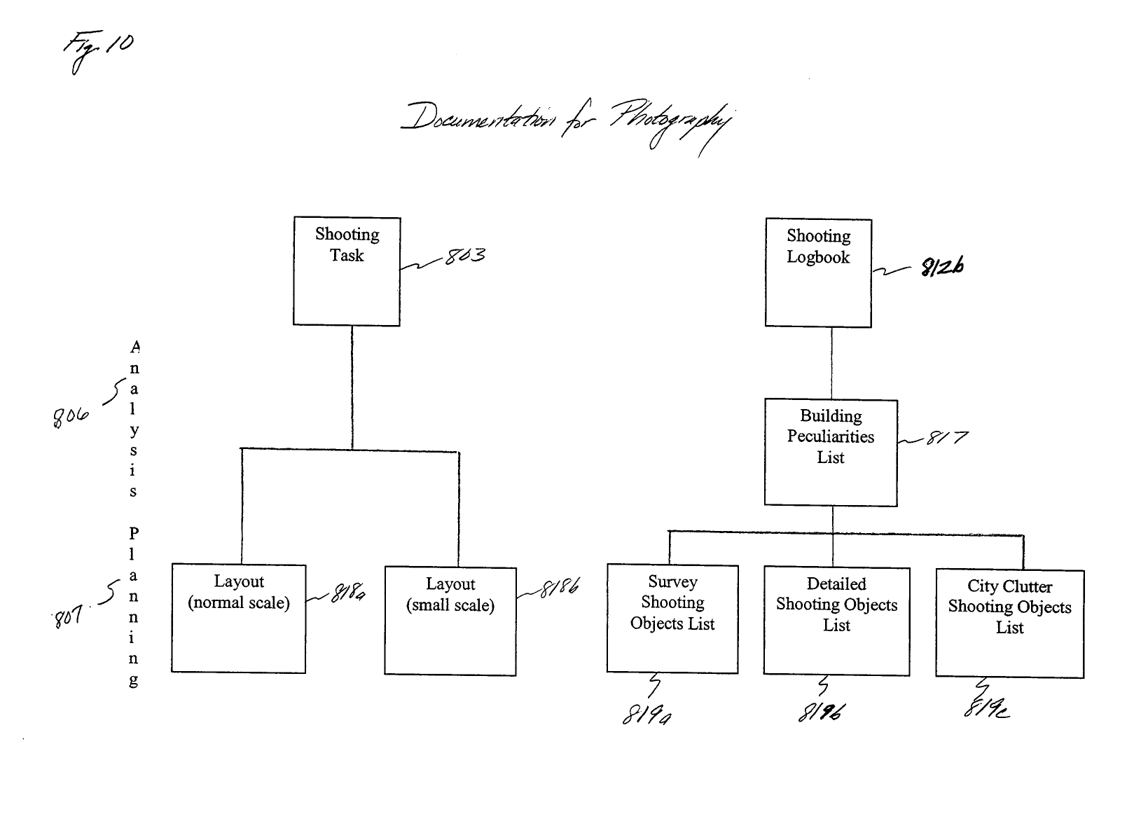

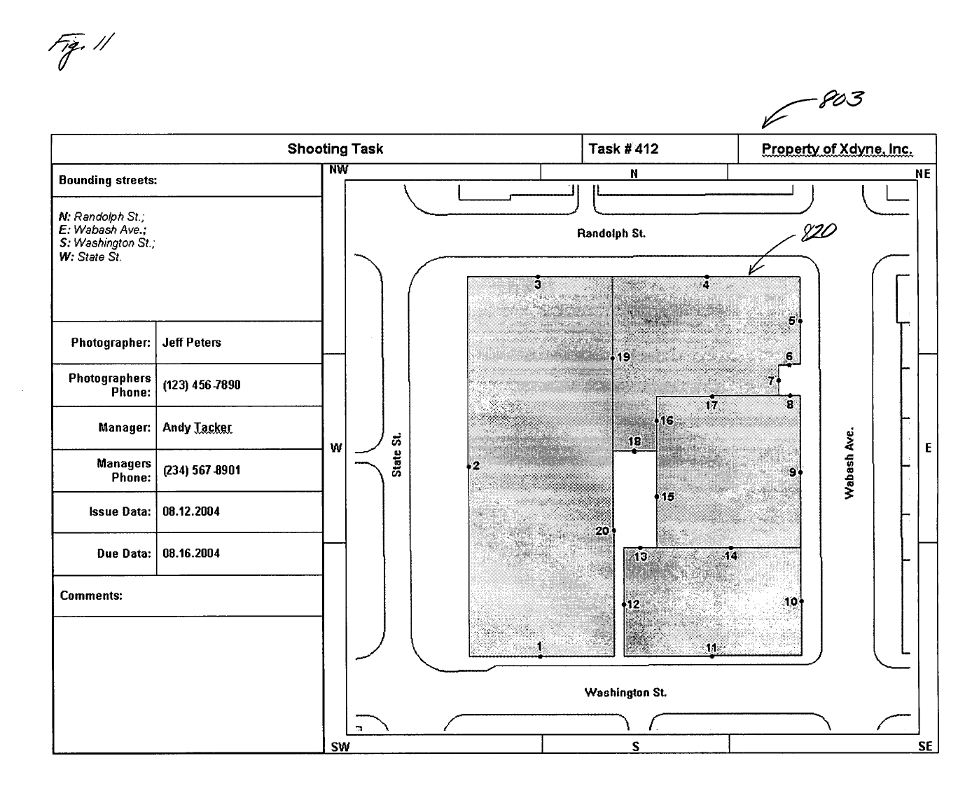

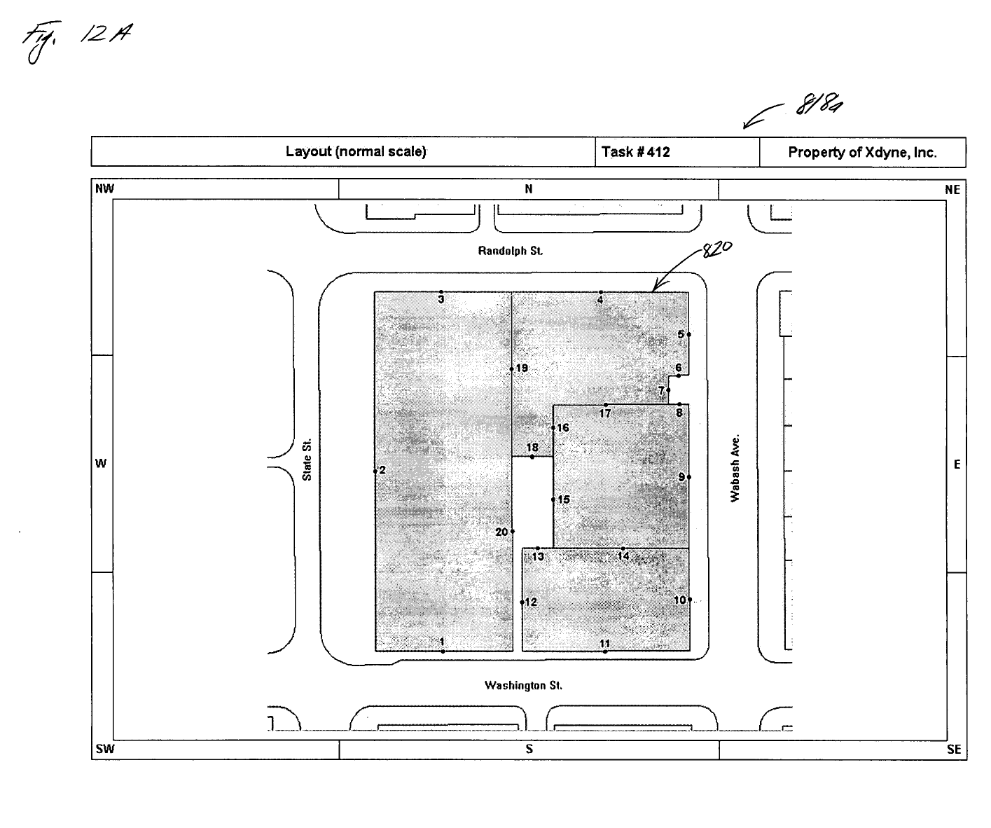

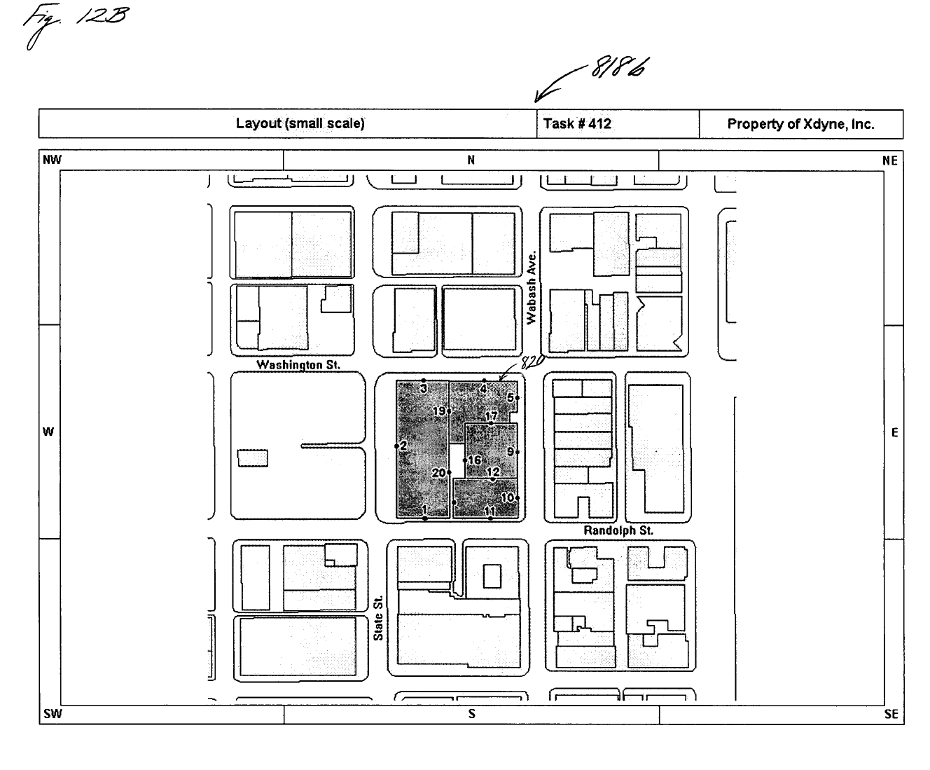

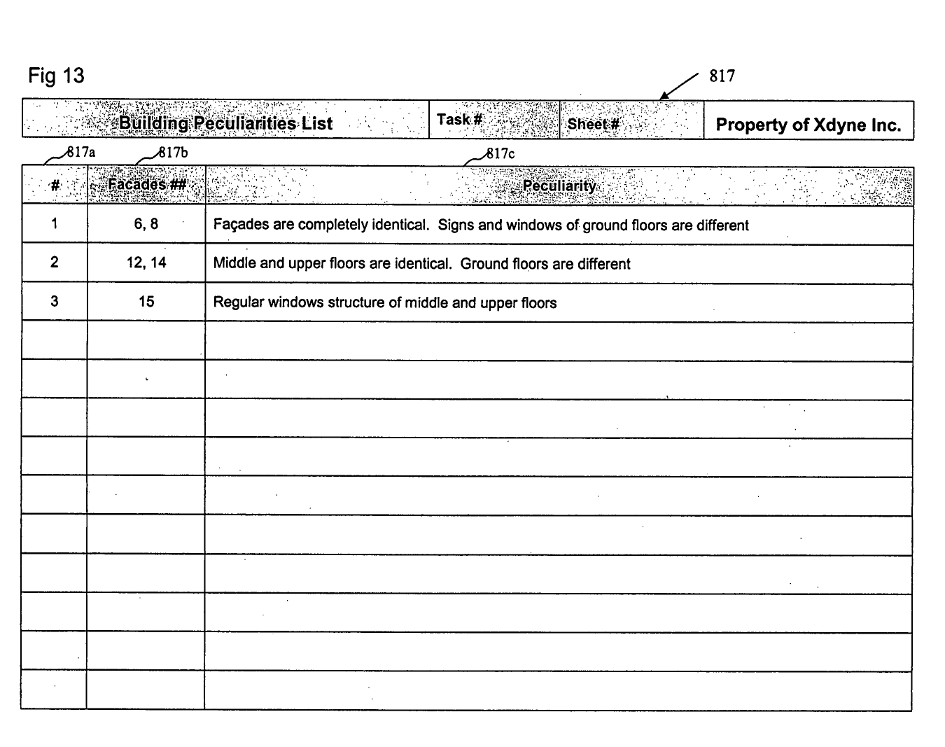

FIG. 13 illustrates an example of a building peculiarities list 817 used in the analysis of the architecture of a building. In one embodiment, as illustrated in FIG. 13, the list of building details or peculiarities 817 includes a description of the task in the form of a table. In one embodiment, the table includes columns and rows. In one embodiment, the peculiarities list 817 includes a record number 817a for each entry in the log or logbook, a listing of the facades identified for each record 817b, and a description of each of the facades with respect to any distinctive detail or peculiarity relevant to the task description 817c. For example, Record #1 identifies facades 6 and 8 of the building as appearing completely identical. The analysis also notes that the signs and windows on the ground floor appear to be different. Record #2 notes that the middle and upper floors of facades 12 and 14 are identical and the ground floors of the facades are different. Record #3 identifies facade 15 as having regular window structure on the middle and upper floors.

In one embodiment, the photographic data collection strategy is based on the analysis of building architecture. Therefore, upon completing the analysis of the target object or structure such as a building 806, the present invention minimizes the amount of photographic data to be collected to sufficiently detail the desired features of the city element, in part, by planning the process of collecting photographic data 807 based on this analysis. Planning the collection of photographic data includes determining the objects for which the collection of photographic data is necessary from the analysis detailed in the list of building peculiarities as well as determining perspectives and locations or positions from which the photographic data is collected. The information also allows the photographer to plan the sequence in which photographic data is collected so that insufficient and redundant photographic data collection is avoided to minimize the amount of data to be collected. Furthermore, this planning stage 807 provides the photographer guidance in choosing the necessary perspectives from which to collect sufficient photographic data.

Therefore, in one embodiment, each side or facade of a building having architectural details unique to that facade identified and described in relation to the other facades in this analysis stage 806 is used in planning the collection of survey photographic data 807. In one embodiment, the architectural details unique to each facade documented in the analysis stage 806 for purposes of planning the collection of detailed photographic data 807. In one embodiment, a single representative element of a unique architectural detail that exists in a repeatable pattern or element identified in the analysis stage 806 is used in planning further collection of detailed photographic data. Therefore, the collection of photographic data to construct a virtual three-dimensional model of a building is minimized by limiting the target subject matter of the collection during the planning stage 802b to unique representative facades and unique representative architectural details of the building which can be digitally duplicated to re-construct the model as discussed below.

For example, based on the analysis in the first record of the list of building peculiarities 817, there is no need to collect survey photographic data of both facades 6 and 8 because both facades are completely identical. It is enough to collect photographic data of a single facade. Detailed photographic data of the different signs and windows of the ground floors must be collected for each facade.

According to the second record 817a, collecting survey photographic data of one facade and survey photographic data of the ground floor of the other facade is likely to be sufficient. The survey photographic data of one facade includes the ground, middle and upper floors of the facade. The ground floor facade that is different than the other ground floor level is the only portion of the facade that needs to have photographic data collected because the middle and upper floors of the other facade are identical to the facade already captured.

The third entry indicates that a window structure repeats itself in uniform fashion across the span of the facade 817c. Photographic data collected from a position close enough to optimize the detail of a portion of the repeated element should be sufficient since the remodeler can reconstruct the remaining portion of the facade from the collected photographic data.

In one embodiment, the shooting task 803 includes a diagram indicating a reference point or shooting position from which photographic data of the target is to be collected. In one embodiment, the normal and/or small scale layouts of the target city area illustrated in FIGS. 12A and 12B are provided to identify survey shooting points during the planning stage. In one embodiment, the points of reference include a general zone around a more precise location or position from which to collect photographic data. In one embodiment, the reference point is identified by a unique reference identifier, such as a letter or number. The reference identifier is used to refer to the reference point 874 in the shooting task logbook 812b. In one embodiment, a sequence of positions for collecting the photographic data is determined. It should be appreciated that determining the optimal strategy and systematic approach before beginning the shooting task decreases the photographing time and facilitates the remaining steps of the reconstruction process to contribute to minimizing the amount of photographic data of a city element to be collected.

Referring now to FIGS. 15 to 20, in one embodiment, the next step of minimizing the amount of photographic data to be collected is to strategically determine reference points or shooting positions from which the photographic data is collected. In one embodiment, the shooting positions are determined based on information provided in footprint layouts as is illustrated in FIGS. 16A, 17A, 18A, 19 and 20B.

In determining a sufficient quantity of photographic data for a building with a simple square footprint, one must consider the presence of identical facades, the architectural peculiarities of the building, the presence of juts and niches on the facades of the building, the presence of neighboring objects and the freedom of the photographer to choose a distance to an object.

FIGS. 15 to 20 illustrate one embodiment of the present invention which includes suggestions for shooting positions and angles for photographs taken of buildings with different shapes and footprints. For example, the table in FIG. 15 describes different levels of homogeneity of the facades of buildings with simple square footprints. The second column of this table describes the number of survey photographs sufficient to model each type of building or level of facade homogeneity.

According to FIG. 15, if all facades of the building are different, a total of eight photographs are taken—one straight view and one angle-view photograph for each facade. For example, FIGS. 16A and 16B illustrate an aerial view or footprint of a building (FIG. 16A) and a profile or side view of the building (FIG. 16B). As illustrated in FIGS. 16A and 16B, for an individual building having a relatively simple footprint and shape 820 as illustrated in FIGS. 16A and 16B, such as a “square box” geometry, but with different elements included on each side of the building or facade surface, up to about eight survey photographs are taken to accomplish full reconstruction of a wireframe model of the building. The shooting positions and angles attempt to capture the building from each of the four sides or facades 820a, 820b, 820c and 820d and each of the four corners. It should be appreciated that additional survey photographs may be required if all facades are not visible and/or there is impaired access to optional or desired shooting positions from the object as discussed below.

As indicated in FIGS. 16A and 16B, photographic data of each facade or fragment of a building is collected in three survey photographs—two angle-view photographs and one straight-view photograph. For example, in one embodiment, angle-view survey photographs of facade 820a, are taken from shooting position A 821 and shooting position C 823. A straight-view survey photograph of facade 820a, is taken from shooting position B 822. Similarly, angle-view survey photographs of facade 820b, are taken from shooting position C 823 and shooting position E 825 and a straight-view survey photograph from shooting position D 824. Angle-view survey photographs of facade 820c, are taken from shooting position E 825 and shooting position G 827 and a straight-view survey photograph from shooting position F 826. For facade 820d, angle-view survey photographs are taken from shooting position G 827 and shooting position A 821 and a straight-view survey photograph is taken from shooting position H 828. Thus, under typical circumstances, one to eight survey photographs are necessary for the reconstruction of a wireframe model of a building depending on architectural peculiarities of the building and the diversity of neighboring objects. The rest of information for a comprehensive three-dimensional reconstruction of a building is collected in detailed photographs.

In FIG. 15, if opposite facades or three of four facades of a building having a square footprint are identical, three angle-view photographs are required for sufficient photographic data of the target building. Alternatively, two straight-view photographs of each of the different facades and one angle-view photograph of two different facades are required for sufficient photographic data of the target building. If all details of the facades are easy to recognize, only one angle-view photograph including two different facades may be required for sufficient photographic data of the target building.

In FIG. 15, if all facades of a building are identical, two angle-view photographs are required for sufficient photographic data of the target building. Alternatively, one straight-view photograph of a facade is required for sufficient photographic data of the target building. If all details of the facades are easy to recognize, one angle-view photograph will be sufficient. For example, FIGS. 17A and 17B illustrate an object or building 840 having a round footprint. Although the building 840 illustrated in FIGS. 17A and 17B includes one continuous facade, if different three-dimensional elements are included over the face of the facade, up to about eight survey photographs may be necessary to accomplish full reconstruction of a wireframe model as described above. Therefore, angle-view photographs at shooting positions B 842, D 844, F 846 and H 848 and straight-view photographs at shooting positions A 841, C 843, E 845 and G 847 are taken to fully describe the three-dimensional elements on the building facade. It should be appreciated that the number of survey photographs needed for a building having this configuration can be reduced to as few as one survey photograph, as described in the table of FIG. 15 above, if the facade of the building is identical from all sides and has no three-dimensional elements. It should be further appreciated that all survey photographs of such a circumferential configuration are both straight-view and angle at the same time.

The angle-view photographs at shooting positions B 822, D 824, F 826 and H 828 give information about joints of adjacent facades, the presence of protrusions such as entrance overhangs, porches, balconies, etc., niches and three-dimensional objects on building facades, as well as the presence of surrounding objects. The two angle-view photographs are preferably taken at not less than a 45° angle to the facade surface. Angle-view photographs, however, are often insufficient to show the structure and depth of niches or recesses including doors or windows. Therefore, one embodiment of the present invention includes taking straight-view photographs at shooting positions such as A 821, C 823, E 825 and G 827 to provide information about the structure of recesses or niches on the building facades.

In addition, in one embodiment, a set of three survey photographs are taken at different angles, as illustrated in FIG. 10A, to capture enough of a facade to minimize the chance that unwanted obstacles and surrounding objects, such as cars parked along the building, trees, and fences, will obstruct the building's details.

Another example of a shape of a building footprint is illustrated in FIGS. 18A and 18B. FIG. 18A includes both concave and convex facade joints. As illustrated in FIGS. 18A and 18B, for this footprint configuration, in one embodiment, two additional angle-view survey photographs are taken to reveal the internal concave facade joints defined by facades 830e, 830f and 830g of the structure 830. For example, in one embodiment, an angle-view survey photograph of facade 830e, is taken from shooting position J 832, angle-view survey photographs of facade 830f, are taken from shooting positions 1831 and J 832, and an angle-view survey photograph of facade 830f, is taken from shooting position 1831. The shooting positions and angles of facades 830a, 830b, 830c and 830d remain the same as in the previous example. In other words, the actual number of survey photographs necessary to model an even more complex shape or footprint can remain about ten, depending on specific architectural features of the building and diversity of surrounding objects.

It should be appreciated that the factors that can affect the number of necessary survey photographic data and the choice of shooting points or positions and angles from which to collect survey photographic data include the horizontal and vertical dimensions of the building, the freedom of the photographer to choose the shooting point at a proper perspective, the shape of the building and its architectural features, the presence of surrounding objects, and the presence of any obstacles. Furthermore, portions of facades of buildings too large to fit into one survey photo including buildings that are too tall to fit into one survey photo, such as high-rise buildings, and buildings that are too wide to fit into one survey photo increase the amount of photographic data to be collected.

Optimal shooting positions and angles at which photographic data is collected are not always available due to building dimensions and cityscape layout features. For example, FIG. 19 illustrates the footprint of a building 850 with a wide facade 850c in relation to the surrounding streets and buildings. As illustrated in FIG. 19, taking two angle-view photographs from both corners of the building at shooting positions A 851 and D 854 does not reveal the central part 855 of the wide facade 850c. Therefore, for wide buildings, the portions of facades can include a left portion, a central portion and a right portion of the facade. For example, to collect photographic data of the central part 855 of the facade 850c, two additional angle-view photographs must be taken from shooting positions B 852 and C 853 as illustrated in FIG. 19. Facades 850b and 850d are captured in the two angle-view photographs taken from shooting positions A 851 and D 854, respectively. Straight-view photographs should only be used if the building facade has three-dimensional elements (niches or protrusions) because of the relatively minimal spatial area able to be covered by the survey photograph. It should be appreciated that facade 850a is completely blocked by other buildings as illustrated in FIG. 19 and will not be photographed. It should be further appreciated that the present invention can be applied to a group of buildings having adjoining or common facades which can be treated as a single building for purposes of collecting photographic data for reconstruction modeling of a target fragment including the group of buildings.

Since the distance from any of the shooting positions to the building is short, capturing the total vertical face of the facade wall with the adjacent sidewalk in a single photograph is very unlikely. A similar situation occurs with a high vertical facade such as with high-rise buildings. Portions of high-rise buildings can include ground floors, middle floors, and upper floors and roof. In one embodiment of the present invention, survey photographs of a structure, such as a high-rise building, having a height and sufficient architectural detail which prevent it from being captured in one survey photograph are divided into long-shot photographs, photographs of ground floor level, and photographs of mid and upper levels.

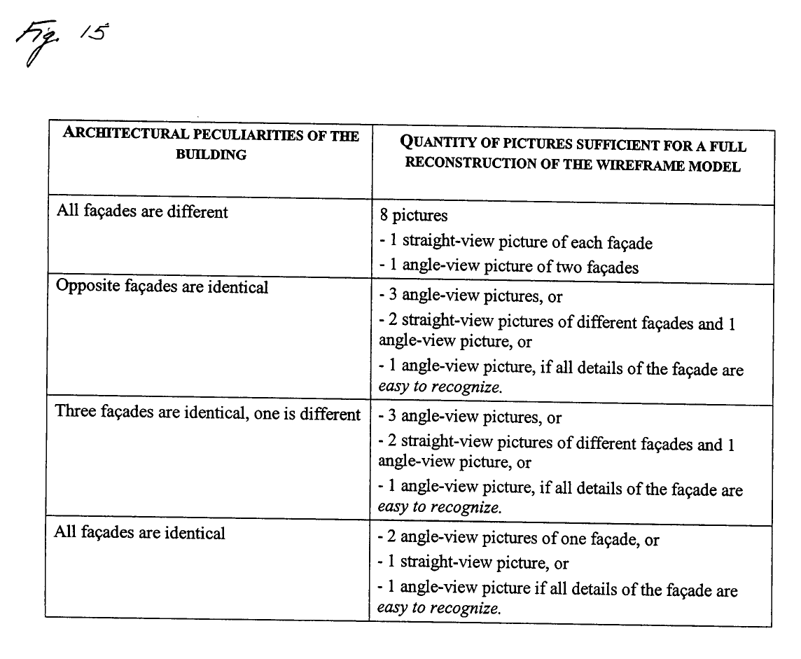

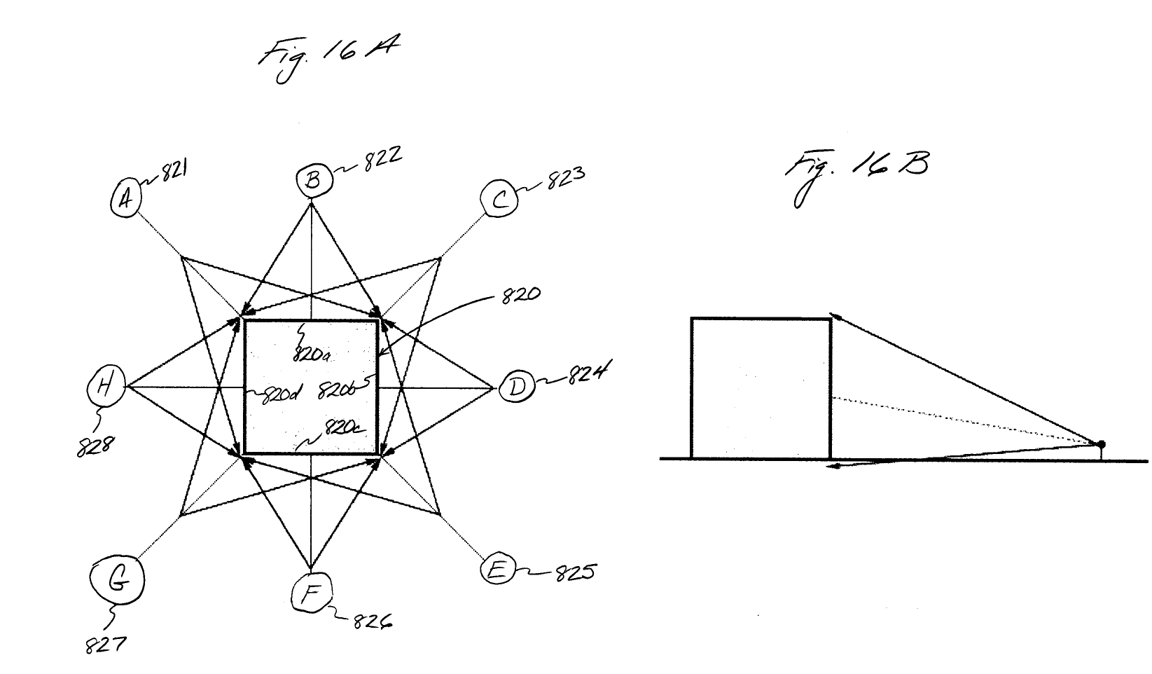

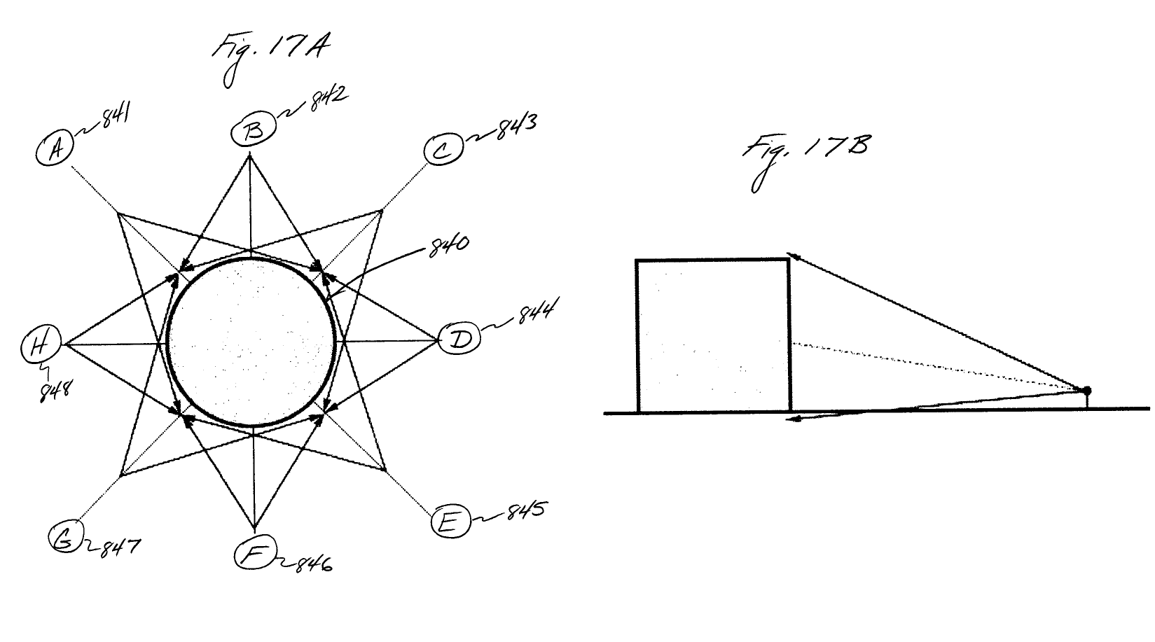

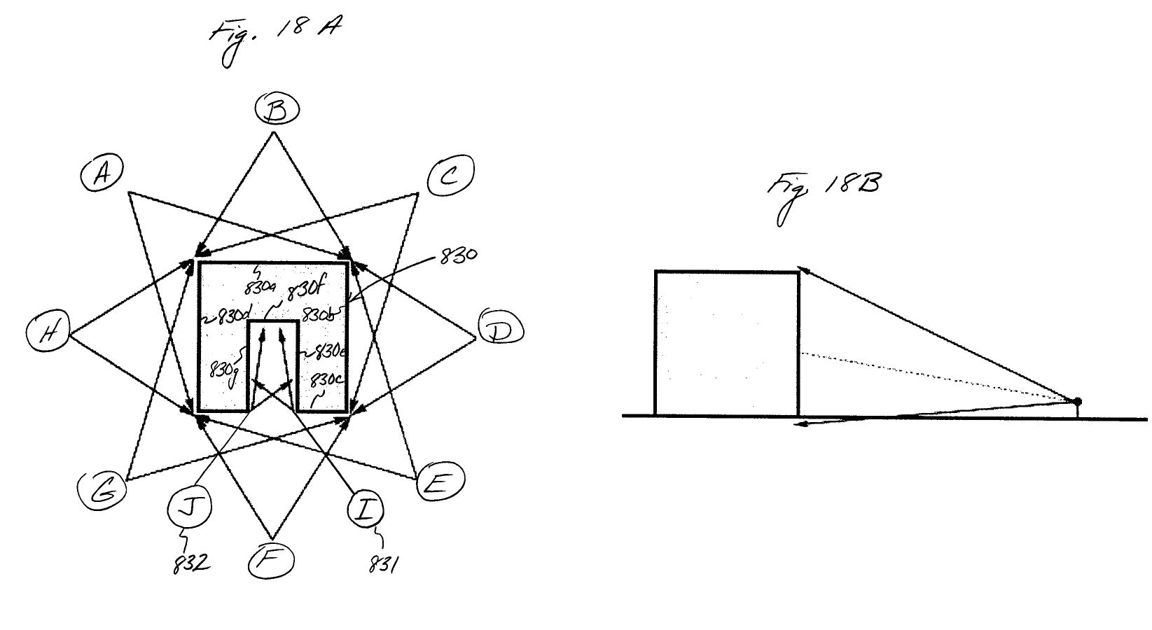

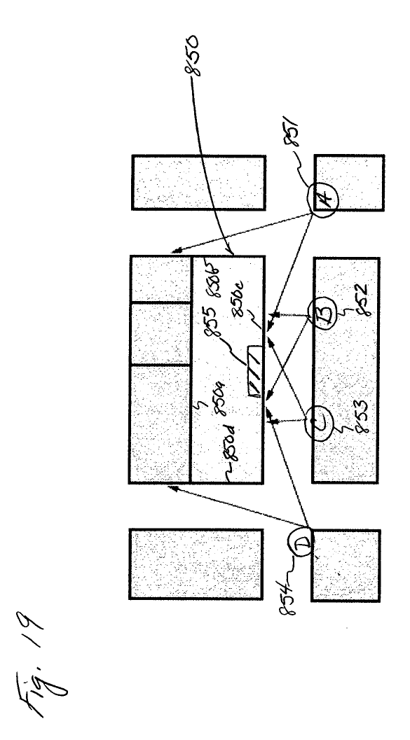

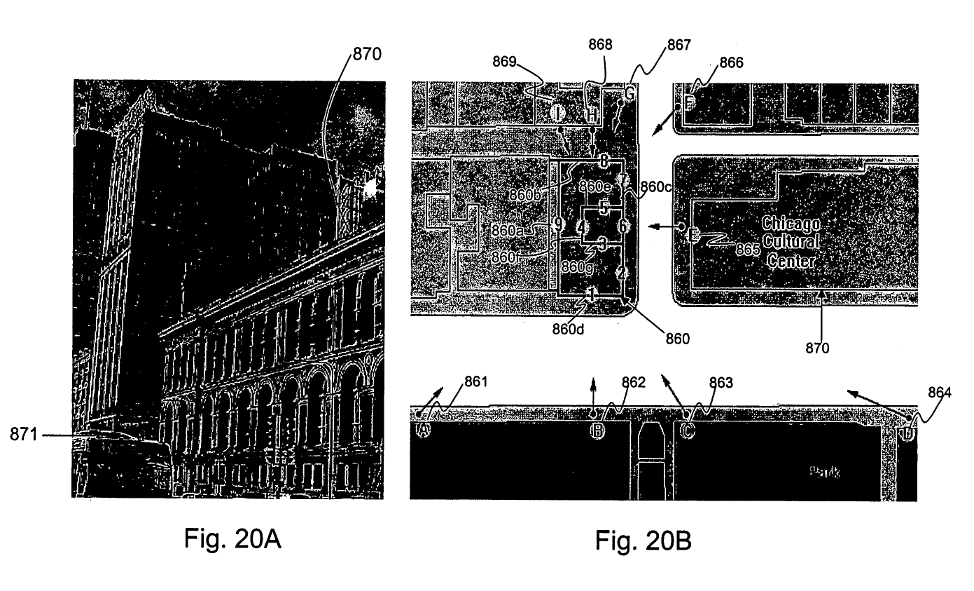

One example of a high-rise building having a height and sufficient architectural detail which prevent it from being captured in one survey photograph is illustrated in FIGS. 20A and 20B. The building 860 situated behind the building in the immediate foreground of FIG. 20A is designated as footprint 860 in FIG. 20B. Due to the height of building 860, a long-shot angle-view survey photograph is taken from shooting position D 864. The angle-view survey photograph taken from point D 864 in FIG. 20B and pictured in FIG. 20A reveals that the building 860 includes an indented structural design having concave facade joints, as described in FIGS. 18A and 18B above. Accordingly, the method of collecting the survey photographs described in FIGS. 18A and 18B above can be used to collect photographic data for modeling of the building illustrated in FIGS. 20A and 20B. The long-shot photograph provides photographic data of the upper levels of the concave facade joints defined by facades 860e, 860f and 860g and provides an estimation of the layout of the middle and upper floor levels of facades 860c and 860e.

In addition, in one embodiment, the set of survey photographs include an angle-view survey photograph of middle and upper floor levels of facade 860a and all or part of facade 860d taken from point A 861. Two straight-view photographs of facade 860d are taken from point B 862 which include one photograph of the ground facade level and one photograph of the mid and upper facade levels. An angle-view photograph showing the joint of facade 860d and facade 860c is taken from point C 863. Two straight-view photographs are taken from point E 865 which include a photograph of ground level of the facade 860c and a photograph of mid-floor levels of facade 860f. Finally, an angle-view photograph showing the joint of facade 860b and facade 860c is taken from point F 866. Alternatively, points G 867, H 868 and 1869 are used to take photographs of the ground floor level of facade 860b if optimal distances for the shots of the ground floor level of facade 860b are limited.

The present invention contemplates that assumptions may need to be made regarding the photographic data of features of a building, such as the layout of the facade, which are difficult to collect or cannot be clearly seen in the photographic data. Making such assumptions limits the number of survey photographs necessary for the reconstruction of the three-dimensional model. For instance, in FIG. 20B, the layout of facade 860b can be assumed to be identical to the layout of facade 860d thereby obviating a full set of survey photographs of one of those facades. Likewise, facade 860g can be assumed to be identical to facade 860e. It is desirable in accordance with the present invention, however, to limit the assumptions. For example, according to the long shot angle-view survey photo illustrated in FIG. 20A, the layout of facade 860f remains unclear; the layout of facade 860d is poorly visible from the angle of the survey photo; and no assumptions can be made about the layout of facade 860a. Therefore, in one embodiment, additional survey photographs are taken of facades 860a, 860d and 860f.

Although the upper level layout of facade 860d may be similar to its ground level, the possibility of original detail on the facade at ground level, such as various signage as well as the presence of surrounding objects, requires taking separate survey photographs for both upper and ground levels of facade 860d. Furthermore, the sample photograph illustrated in FIG. 20A, includes unwanted objects—a building 870 and a bus 871—completely obscuring the facade 860d at ground level. Thus, a set of photographs of the facades must be taken at ground level. For example, in one embodiment, the set of survey photographs includes a straight-view photograph of the ground level of facade 860d described above taken from point B 862. Therefore, in one embodiment, survey photographic data is collected which includes a representative side or facade of each unique side or facade of a building. When creating a computer model of the building, the homogeneity of a facade including repeatable elements often allows portions of the facade hidden by obstacles, such as cars or trees, to be reconstructed without the photographic data for those hidden portions.

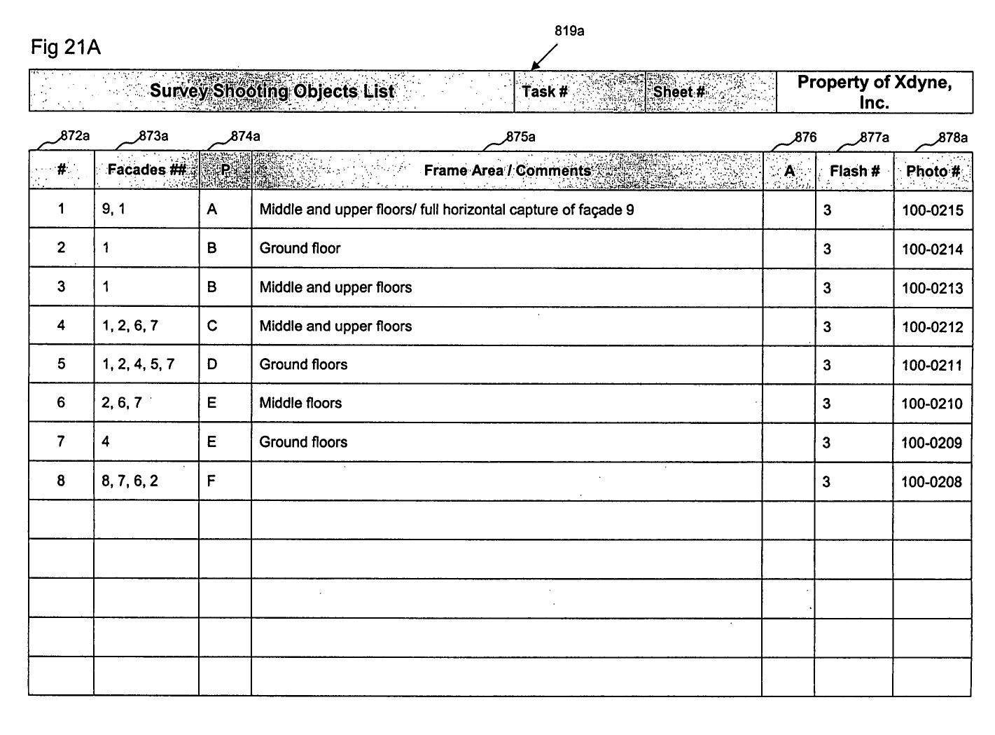

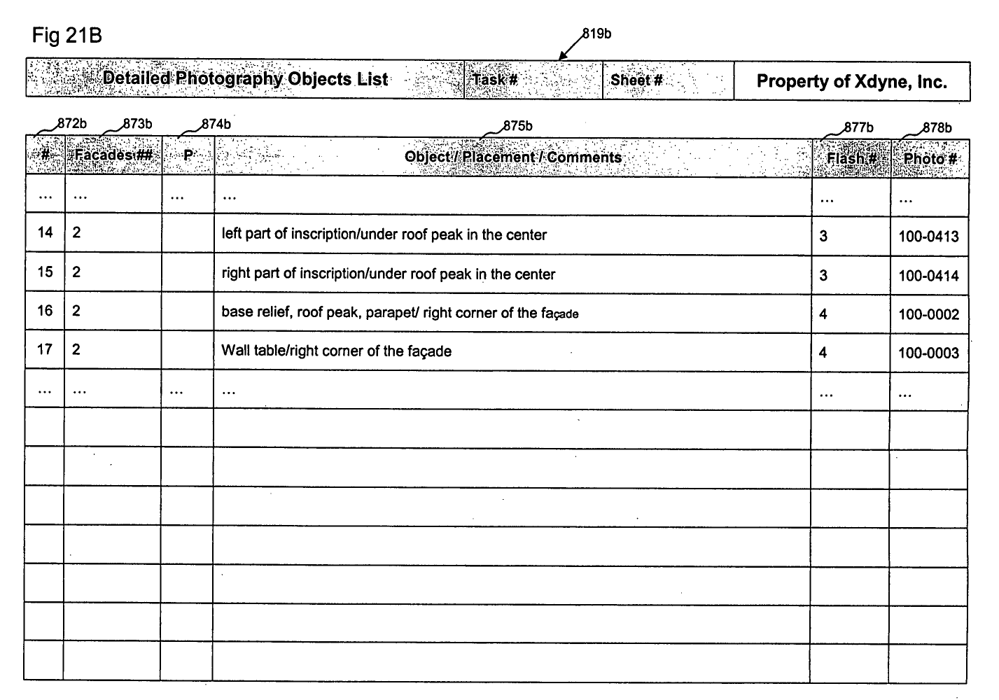

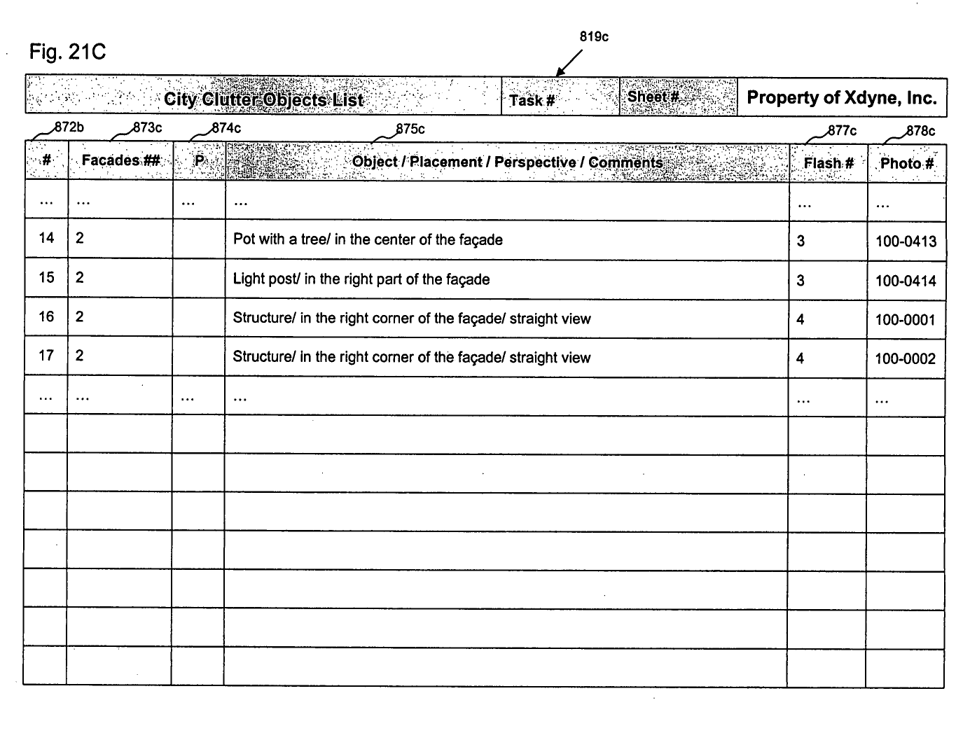

Referring back to FIG. 10, in one embodiment, the planned photographic data is recorded in a log or logbook 812b. In one embodiment, the log or logbook is divided into sections. In one embodiment, the sections of the log or logbook correspond to different lists of objects for photography. In one embodiment, the log or logbook is divided according to the type of photographic data to be collected for different objects. In one embodiment, the log or logbook 812b also includes a list of objects for which survey photographic data is collected 819a, a list of objects for which detailed photographic data is collected 819b, and a list of city clutter objects for which photographic data is collected 819c. An example of a list of objects of which survey photographic data is collected is illustrated in FIG. 21A, a list of objects of which detailed photographic data is collected is illustrated in FIG. 21B, and an example of a list of any objects in close proximity to the target object or “city clutter” objects is illustrated in FIG. 21C. The lists, in one embodiment, are substantially similar in format and include a description of the task in the format of a table in which information, on planned and collected photographic data is provided in the planning stage 807 and the collection or shooting stage 808, respectively.

In one embodiment, the predetermined parameters of the photographic data to be included in the logbook include identification and description of the subject matter of the photographic data, such as a building identifier and a fragment or facade identifier from the shooting task 803 or the city layouts 818a and 818b; conditions under which the photographic data is collected, such as the shooting position or reference point identifier, the direction, distance to the object, focal length, lighting and weather; and the status of the collected photographic data such as identification of the data and where the data is stored. It should be appreciated that other parameters can be documented to further organize the data for processing, application and storage.

As illustrated in FIG. 21A, in one embodiment, the list of objects for survey photography 819a includes identifiers for each record or photograph 872a, identifiers of the facades of the target building or facades determining the position of the object for photography 873a, identifiers of the shooting point or position from which photographic data is collected according to the photographer's records on the layout 874a, a description including a description of the limits of facade(s) included in the photographic data, and optional comments of the photographer 875a, a designation of artistic photography used when artistic pictures are taken 876a, identifiers of the memory device or flash-card on which the photographic data is stored 877a, and identifiers of the photographic data 878a.

FIG. 21A illustrates an example of a survey photography objects list 819a developed during the planning stage 807 for the target described in FIGS. 20A and 20B above and completed as photographic data of the targets is collected 808. Therefore, referring to FIG. 21A and FIG. 20B, record #1 of the survey shooting objects list 819a includes an angle-photograph of the middle and upper floors of facades 9 and 1 taken from point A. The photographic data of record #1 is stored on memory device #3 and is identified as 100-0215. Similarly, record #2 includes a straight-view photograph of the ground floor taken from point B, and record #3 includes a straight-view photograph of the middle and upper floors taken from point B. Record #4 includes an angle-view photograph of the ground floors of facades 1, 2, 6 and 7 taken from point C. Record #5 includes an angle-view photograph of the middle and upper floors of facades 1, 2, 4, 5 and 7 taken from point D. Record #6 includes a straight-view photograph of facades 2, 6 and 7 taken from point E and record #7 includes a straight-view photograph of the middle floors of facade 4 taken from point E. Record #8 includes an angle-view photograph of the ground floors of facades 8, 7, 6 and 2 taken from point F. It should be appreciated that additional photographic data can be collected according to the discretion of the photographer. It should be further understood that planned photographic data can be withdrawn from the logbook according to the discretion of the photographer.

In one embodiment, a variation of survey photography is used to convey a photographer's interpretation of the subject matter as an artistic expression including various visual effects. Thus, it should be appreciated that artistic photography is not necessarily subject to the requirements of the present invention such as weather conditions and illumination. Artistic photographic data provides the computer modeler with an initial selection of cityscape photographic images needed for designing various components of program screens of the present invention and is incorporated into multimedia presentations included in the present invention software, or is used in the design of a graphical background for certain program displays. In addition or alternatively, artistic photography is used in the three-dimensional modeling process. In one embodiment two to three artistic pictures are taken of each building. Accordingly, artistic records are indicated in the survey shooting objects list 819a of the logbook 812b under the column labeled “A” 876.

One embodiment of the present invention includes minimizing the amount of detailed photographic data to be used in the three-dimensional modeling process. In one embodiment, the advantage of detailed photographs includes retrieving photographic data of elements of building facades to be used as graphical patterns. For example, in one embodiment of the present invention, the subject matter of detailed photographs of a lower level of a building usually includes unique and individual architectural elements such as a storefront, entrance, decor details, wall-mounted billboard, etc. It should be appreciated that each of these elements of the building are unique and, therefore, may not be repeatable in creating the virtual three-dimensional model of the city requiring each unique element to be included in the collected photographic data.

In one embodiment of detailed photography, it is not necessary to plan the photography point or position from which detailed photographic data is collected. In one embodiment, the shooting target, such as the target facade or portion of the facade of the target building determines the position of the photographer to collect the detailed photographic data. In one embodiment, the position from which detailed photographic data of a target object includes a location which allows the dimensions of the captured target area not to exceed about a 4×6 meter (or 12×18 foot) area. In one embodiment, the photographic data of a shooting target includes a moderate amount of fringe area or border around the target which, in one embodiment, includes as much as 15-20% of the area of the photographic data. If an object of detailed photography is greater than the specified dimensions, in one embodiment, photographic data of the object or structure is collected in parts with intersecting zones between the pictures. In one embodiment, if the shooting target exceeds these dimensions, several overlapping shots of adjacent portions of the target are taken. In one embodiment, the photographic data of adjacent targets overlaps by a designated percentage. In one embodiment, the photographic data of adjacent targets overlaps by at least a designated percentage such as at least 10-15% of the area of the photographic data. In one embodiment, the shooting position of the photographer is substantially perpendicular to the surface of the shooting target to decrease distortion of straight lines and angles. In one embodiment, the photographer positions himself to minimize the number of obstacles or extent of obstruction of the object of photography.

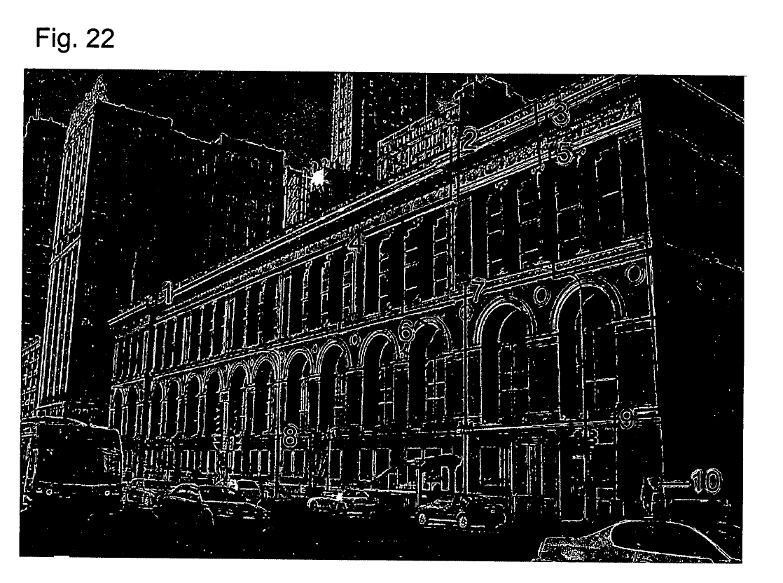

Referring to FIG. 22, in one embodiment of the present invention, each building facade is divided into about three sections: ground floor level, mid-floor level, and upper floor and roof level. It should be appreciated that low-rise or lower story buildings may not have a distinct mid-floor level. In one embodiment, the shooting targets for the detailed photography of a facade of a building are determined based on a survey photograph of the building illustrated in FIG. 22. Analysis of this photograph yields ten potential targets or areas for detailed photography indicated in FIG. 22 that are sufficient for a modeler to use to reconstruct the entire building facade pictured in FIG. 22.

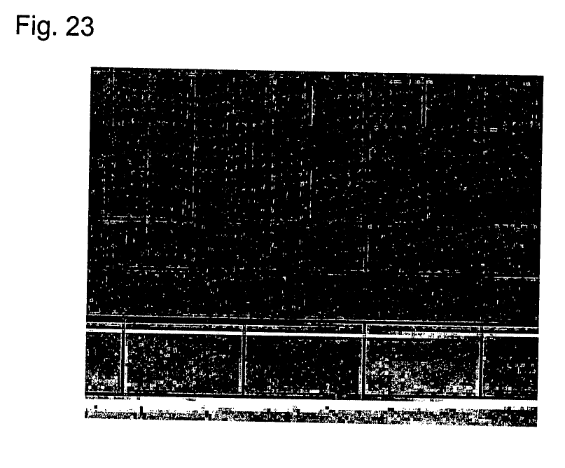

In one embodiment, the detailed photographs of the ground floor level of a building capture entries, doorways, arches, bulkheads, windows, storefronts, signage, columns, stairs, raised architectural elements, fragments of wall facing, such as the stone facing illustrated in FIG. 23, and any other architectural component requiring more detailed photographic data. For example, the area designated as area 8 includes a fragment of a window layout at ground floor level. Area 9 includes a fragment of wall and foundation facings. Area 10 includes a wall-mounted plate. In one embodiment, substantially all such protrusions and niches on the facade of a building require detailed photographs showing both straight and angle views of such components.

The layout of a mid-floor level of a building is usually more uniform than the ground level, as illustrated in the repeated components found on the facade layout in FIG. 22. In one embodiment, detailed photographs are taken of a regular pattern of two adjacent components to provide both spacing distance between components and information about the surface structure of the components. The identical elements or uniform components of a building facade, such as identical windows structures on different facades only require collection of those identical elements on a single facade. In one embodiment, the photographic data collected for identical elements with high degree of uniformity includes two to three pictures of such elements in different parts of the facade or different facades. For example, detailed photographs of two or more identical and adjacent windows of the mid-floor level illustrated in area 7 in FIG. 22 are taken along with windows of the third floor level indicated in area 4 and area 5 which include different types of window spacing. It should be appreciated that when the collection of photographic data of only one facade is necessary, the photographer can consider factors such as which facade affords a greater freedom to choose a shooting point of that facade, obstructions of the facade, and illumination of the facade when determining which facade will be photographed.

As discussed above in FIG. 14, in one embodiment, the uniform components of a building facade can be repeated in a vertical fashion, in a horizontal fashion or in both a vertical and horizontal fashion. In one embodiment, if a component is repeated in only one direction (vertical or horizontal), then the photograph showing two adjacent components is taken with a small area or fringe area around each of the adjacent components. In one embodiment, detailed photographic data is collected showing the uniform component with a small overlap of ten to fifteen percent of adjacent components. This overlap provides both exact spacing distance and information about the surface structure. If a component repeats in both vertical and horizontal directions, such as the rectangular stone bocks in the stone facing illustrated in FIG. 23, in one embodiment, a detailed photograph is taken which includes, for instance, at least a two-by-two matrix of the adjacent components or at least four components (stone blocks).

In one embodiment, if the mid-floor level area of the facade is relatively large, it is preferable to have at least two photograph variations of recurring components of the facade layout that show different views of those particular components. This is used in the modeling process to achieve a more natural and diverse view of the surface of the modeled facade.

Detailed photographs of an upper floor and roof level include subject matter such as windows, roof parapets, bulkheads, etc. In FIG. 22, for example, area 1 includes lengthy lettering relief. At least two overlapping photographs are taken to achieve the level of detailed photographic data necessary to accurately model this area. Other targets include area 2 which contains fragments of base relief, roof overhead and parapet. Area 3 and area 6 include roof soffit and the topside of the window casing, respectively. In one embodiment, additional photographic data of each of these areas is collected at a shooting position directly underneath the structures of these areas. It should be appreciated that access to suitable shooting positions that provide appropriate angles of the upper floor levels, especially for high-rise buildings, can be limited. In such cases where it is not possible to collect photographic data from optimal shooting positions, the present invention, in one embodiment, contemplates simplifying the model during the reconstruction of the upper floor and roof levels of high-rise buildings and creating graphical textures of upper levels based solely on survey photographs.

It should be appreciated that for upper levels of high-rise buildings in areas with high building density, aerial detailed photography may be required to collect detailed photographic data. Aerial detailed photography can include a collection of photographic data from a position perpendicular to the surface being photographed. Such positioning can be accomplished from a neighboring building, or by helicopter, airplane or any other suitable means of positioning the photographer at a location where adequate detailed photographic data can be collected.

Thus, to reconstruct the building facade illustrated in FIG. 22, one embodiment of the present invention includes taking at least ten detailed photographs showing the areas described above, or areas similar to them. It should be appreciated that the numbering of the outlined areas does not determine the sequence of the shooting.

In one embodiment, illustrated in FIG. 21B, an example of a detailed photography objects list developed during the planning stage and completed as photographic data is collected includes identifiers for each record 872b, identifiers of the facades or portion of the target building determining the position of the object for photography 873b, identifiers of the photography point or position from which detailed photographic data is collected 874b, a description of the data including a name of an object to be shot and its relation to or positioning on the facade as well as optional comments of a photographer 875b, identifiers of the memory device or flash-card media on which the photographic data is stored 877b, and an identifier of the photographic data 878b.

The records include the collection of photographic data of objects appearing in area no. 2 of the angle-view survey photo illustrated in FIG. 22. For example, Record #14 includes a photograph of the left part of an inscription located under the roof peak in the center of area no. 2 of FIG. 22. The photographic data is stored on memory device #3 and is identified as 100-0413. Similarly, Record #15 includes a photograph of the right part of the inscription. Record #16 includes a photograph of base relief, roof peak and parapet located at the right corner of the facade of FIG. 22. Record #17 includes a photograph of the window of the third floor located to the right of the center of the facade of FIG. 22. Record #18 includes a photograph of the wall table located in the right corner of the facade. It should be appreciated that additional photographic data can be collected according to the discretion of the photographer. It should be further understood that planned photographic data can be withdrawn from the log or logbook according to the discretion of the photographer.

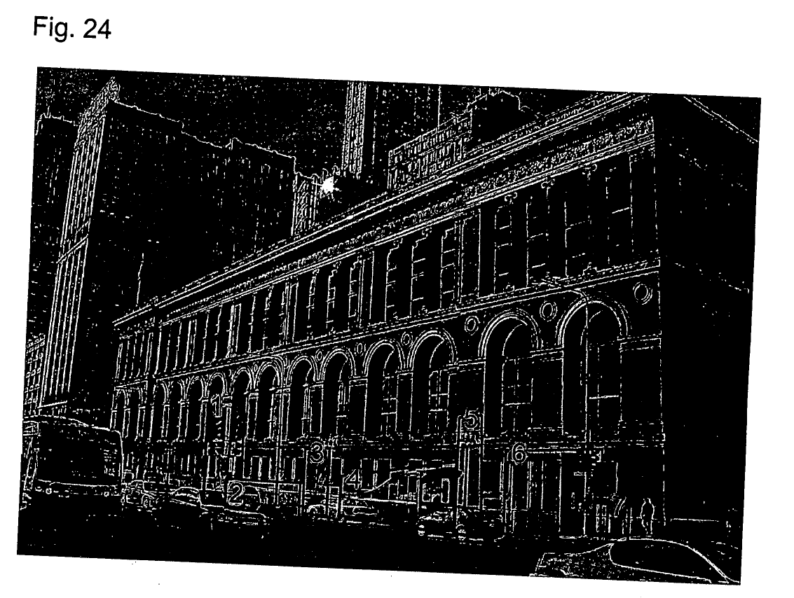

In one embodiment, objects around a building pictured in a survey photograph are identified within areas for detailed photography as illustrated in FIG. 24. City clutter photography is a variation of detailed photography. The results of this type of photography are used for the reconstruction of the geometrical shapes of objects surrounding the building and creating their graphical textures. Such subject matter contributes to a more natural presentation of textures of identical objects.

It should be appreciated that many of the features of the present invention that apply to modeling a building, including collecting photographic data through survey photography and detailed photography of a building, are applied to modeling city clutter. For instance, in one embodiment, detailed photography of identical objects requires only two to three photographs to be taken of identical objects. FIG. 24 illustrates traffic lights located at the center of the roadway in area 1 and in area 6. In one embodiment, a straight-view photograph and an angle-view photograph are sufficient for objects having symmetrical shape with three-dimensional elements such as the traffic lights. Additionally, only one representative object of multiple identical or substantially similar objects is photographed. For example, area 5 outlines a street light pole. Substantially similar poles are located around the building perimeter. Only one photograph of one light pole is taken for the reconstruction of a model because of the symmetrical shape of the light pole and its substantial similarity to other light poles. Other examples of objects which are symmetrical and appearing the same from any side and require only one photograph to be taken are the tree planted in a circular pot outlined in area 3 and the trash receptacle outlined in area 7 of FIG. 24.

Area 2 of FIG. 24 outlines a fence-like structure. Based on the survey photograph alone, the fence appears to require at least straight-view photographs of each of the four sides of the fence. However, upon closer examination of the object additional photographs may be necessary to illustrate unique features of the object.

Area 4 in FIG. 24 outlines a subway entrance. In one embodiment, a straight-view photograph is taken of surfaces of an object or structure which are different from one another such as the front and back surfaces of the subway entrance. In addition, only one photograph is taken of a side if both sides are substantially similar such as one of the sides of the subway entrance. Also, in one embodiment, a photographic data is collected of a view toward the inside of a structure such as a top-down view of the stairs leading into the subway.

Area 6 in FIG. 24 outlines a booth-like structure. Similar to collecting photographic data of a building, to reconstruct the booth, a straight-view photograph of each side of the booth is taken. If the opposite sides of the booth are identical, then it is enough to take two straight-view photographs of the adjacent sides.

The quantity of necessary pictures of identical objects neighboring the building depends on the quantity of such objects. In one embodiment, at least one picture is necessary for every five to seven objects up to about three pictures. It should be appreciated that the numbering of outlined areas does not determine the sequence of the shooting.

In one embodiment, the city clutter objects list 819c illustrated in FIG. 21C, similar to the survey and detailed photography lists, includes a record identifier 872c, an identifier of the facades of the target building determining the position of the object for photography 873c, and an identifier of the shooting point or position 874c according to a layout. A description 875c of an object(s) of photography is also included in the list 819c. The description includes a brief identification of the object, the location of the object(s) in relation to facade(s) of the building, and the perspective from which photographic data of the object is collected. The objects list 819c, in one embodiment, also includes a section for photographer comments if necessary. The list includes identifiers of the memory media on which the photographic data is stored such as a flash-card medium and an identifier of the actual photographic data itself.

FIG. 21C illustrates an example of a portion of city clutter objects list developed during the planning stage and completed as photographic data is collected. The records include the collection of photographic data of objects appearing in area no. 2 of the angle-view survey photo illustrated in FIG. 24. For example, Record #14 includes a photograph of a pot with a tree located in the center of the facade as identified in area 3 in FIG. 24. Record #15 includes a photograph of a light post located in the right portion of the facade appearing in area 7 in FIG. 24. Record #16 includes a photograph of straight-view of a structure in the right corner of the facade appearing in area 6 of FIG. 24, and Record #17 includes an additional photograph of the structure.

It should be appreciated that the types of photographs and qualities that must be present in the photographic data for complete and accurate modeling of an object can be further planned and organized at the actual building site due to the number of undocumented variables that may be absent from preliminary information on a target such as a footprint layout. It should also be appreciated that planning the architectural photography may be carried out both separately and together with the analysis of the architecture of buildings of the target city block. For example, a photographer, in one embodiment, conducts an analysis of the target city block and the architecture of its buildings first from perspectives necessary for survey photographic data collection followed by the details of the facades, and finally of neighboring objects around the building. Accordingly, it should be appreciated that the photographer can determine simultaneously the facades and perspectives for sufficient photographic data collection.

In one embodiment, the planning stage 807 also includes test photography to determine the adequacy of the method of architectural photography to complete the model reconstruction. Testing the method of architectural photography includes determining the capacity for work and efficiency of the photographic method, the adequacy of the method of photography, determining the sufficiency and method of a system of documenting the photographic data, and evaluating the completeness of materials, clearness of expression and sufficiency of illustration of instruction provided to photographers through manuals, publications or any other suitable form of communication. In one embodiment, test photography is used to determine the adequacy of the timing or efficiency of photographic and/or modeling tasks such as the average time for analysis and planning, the average time for collecting photographic data, the average time for processing the photographic data and the average time for quality control of sufficiency and quality of the photographic data and corresponding documents as discussed above. In one embodiment, test photography is used to determine the requirements of processing the photographic data such as functions of a processing center and requirements for the composition of photographic data to be collected and processed.

The following step includes the actual collection of photographic data 808 or shooting of the shooting task fragment of the target area. During this stage the collection of photographic data of buildings and neighboring objects occurs in accordance with the plan for photography. The collection of photographic data for buildings, their details, and neighboring objects is carried out according to the shooting task 803 plan layout and corresponding description of the photographic data to be collected as recorded in the log or logbook 812b. Therefore, in one embodiment, survey photographic data is collected which includes each side or facade of a building having architectural details unique to that facade. In one embodiment detailed photographic data is collected which includes the architectural details unique to each facade. In one embodiment, if the unique architectural detail is a repeatable pattern or element, the detailed photographic data collected is limited to a single representative element. Therefore, the collection of photographic data to construct a virtual three-dimensional model of a building is minimized by limiting the target subject matter of the collection to unique representative facades and unique representative architectural details of the building which can be digitally duplicated to re-construct the model as discussed below.

In one embodiment, the photographer determines an object for which photographic data is collected in accordance with records in the log or logbook 812b. The photographer proceeds to the position(s) or zones identified in the layout, log or logbook from which to collect the photographic data of the object. The photographer chooses the best perspective to collect the necessary photographic data. It should be appreciated that the photographer can deviate from the plan according to his discretion due to changes in conditions such as illumination or views such as obstacle blocking the originally planned perspective.

An important step of minimizing the amount of photographic data to be collected is to accurately document and organize or classify the data. To this end, in one embodiment of the present invention, a photographer must promptly document or record into a manual or computerized shooting task logbook or spreadsheet a description of predetermined parameters of the photographic data as it is collected. In one embodiment, the photographer makes a record in the log or logbook of each shot that was planned during the previous stage. To this end, the photographer records in the log or logbook an identifier such as a number corresponding to the photographic data and an identifier such as a number corresponding to any memory device on which that photographic data is stored. As illustrated in FIGS. 21A, 21B and 21C, the objects lists for survey, detailed, and city clutter photographic data include a section for an identifier of the memory media on which the photographic data is stored such as a flash-card medium 877 and identifiers of the actual photographic data itself 878. In one embodiment, as illustrated in FIGS. 21A, 21B and 21C, a section 875 is designated for photographer comments, if necessary.

After completing the collection of the survey photographic data and documenting identifiers and a description of the photographic data the photographic data along with the logbook is submitted for processing.

Referring again to FIG. 10, in one embodiment, the completed shooting tasks undergo an internal quality assessment or quality control 809a and 809b. It should be appreciated that quality control can be performed by the photographer, modeler or both as illustrated in FIG. 10. In addition to the special requirements for each type of architectural photography discussed above, i.e. survey, detailed or object, general requirements exist for all types of architectural photography. General requirements are related to the sufficiency of photographic data and the quality of the photographic data. The sufficiency of photographic data requirement is based on whether the photographic data is sufficient to allow a modeler to fully represent the real object or structure in a corresponding computer three-dimensional model of the object or building. It should be appreciated that the photographer must also be able to determine the adequacy and sufficiency of the photographic data necessary to complete the modeling of the object or structure while analyzing the object or structure and planning the collection of the photographic data.

The quality of the photographic data includes visual quality and technical quality. Visual quality requirements of the photographic data include illumination requirements such as lighting and weather conditions influencing the illumination of the object. To this end, it is preferable that all photography be carried out during daylight hours and in the absence of atmospheric precipitation (rain, fog, etc.). Furthermore, scene lighting should be as uniform as possible. Accordingly, contrast shots containing sharp edges between shadowed and sunlit areas should be avoided whenever possible. If the above conditions cannot be met for any reason, the shadowed area should be re-shot separately to perceive the details of the darkened part of the image. Mild shadowing, observable under hazy or cloudy skies, are usually acceptable requiring no additional shots. It should be appreciated that these requirements do not necessarily apply to artistic photography. For instance, a photographer may choose evening or night time conditions to achieve an artistic effect. Visual quality requirements of the photographic data also include the orientation of unequally proportioned photographic data such as landscape or portrait orientations. It should be appreciated that the shape of the object for which photographic data is collected can determine the proportions and orientation of the data.

Technical quality of the photographic data includes a resolution requirement of the data. The resolution of photographic data collected by a still photo camera is determined by the size of a photosensitive matrix of a digital camera. In one embodiment, the size of photosensitive matrix of the digital camera is at least 3072×2048 pixels or 6.3 megapixels. In one embodiment, photographic data is collected and stored for three-dimensional modeling in electronic form such as JPEG format or any suitable high quality format for the camera being used.

In one embodiment, architectural photography for the three-dimensional modeling includes the use of digital cameras (professional and semi-professional). It should be appreciated that other photographic equipment such as film cameras, video recorders, etc. can be employed in the present invention but may require additional digitizing of the recorded image. In one embodiment, architectural photography is conducted using 35-mm film or 6-megapixel digital SLR cameras. Use of digital cameras is preferred and highly recommended to cut down the time of processing the shooting task results. Table I below summarizes camera parameters and camera models recommended for architectural photography.

TABLE I
Camera Specification Summary

Camera Type:

| | |
|---|---|
| Film | Digital |

| | |
|---|---|
| Camera System | SLR (Single-Lens-Reflex) |

| | | |
|---|---|---|
| Recommended | | |
| Models: | | |
| Canon | EOS 300D 6M | EOS D60/10D |
| Nikon | N65/FM10/F3HP | D70/D100 |

Another technical quality requirement includes focus requirements. In one embodiment, cameras used in the present invention employ interchangeable lenses for a wide range of effective focal lengths. In one embodiment, zoom lenses, including optical or digital zoom, are used for all focal length adjustments when collecting photographic data for different objects at various distances. In one embodiment, only optical zoom is used to collect photographic data. In one embodiment, different types of interchangeable lenses may be required to ensure the best shooting results depending on various task-specific factors. It should be appreciated that a digital zoom feature may result in sub-optimal picture resolution. In one embodiment, the use of a digital zoom feature is avoided because only images of the highest quality are used in the modeling process having an image resolution of at least six megapixels (3072×2048 pixels). It should be appreciated that use of the digital zoom feature can reduce the quality of the picture by decreasing image resolution. The digital zoom feature decreases image resolution by capturing a portion of an image that has been projected through lenses onto an active element matrix, and stretching the image to fit a camera picture size, e.g. 3072×2048 pixels. Optical zoom, on the other hand, captures the entire image projected directly to the active element matrix thereby minimizing the reduction of image resolution. In one embodiment, the digital zoom feature in high-resolution professional digital cameras having, for example, a fourteen-megapixel matrix is used for collecting photographic data, It should be appreciated, however, that in one embodiment the zoom factor should not exceed 14/6=2.3 times the image resolution.

In one embodiment, wide angle or ultra-wide zoom lenses are used for survey photography. In one embodiment, standard or telephoto zoom lenses are used for detailed photography. Table II summarizes the lens specifications and lens models recommended for survey and detailed photography in one embodiment.

TABLE II
Lens Specification Summary

| | | Photography Type: | |
|---|---|---|---|
| | | Survey | Detailed |
| Lens Type | | Wide Angle/Ultra-Wide Zoom | Standard/Telephoto Zoom |
| Diagonal Angle of View | | 40°-80° | 10°-40° |
| Effective Focal Length | | 25-50 mm | 50-300 mm |
| Recommended Models: | | | |
| Canon | Digital | EF18-55 mm f3.5-5.6 | EF28-200 mm f/3.5-5.6 USM |
| | Film | EF24-70 mm f/2.8L USM | EF35-350 mm f/3.5-5.6 USM |
| Nikon | Digital | 17-35 mm f/2.8D ED-IF AF-S | 28-200 mm f/3.5-5.6D IF AF |
| (Zoom-Nikkor) | Film | 24-85 mm f/2.8-4D AF | 50-300 mm/4.5 ED Ai-S |

As illustrated in FIG. 9A, in one embodiment, shooting tasks which require re-working are reassigned as shooting re-work tasks 811 a and completion dates of all tasks being re-worked are updated in the supply schedule 805.

The next step 810 in the architectural photography process framework illustrated in FIG. 9A includes processing and submitting results. Upon completion of the photographic data collection 808 of the shooting task 803 and evaluation internal quality control 809a, the photographic data documented in the log or logbook is classified and documented in electronic form in a shooting task journal file (if not originally done). It is contemplated by the present invention that at least one digital representation of the physical appearance of each object in the virtual city will be stored in a database as discussed above.

In one embodiment, complete processed sets of shooting task photographic data 812a along with corresponding shooting task journal files 812b are evaluated for use in creating the three-dimensional virtual city model 809b. In step 809b, additional quality and integrity control of the photographic data 812a is conducted for completeness of the amount of photographic data necessary to complete the reconstruction of a three-dimensional model. For example, in one embodiment, the process includes collecting photographic data with corresponding documentation identifying and describing the photographic data and then passing the photographic data to the modeler for analysis. The modeler, in turn, creates a full image of a building(s) using the photographic data. If the model reconstruction cannot be completed with the photographic data available, the modeler determines the perspectives and details which are necessary to complete the model. Therefore, at step 811b, any discarded photographs, poor quality photographs, new photographs not yet taken and all shooting tasks recorded in the shooting task journal 812b but not yet received are documented in a deficiency report 813 to be re-worked as described in step 811a. Completion dates of all tasks to be re-worked are updated in the supply schedule 805. In one embodiment, once the photographic data has been planned, collected and reviewed for quality and completeness in the architectural photography framework illustrated in FIG. 9A, the photographic data enters the reconstruction process framework, illustrated in FIG. 9B.

### Reconstruction Process Framework

Once sufficient photographic data has been planned, collected, processed, documented and stored in the architectural photography process framework, the collected photographic data enters the reconstruction process framework of the three-dimensional modeling process. In FIG. 9B, one embodiment of the present invention includes four steps or stages of a three-dimensional reconstruction of a city object designated as “A” in FIG. 9A. The first step 902 includes analyzing the target information including survey photographic data from which a three-dimensional or wireframe model of the building is reconstructed in the second step 904. The next step 906 of three-dimensional modeling of an object includes creating a graphical pattern or texture. The final step 908 is to texture the wireframe model by assigning to each face of the constructed wireframe the graphical pattern or texture created in step 906.

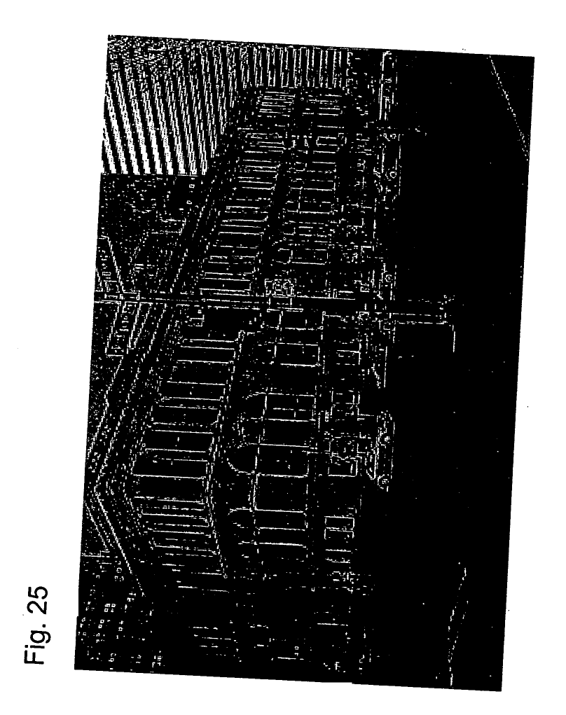

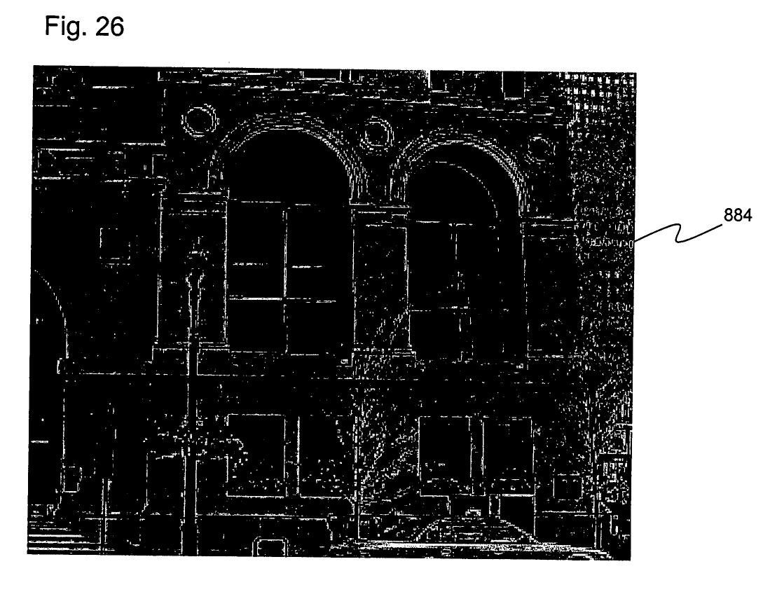

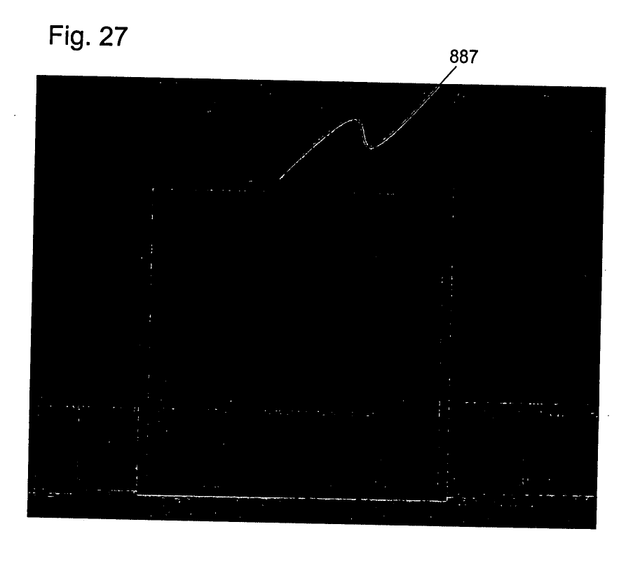

The first stage 902, in one embodiment, includes analyzing the survey photographic data. During this stage, a visual image of an object begins to be formed based on results of the analysis of all available photographic data. It should be appreciated that all available photographic data may include preliminary photographs of the building, survey photographic data, or, in one embodiment both survey and detailed photographic data as described above. FIGS. 25, 26 and 27 illustrate examples of some of the photographs used to reconstruct a portion of a building model. FIG. 25 illustrates a survey photograph of two adjoining building facades. FIG. 26 illustrates a detailed photograph of windows on a facade. FIG. 27 illustrates a detailed photograph of stone facing on a facade. From these relatively few photographs, the modeler is able to determine object geometry such as the shape of the building and proportions and dimensions of its major components such as windows, composition and layout of uniform repeated structures found on the face of the object such as stone blocks, and unique structural details such as an entrance. It should be appreciated that the detailed documentation of photographic data performed at the architectural photography process stage of the present invention assists the modeler with this stage of the process.

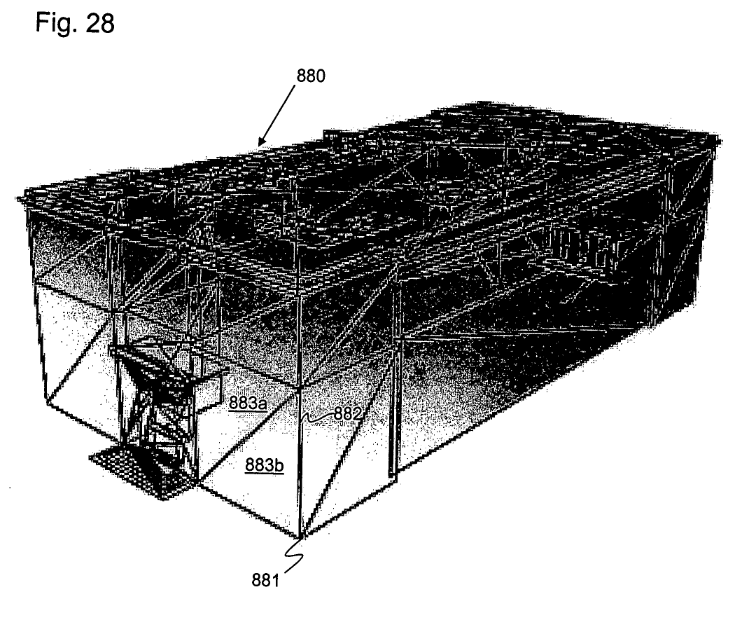

The next stage 904 includes building a three-dimensional model reconstruction. FIG. 28 illustrates a model 880 of a building reconstructed from a set of survey photographs. The creation of a three-dimensional model begins with the reconstruction of its geometrical shape using the analysis of geometry and dimensions of the building along with the proportions, dimensions, composition and layout of its component structures. The geometrical outline of an object in one embodiment essentially comprises a set of vertices 881 in three-dimensional space, interconnected with straight lines 882. This geometrical outline forms the skeleton of the three-dimensional model referred to herein as the “wireframe”.

In one embodiment of the present invention, the wireframe includes a number of triangular facets or faces 883 defined by the interconnected vertices 881 and lines 882. Each face 883 represents a portion of the surface of the modeled object. The number of faces in a wireframe is one of the major characteristics of a three-dimensional model which determines its visual quality. It should be appreciated, therefore, that a higher number of faces results in a higher quality model. The wireframe illustrated in FIG. 28, for example, is substantially simplified comprising fewer faces and less detail such as relief details of window arches and columns. In one embodiment, relief details are represented by flat images of these elements “glued” to outer faces of the wireframe during the texturing stage discussed below.

In one embodiment of the present invention, detailed photographic data is planned and collected at this stage of analysis of the survey photographic data. In one embodiment, once a wireframe model is prepared using the survey photographs, detailed photography shooting tasks are assigned to a photographer. Alternatively, the detailed photographs are taken during the shooting of the survey photographs.

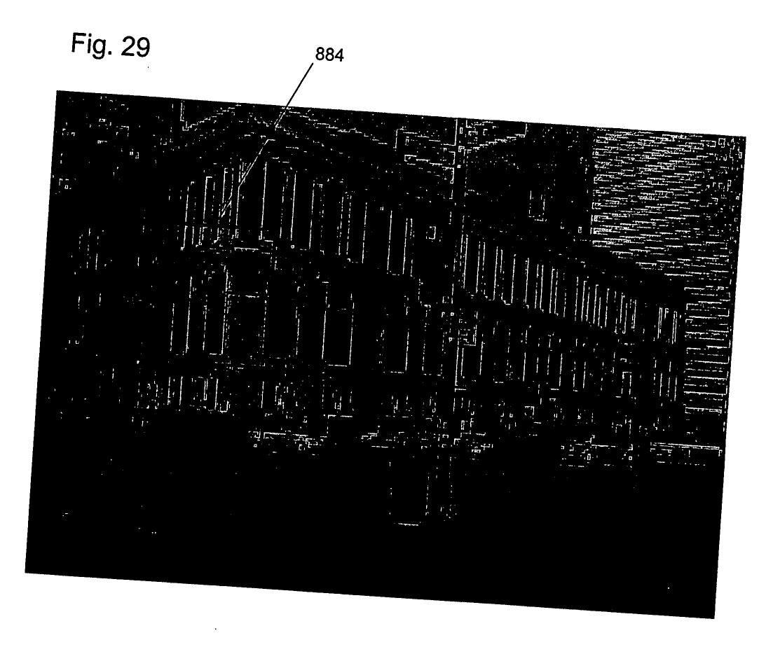

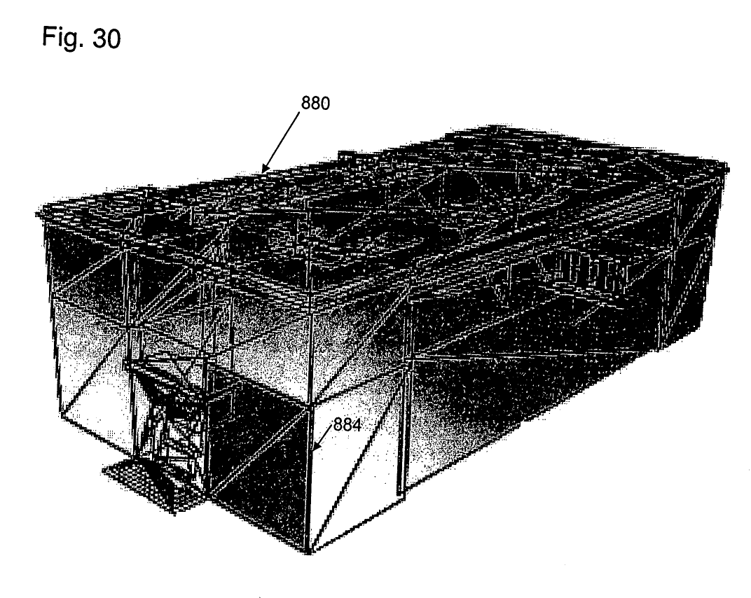

The next step 906 of three-dimensional modeling of an object includes creating a graphical pattern or texture to be applied to each face 883a and 883b of the constructed wireframe 880 of graphical tile images referred to as wireframe texturing. Wireframe texturing includes outlining a fragment of a building facade. The outlined facade fragment is transformed to create a tile texture. FIG. 29, for example, illustrates an outlined fragment 884 of a portion of a building facade from a survey photograph. The outlined fragment 884 is also identified in the corresponding wireframe sketch illustrated in FIG. 30 as the combination of faces 883a and 883b. The graphical pattern represents the corresponding texture 884 of the surface of the object outlined in the survey photograph of FIG. 29. It should be appreciated that the visual quality of the three-dimensional model of an object depends on the quality of textures used in the modeling process.

In one embodiment, the tile texture for the designated fragment 884 of the building facade illustrated in the survey photograph of FIG. 25 is created from a fragment included in a source digital photograph, such as the detailed photograph of FIG. 26. In one embodiment, the designated fragment 884 undergoes a series of transformations before being applied to the wireframe model in the location 883 identified in FIG. 30. In one embodiment, the transformations can include excluding portions of the source photograph to remove unneeded details in the tile texture, correcting perspective to remove geometrical distortions, re-sizing the image, removing irrelevant artifacts such as trees, cars, people, etc., correcting color, and hardening contrast to restore contrast lost from perspective transformation.

Referring now to FIGS. 31A, 31B, 31C and 31D, examples of one embodiment of the present invention are illustrated which includes a series of processing steps used to correct visual distortions in a detailed photograph in order to create a graphical tile to be used to texture the wireframe. FIGS. 31A, 31B, 31C and 31D illustrate some of the main phases of computer processing to correct visual distortion of the graphical tile from the source digital photograph included in one embodiment of the present invention. Most typical sources of visual distortions include perspective distortions due to shooting at acute angles to a facade surface. FIG. 31A, for example, illustrates a source detailed photograph that was taken at an angle not completely perpendicular to the window target area. It should be appreciated that it may not be possible to take architectural photographs at the correct angle; therefore, an ability to correct perspective distortion as illustrated in FIG. 31B is valuable to the modeler. Other visual distortions include overlapping of the target shooting area with foreign objects. FIG. 31C illustrates re-sizing the image and excluding from the tile texture the foreign objects such as the lamp post and, in FIG. 31D, the tree. Low image sharpness can also occur due to incorrect focusing, large distances to the shooting target, deep shadows, or uneven, poor or excessive scene lighting. FIG. 31D illustrates the correction of such qualities of the photograph. It should be appreciated that the less visual noise and distortions present in the original source photograph, the higher the quality in the final tile image.

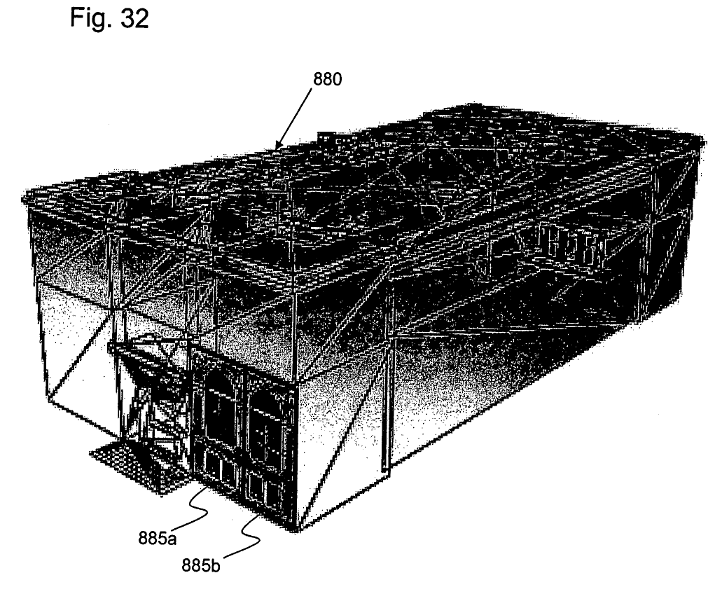

The final step 908 in creating a reconstruction model is to texture the wireframe model. Once the detailed photograph of the fragment of the source digital photograph is transformed, the resulting tile texture is applied to the wire frame model. It should be appreciated that the graphical tile can be duplicated, if necessary, and perfectly joined together with the same or other tile textures to form a contiguous mosaic to be applied to the wireframe model. As illustrated in FIG. 32, in one embodiment, once the tile texture 885 is created, the tile texture 885 is duplicated into tile textures 885a and 885b and perfectly joined to one another in a seamless manner to be superimposed on the surface of the wireframe model 880 in the identified fragment 883. In one embodiment, the tile texture is applied to other areas of the wireframe model having corresponding fragments. It should be appreciated that in the example illustrated in the survey photograph in FIG. 25, the created tile texture of a single window continues along another side of the building. Therefore, the tile texture in one embodiment is further used to texture the other side of the building facade comprising the same window pattern.

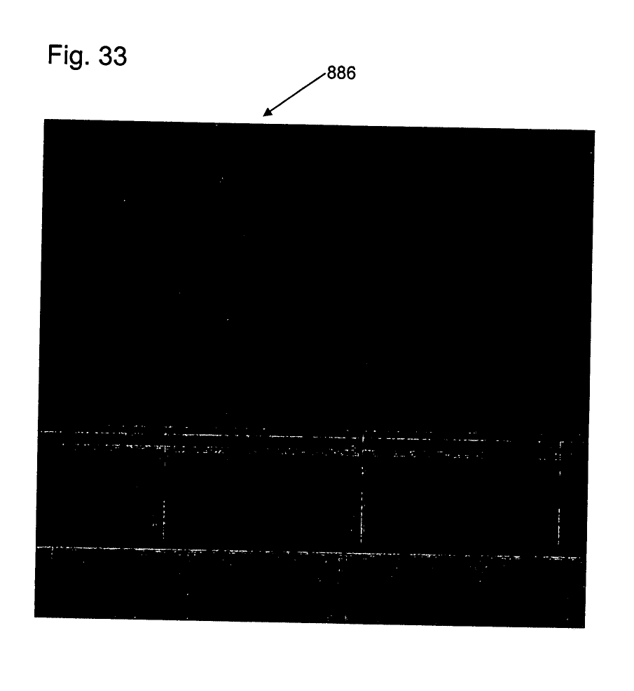

Referring now to FIGS. 33 to 35, in one embodiment of the present invention, a tile texture is used to “coat” the wireframe model 880. In the illustrated example, the detailed photograph of FIG. 27 capturing the stone block surface of the target building is used as a source of photographic data. In one embodiment, illustrated in FIG. 27, the fragment of the source photograph used to create the tile texture is indicated by, for example, a highlighted or colored red frame 887. Again, the outlined fragment undergoes transformation processing described above to create the tile texture 886 illustrated in FIG. 33. It should be appreciated that the quality of the texture contributes to the overall visual quality of the three-dimensional model.

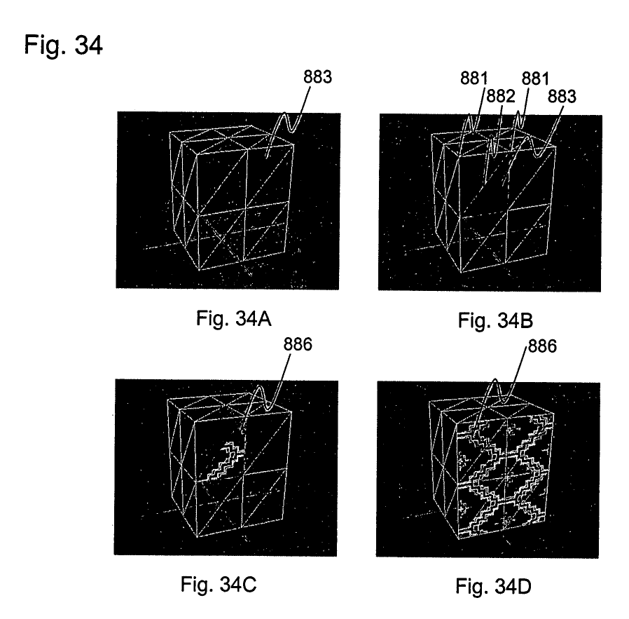

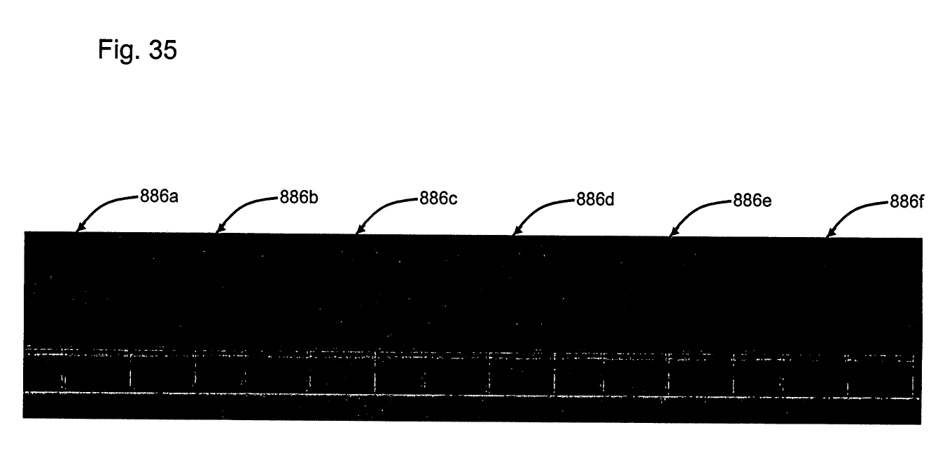

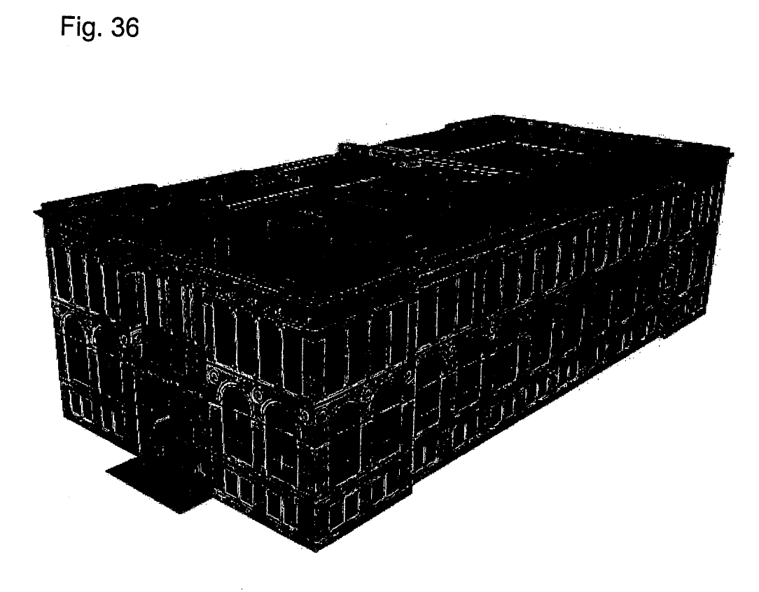

As discussed above, the wireframe model illustrated in FIG. 34A includes triangular faces 883 defined by the interconnected vertices 881 and lines 882. Each face 883 represents a portion of the surface of the modeled object. As illustrated in FIGS. 34B and 34C, a face is selected and is assigned the transformed graphical pattern or texture 886 which simulates the corresponding portion of the actual surface of the object such as brick, block, marble, wood, etc. Assigning the texture tile 886 along multiple corresponding faces of the wireframe forms a textured surface as illustrated in FIG. 34D. The repeated graphic patterns 886a to 886f complete the “coating” of the lower portion of the entire facade of the building as illustrated in FIG. 35. It should be appreciated that, by applying the procedures described above consecutively to other parts of the building, it is possible to reconstruct a complete and substantially realistic three-dimensional model as illustrated in FIG. 36.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A computer implemented virtual model of an actual city, comprising:
data representing a plurality of actual city elements, wherein said data includes photographic data collected for at least one actual city element, said photographic data including:
(a) survey photographic data of each representative surface of the actual city element, wherein said representative surface includes at least one detail unique to said representative surface, and
(b) detailed photographic data of each representative detail unique to said representative surface of the actual city element wherein said detailed photographic data is adapted to be duplicated;
a plurality of virtual city elements, wherein the virtual city elements include three-dimensional representations of actual city elements constructed from said survey photographic data and detailed photographic data; and
an executable version of the virtual city elements on a storage medium.

2. The virtual city model of claim 1, wherein the actual city is selected from the group consisting of: a real city, a real town, a real village, a real province, a real county, a real state, a real country, a real ward, a real community, a real university campus, and a real college campus.

3. The virtual city model of claim 1, wherein the actual city elements are selected from the group consisting of: buildings, facilities, and objects.

4. The virtual city model of claim 3, wherein the buildings are selected from the group consisting of skyscrapers, towers, temples, churches, halls, apartments, house, condominiums, theaters, libraries and museums.

5. The virtual city model of claim 3, wherein the facilities are selected from the group consisting of plazas, squares, convention centers, convocation centers, stadiums and arenas, airports, train stations, bus depots and taxi stands.

6. The virtual city model of claim 1, wherein the representative surface of the actual city element represents a plurality of substantially similar surfaces.

7. The virtual city model of claim 1, wherein the representative detail unique to said representative surface represents a plurality of substantially similar details.

8. The virtual city model of claim 1, wherein the photographic data of each representative surface of the actual city element is collected from different views.

9. The virtual city model of claim 1, wherein the photographic data of each representative detail associated with at least one surface of the actual city element is collected from different views.

10. The virtual city model of claim 1, wherein the amount of photographic data necessary to be collected to produce a virtual three-dimensional model of the city element for a virtual three-dimensional city is minimized by collecting photographic data of at least one representative surface and at least one representative detail of the city element and duplicating said representative surface and representative detail, if necessary, to correspond to each surface and each detail of the city element.

11. A method of creating a computer-implemented virtual city model of an actual city, the method comprising:
collecting information relating to at least one actual city element, wherein collecting said information includes:
i. collecting survey photographic data of each representative surface of the actual city element, wherein said representative surface includes at least one detail unique to said representative surface,
ii. collecting detailed photographic data of each representative detail unique to said representative surface of the actual city element
creating a virtual three-dimensional model of the actual city element based on the photographic data wherein said virtual, three-dimensional model includes surfaces corresponding to each surface of the actual city element;
adapting the photographic data of each representative surface of the actual city element;
applying to each of the surfaces of the virtual three-dimensional model the adapted photographic data corresponding to each surface of the actual city element;
generating an executable version of the virtual city model based on said information; and
storing said generated executable version of the virtual city model on a storage medium.

12. The method of claim 11, wherein the actual city element includes a structure.

13. The method of claim 12, wherein the structure includes a building.

14. The method of claim 12, wherein the surface of the actual city element includes a wall of the structure.

15. The method of claim 11, which includes collecting photographic data of each representative surface of the actual city element from a plurality of different views.

16. The method of claim 11, which includes collecting photographic data of each representative detail associated with at least one surface of the actual city element from a plurality of different views.

17. The method of claim 11, wherein at least one view is elevated.

18. The method of claim 11, which includes planning the collection of the photographic data of the actual city element based on an analysis of said element.

19. The method of claim 18, wherein planning the collection of the photographic data of the actual city element includes determining a position from which the photographic data is collected.

20. The method of claim 18, wherein planning the collection of the photographic data of the actual city element includes documenting a description of each of the photographic data.

21. The method of claim 11, wherein adapting the photographic data of each object surface includes at least one of the transformations selected from the group consisting of: adjusting a perspective of said photographic data, excluding a portion of said photographic data, adjusting a level of contrast of said photographic data, and adjusting a level of brightness of said photographic data.

22. The method of claim 11, which includes creating a graphical tile texture based on the detailed photographic data of at least one representative surface of the actual city element.

23. The method of claim 22, which includes duplicating the graphical tile texture to be applied to at least one surface of the virtual three-dimensional model of the actual city element corresponding to each surface of the actual city element.

24. The method of claim 11, which includes creating a computer-implemented virtual city model of an actual city in a software product.

25. The method of claim 24, which includes continuing to create the computer-implemented virtual city model of the actual city in the software product.

26. The method of claim 11, which includes minimizing the amount of photographic data necessary to be collected to produce a virtual three-dimensional model of the actual city element for a virtual three-dimensional city by collecting photographic data of representative surfaces and representative details of the city element and duplicating said representative surfaces and representative details, if necessary, to correspond to each surface and each detail of the actual city element.

27. A method of minimizing the amount of photographic data necessary to be collected to produce a virtual three-dimensional model of an actual object in an actual city, said method comprising:
collecting photographic data of the actual object from at least one view for each different surface of the object; and
collecting photographic data of the actual object from at least one view of each different element associated with at least one surface of the object.

28. The method of claim 27, wherein at least one different element is repeated on at least one surface of the object.

29. The method of claim 27, wherein the element includes a three-dimensional object.

30. The method of claim 27, which includes transforming the photographic data of each object.

31. The method of claim 27, wherein transforming the photographic data of each object surface includes at least one of the transformations selected from the group consisting of: adjusting the perspective angle of said photographic data, excluding a portion of said photographic data, adjusting a level of contrast of said photographic data, and adjusting a level of brightness of said photographic data.

32. The method of claim 27, which includes duplicating the photographic data to be applied to each surface of the virtual three-dimensional model corresponding to each surface of said actual object.

33. The method of claim 27, which includes applying photographic data of each surface of the actual object to each surface of the model corresponding to each surface of the actual object.

34. The method of claim 27, which includes storing the photographic data in a database.

35. A method of creating a virtual model of a three-dimensional object, said method comprising:
a. planning a strategy of collecting photographic data of an object based on a shape of the object;
b. collecting the photographic data, wherein the photographic data includes each different surface of the object and each different element associated with each different surface of said object;
c. documenting a description of the photographic data;
d. creating a virtual three-dimensional model of the geometrical shape of each surface of the object based on at least one of the photographic data, said model including at least one model surface;
e. adapting the photographic data of at least one surface of the object; and
f. applying to each model surface the adapted photographic data corresponding to said surface of the object.

36. The method of claim 35, wherein the object includes a building.

37. The method of claim 35, wherein the strategy of collecting photographic date includes identifying at least one shooting position from which the photographic data is collected.

38. The method of claim 35, wherein documenting the description of the photographic data includes entering said description in at least one log.

39. The method of claim 35, wherein the virtual model of the object includes a plurality of surfaces interconnected by a plurality of straight lines spaced in proportion to the geometric shape of the actual object.

40. The method of claim 35, which includes storing the photographic data electronically.

41. The method of claim 35, wherein adapting the photographic data includes duplicating said photographic data to correspond to each duplicated surface of the object.
